(19) United States
(12) Patent Application Publication
(10) Pub. No.: US 2006/0132447 A1
(43) Pub. Date: Jun. 22, 2006

(54) Method and apparatus for automatically transforming functions of computer keyboard keys and pointing devices by detection of hand location

(76) Inventor: Richard H. Conrad, Waianae, HI (US)

Correspondence Address: Richard H. Conrad, 84-1330 Mauna'olu St., Waianae, HI, 96792, US

(21) Appl. No.: 11/303,782

(22) Filed: Dec. 16, 2005

Related U.S. Application Data
(60) Provisional application No. 60/637,310, filed on Dec. 16, 2004.

(51) Int. Cl. G09G 5/00

(52) U.S. Cl. 345/168

(57) ABSTRACT

This invention is an ergonomic method and apparatus for integrating the operation of computer keyboards and cursor control devices. It employs hand location detection to determine when the mouse hand is absent from its keyboard typing position or is present at the mouse. A detector output automatically transforms the functions of a set of keyboard keys lying under the non-mouse hand from their original actions into new actions which can include mouse clicks, keyboard shortcuts and macros. These keys usually include the home keys (a s d f, or j k l ;). The new functions are preprogrammed into this set of keys at an inactive level, and do not affect actions unless the hand position sensor detects that the mouse hand is absent from its keyboard typing position or is present at the mouse. This invention allows the non-mouse hand to actuate clicks at the keyboard by using the home keys as click switches, and also makes it possible for the non-mouse hand to type, with a single keystroke, keyboard shortcuts not normally available to it. When the mouse hand returns to the keyboard the keys automatically revert to their default functions. This method increases working speed, reduces the number of trips back and forth between keyboard and mouse, and relieves stress on the mouse hand. It is of special value to persons with carpal tunnel syndrome or Repetitive Strain Injuries. Detection of hand position or location is accomplished by sensors at the keyboard and/or at the pointing device, or by software detection of any data output from the mouse (movement or click) or from any keypress on the mouse side of the keyboard. This invention can be embodied solely as software, as firmware in an external device or keyboard, or as any combination of software and firmware. It essentially converts the non-mouse side of the keyboard into single-key macros: mouse buttons, tool selection keys, and special function keys. It can also be used to temporarily assign an alternate set of actions to mouse motion, mouse buttons and scrolling devices. Optionally this invention includes a floating on-screen palette which serves as an indicator of transformation and provides a map of the new functions. With simultaneous transformation of both a keyset and its corresponding palette, the palette always displays the new functions in the same geometric pattern as the actual layout of the new functions on the keyboard. This enables eye-to-hand pattern transfer for intuitive tool selection via the keyboard without using the mouse.

### CROSS-REFERENCE TO RELATED APPLICATIONS

This application claims the benefit of provisional patent application Ser. No. 60/637,310, filed Dec. 16, 2004 by the present inventor.

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates to computers, particularly to keyboards and pointing devices.

2. Prior Art

The operation of a computer keyboard and pointing device or mouse requires frequent trips of the mouse hand back and forth between the keyboard and the mouse. The mouse hand is needed at the keyboard to type characters on the screen and to press key combinations/macros (modifier key(s) plus alphanumeric key), and at the mouse to move the on-screen cursor and actuate mouse clicks. There are three basic problems here, with a great deal of room for improvement to reduce the incidence of repetitive strain disorders for millions of people and improve productivity for all computer users. The first is that about half of the macros needed while the hand is at the mouse are on the mouse side of the keyboard, the second is that many of the macros require pressing two or three keys, and the third is the significant toll in stress, shoulder, wrist and hand problems resulting from using the mouse, particularly because of the dual task the mouse hand is required to carry out of both moving the mouse and actuating its click buttons. In reference to the first problem, one cannot reduce the number of back and forth trips by putting all of the macros on the non-mouse side of the keyboard because there are not enough keys available unless one increases the number of keys required for each macro beyond two or three, thereby worsening the above second problem. The second problem is already a strain as it is, having to actuate, simultaneously or in sequence, macros of two or three keys, and more than just a few three key combinations can become difficult to remember without confusion. The third problem is that of the very poor ergonomics of most pointing devices, which to reduce fatigue have to be both very easy to move and also very easy to click. But this introduces the strain of preventing unwanted clicks while moving, and particularly the preventing of unwanted motion while clicking. Even very subtle dual tasking stresses can take a toll after hundreds of repetitions of the mouse hand traveling back and forth, hundreds of multiple key macro actuations, and many thousands of mouse motions and clicks. All of these problems become more serious during editing work, and especially during CAD operations, which involve less typing and more use of the mouse and of macros for tool selection. While working in drawing and CAD applications, repeatedly moving the mouse away from work objects in order to click in toolbars or menus is not only a distraction, but can require more clicking and moving of the mouse than the drawing itself Using keyboard shortcuts and macros can also be less than satisfactory because of having to remember them by touch and because activating them usually requires reaching to depress more than one key at a time.

In prior art, for the purpose of making more functions available to a number of keys at once, keyset transformations are used to convert keyboard alphanumeric keys to upper case by pressing the shift key, and alphanumeric keys on the right side of laptop computer keyboards are converted into a numeric keypad by pressing a function key. The Kinesis Contour keyboard has an additional programmable set of functions available for its numeric keypad, which also requires pressing a function key. In the Apple Macintosh operating system, pressing the shift key five times in a row turns the numeric keypad into mouse move keys plus one click key. The Apple Keyboard Viewer and various learn-to-type programs employ an on-screen palette that pictures the whole keyboard, and the palette together with the functions of the keys it represents can be replaced by another set of icons and key functions by pressing key(s) or pulling down a menu and clicking. Also in prior art, CAD and similar programs use a default keyboard containing special functions, and automatically convert to native alphanumerics when a tool or operation is selected that requires the input of a character or a number.

All of the above examples of prior art require the purposeful depression of a function key or macro in order to activate the alternative function, and either a purposeful release or another purposeful depression to cancel it. They do nothing to alleviate any of the three problems of using prior art pointing devices and keyboards together listed above.

### OBJECTS AND ADVANTAGES

The method of the present invention differs very basically from prior art in that it employs the unique feature of hand location sensing to automatically carry out the transformation of key functions, which can be the transformation of a single key, a large set of keys or the whole keyboard at once if desired. When it detects the return of the hand to its typing position it automatically causes a reversion to the native keyboard. The uniqueness and special benefits of the present invention begin when the mouse hand leaves the keyboard: a change in hand location is detected and registered as either transformation state T or M (or Z), which automatically causes the functions of the set of keys under the non-mouse hand to be transformed into a new functionset. Hand location responsive transformation also makes available to the non-mouse hand the functions from the mouse side of the keyboard and one or more additional new sets of functions or tools, all triggerable by a single key stroke, and also a set of mouse buttons, clicks, arrow keys and other navigation tools, etc. for use while the mouse hand is operating the pointing device.

Thus the present invention greatly reduces the three main problems of the prior art: 1) it reduces the number of times the mouse hand has to travel back and forth to the keyboard, 2) most of the functions are now single stroke macros, and 3) it can duplicate the mouse buttons onto the keyboard, thereby transferring the task of clicking from the mouse hand to the non-mouse hand at the keyboard. Furthermore, optional on-screen palettes that reflect the keyboard layout of labels or icons of the functions assigned to the active keyset eliminate the need to memorize a long list of macros, and facilitates tool selection in CAD and similar programs via eye-to-hand pattern transfer, without using the mouse or clicking.

The present invention can be used to select tools from palettes in CAD programs without using the mouse and without multi-key macros by the method described below. This method utilizes hand location responsive keyset function transformation together with transparent and intuitive eye-to-hand pattern transfer. It takes advantage of subconscious coordination based on a match between the layout of functions in the on-screen palette and on the keyboard. In the prior art, during most of the time that the mouse hand is at the mouse, the non-mouse hand is doing nothing, its fingers just resting on the home keys.

Using most prior art CAD tool selection methods is analogous to a surgeon having to reach away from his patient and over to the instrument tray himself, and then bring the instrument back into the operating area. Using the method of the present invention a part of the computer interface is like being a surgeon who has an assistant by his/her side placing tools: scalpel, clamp, etc. into his hands when needed, without the surgeon having to remove his hands from the area of operation.

### INTRODUCTION/OVERVIEW

This invention is a method and device for automatically providing a new set of functions for the non-mouse hand when the mouse hand leaves its keyboard typing position or arrives at the mouse. When the mouse hand returns to the keyboard the keys automatically revert to their native or default functions. The invention consists of one or more hand position sensors and/or detector methods together with hardware, firmware and/or software to enable signals from the hand position detection to transform key actions. It can be used with existing computer equipment as software only or as an external device, or it can be incorporated into new keyboard, pointing device and/or computer designs. This invention employs a set of alphabet and punctuation keys typically including four “home” row keys (for example, a s d f) and optionally also the row of four keys above and the row of four keys below the home keys. Alternative functions are then programmed into these keys at an inactive level, i.e. some of the keys used in normal typing now include latent triggers for macros. Then when the mouse hand is absent from its typing position or is present at the mouse, a hand position detector sends a signal which disables the original/native functions and replaces them by activating the latent functions. Keys outside of the set normally retain their native functions, although preferences could be adjusted so that these other keys become temporarily disabled during transformation. Usually the transformed keys lie directly under the fingers of the non-mouse hand and can be used to trigger their new function or programmed macro with a single keystroke. The function or macro can consist of or contain mouse clicks, keyboard shortcuts, tool selections, navigation tools or the numeric characters making up a numeric keypad. Most of the new functions would be momentary, but some, such as tool and tool method selections, CAD operations and some clicks, can be latching toggles. Thus this invention creates and automatically enables and disables latent alternative functions for preselected sets of keys in automatic response to the mouse hand being either absent from its keyboard typing position or present at the mouse. Right or left-hand absence from or presence at a particular location is detected by hand position/location sensing of any type. Removal of the mouse hand from its normal typing position or its arrival near or at the mouse (or other pointing device) automatically causes transformation: the turning on or enabling of an alternate set of functions for keys lying under the other hand. All of the mouse clicks and many of the native mouse and keyboard shortcuts and functions can thereby be made available to the non-mouse hand as single keystrokes, including Enter, Backspace and Delete for the left hand and Tab for the right hand.

The ability to separate the operations of moving the mouse and of clicking into different hands is one of the major benefits of the present invention. Removing the click functions from the mouse significantly reduces stress on the mouse hand. For most people it is the mouse that has to be operated by the dominant hand, not the mouse buttons. Anyone who has no trouble touch typing the home keys under the non-dominant hand will have no problem using those same home keys as clicks while the dominant hand is at the mouse. The mouse clicks, most keyboard shortcuts, tool selections and document navigation functions can now lie under the non-mouse hand for single-stroke triggering while the other hand remains at the mouse. This decreases the number of times the mouse hand has to move back and forth between keyboard and mouse. It reduces the need for mousing down menus and makes it possible to activate keyboard shortcuts or macros without reaching or looking down. For example, one can now surf the web with the hand leaving the mouse less often. Mouse-keyboard operational integration and ergonomics are greatly improved. For persons who prefer to click mouse buttons directly on the mouse, this invention provides their non-mouse hand with many new functions including all of the arrow keys, page up, page down, home and end without going very far from the home keys.

Another use and benefit of the present invention is for hand location responsive transformation to be used to automatically and reversibly assign alternate actions to mouse motions, mouse buttons and to the scroll wheel on the pointing device while the non-mouse hand is rotated away from its typing position. It could also use hand location detection to automatically temporarily provide an alternate set of functions for an auxiliary keypad.

Optional floating palettes that appear on the computer screen when transformation is enabled can serve as indicators that transformation (and designating which transformation) has occurred and as a map of new functions and their locations. Since the geometric layout of their function labels exactly matches the layout of the functions on the keyboard, they provide eye-to-hand pattern transfer for intuitive activation of the desired function. The palettes together with the keyboard can be used to program the transformed sets, or multiple keystroke macros can be imported from preexisting software products and converted into hand-position responsive single-key macros.

Hand location detection is usually accomplished by one of the following two basic methods.

A) detection via discrete sensor: hand position/location sensor(s) can be incorporated into the keyboard or its wrist rest and/or into the pointing device, or can be accomplished by a camera with imaging firmware or software;

B) detection without discrete sensor: hand location detection software/firmware can be programmed to toggle transformation on when it first detects a data output from the pointing device indicating any movement or click, and off when it detects the first data output from any key on the mouse side of the keyboard (i.e. the first keypress by the mouse hand when it returns to its side of the keyboard). The transformation means and its activation means can be incorporated into: (1) the keyboard processor, (2) a junction box inserted between the keyboard and the computer (containing for example hand position sensor input, USB input and output), (3) firmware inside the computer, (4) a software driver or application installed on the computer, or (5) incorporated directly into the computer's operating system. The present invention can utilize these options in any combination. Optionally this invention also includes transformation indicators, floating palettes, reprogrammability, shift transform key, general or selective transformation override key, and application specific and user specific transformed keysets.

Refer to FIG. 1 for a general overview of the present invention, and to FIG. 2 for an illustration of its use. Both figures will be discussed later in the “Detailed description of drawings”.

### DEFINITIONS

Definition of the terms: transform, activate, native, latent, transformation mode/state, transformed keyset, enable, trigger, embedded, standby, shift transform, keyboard and mouse as used in this patent application: To transform is to activate transformation, that is, to change the function of a key from its native (original) alphanumeric function (or in the case of some CAD programs from a default set of special functions) to an alternative macro or function that was previously programmed into the key at a latent level (latent meaning without affecting the native action of that key). Detection of a change in hand position/location by a sensing means results in a signal output representing a transformation mode or state, which in turn causes native functions to be replaced by the latent functions or macros predetermined for that state. A transformed keyset is a set of keyboard keys whose functions have been transformed into either function set/keyset T (transition) by state T, keyset M (mouse) by state M, keyset Z by state Z, etc. depending on the output of the hand location detector(s). State and keyset N signifies either native alphanumeric characters or default keyboard, i.e., No transformation (default in most CAD and similar programs is not native alphanumeric, but other functions.) Thus the transformation states are N, (No transformation), T, M, and Z, and the resulting keysets can have the same labels as the states, or if there is more than one keyset for each state, labels such as T and T+ (T+ST, Shift Transform key), or Mg1, Mg2 (a first and second M keyset for general use). To enable means to convert the alternative functions for particular keys from latent to active. Enabling is controlled by the hand location sensors. To trigger means to manually depress a transformed key to produce its action. Embedded means transformed keys with a second transformable function embedded under the first latent layer: when the keyset is enabled by a change in hand position, the first layer is enabled and the embedded second layer is on standby. When a designated shift transform key is pressed, the layers interchange, the embedded becoming enabled and the first disabled. This is analogous to lower case and upper case, with the shift key disabling the lower and enabling (but not triggering) the upper. By default the shift transform key only affects keys with an embedded function, but preferences could be set so that it also affects other keys, causing them to be disabled, or to revert to native. Keyboard signifies either the entire keyboard device, or just the matrix array of key switches. The word mouse is used interchangeably with cursor control device and pointing device. Hand absence from or present at mouse includes any type of cursor control device that is on or at the keyboard.

Additional definitions: Hand absent from keyboard typing position, or −tp means that the hand is not in a position from which it can type, and/or when keyboard hand position sensor detects absence. Generally, in the method and apparatus of the present invention, sensing (for the purpose of function transformation) of hand presence or absence at keyboard typing position would not be affected/activated by a change in the position of the fingers with respect to each other, but rather by a displacement and/or rotation of the forearm and/or of the whole hand. Hand present at mouse, or +m means that a detector has signaled that the hand is at or is very near to the pointing device. The terms position and location are generally used interchangeably, and hand position sensor and hand location sensor are generally used interchangeably, although a hand can leave its typing position without leaving the keyboard completely, i.e., it could still be located at the keyboard but be detected to have left its typing position. Detection of hand position is not a detection of specific finger position or location, but it is a detection of position and/or location of the heel-base, karate edge and/or palm and/or top of the hand, and/or of the hand as a whole. Detection of hand location or position does not necessarily mean direct sensing of the hand itself: when using discrete sensors, in order to determine that a hand is absent from its keyboard typing position or is present at the pointing device, it is not necessary to sense the hand itself directly, since sensing of the position of the wrist, forearm or fingers as a group of fingers could also serve this purpose. Thus anywhere in this patent application that the phrase “keyboard hand position sensor” or the like is employed, it should be taken to signify any means, direct or indirect, that is able to determine if the hand is absent from its typing position or is present at the pointing device. The mouse hand or pointing device hand is the hand that is used for the pointing device, and the non-mouse hand or non-pointing device hand is the other hand. The scrolling device hand is the hand that is used to operate the scrolling device, and the non-scrolling device hand is the other hand; either one can be the same as the pointing device hand. For a user who operates the pointing device with the right hand, the non-mouse side of the keyboard signifies the left side of the keyboard. The keyboard keys lying under the non-mouse hand (non-pointing device hand) are then the keys on the left side of the keyboard. The home keys signify, for the QWERTY system, a, s, d and f on the left side of the keyboard, and j, k, 1 and ; on the right side. Desktop computer is a computer without built-in keyboard or monitor, as opposed to a laptop computer.

Definition concerning sensor means: hand position/location sensing is either solely via software detection of keyboard and mouse usage, or by hardware, that is non-virtual means. Hardware sensing means will be referred to as discrete sensor means, and can include an imaging camera or any other imaging means requiring specific sensor hardware, or photosensor with or without led, or any type of proximity or touch/contact sensor (touch or contact types would be for pointing device only). Of course most discrete sensing will be followed up by signal processing via logic and/or firmware and/or software.

### DISCUSSION

Absence of the mouse hand from its keyboard typing position or presence of the mouse hand at or near the mouse automatically transforms keys under non-mouse hand into mouse clicks, navigation, keys and/or single-stroke keyboard shortcuts and macros. This invention automatically makes functions accessible to the “non-mouse” hand that are not normally available to it, and even functions normally available can be rearranged into a more ergonomic array. The sensing of mouse hand absence from typing position or presence at the mouse can activate the transformation of keys under the non-mouse hand into frequently used keyboard shortcuts that are normally on the “mouse” hand side of the keyboard. Thus the mouse hand can stay at the mouse and its shortcuts now be accessible by the other hand, and now via a single keystroke instead of reaching to press a modifier plus another key simultaneously. The easiest implementation to learn and use is the transformation of one or more of the four “home keys” since usually the four fingers are already resting there: they don't have to be moved, only depressed in place. Implementation can be expanded to include the horizontal row of four keys above the home row and, especially in keyboards that do not have asymmetrically staggered rows of keys, also the row above that and the row below home row, for a total of up to sixteen transformed keys. (Asymmetrical staggering is the norm on traditional keyboards, and is an extremely non-ergonomic carryover from mechanical typewriters that is no longer necessary).

If a right-handed person has no trouble touch-typing the asdf home keys with their left hand, then they will have no problem using these same home keys for clicks while the right hand is at the mouse. For most people it is the mouse that must be operated by the dominant hand, not the mouse buttons. Transformed keys are remembered not by their native alphanumeric function, but by their kinesthetic position in respect to the home keys. The learning curve is surprisingly easy and operation quickly becomes natural and transparent, since new functions become kinesthetically identified with position and pattern; with finger and transformed row, not with old letter. (Four fingers, four columns, each finger has its own column of keys). After a while it requires no thought or conscious attention at all. Persons who sometimes became confused between buttons on a 3-button mouse will find it easier to use 3 home key click buttons on the keyboard because the non-mouse hand does not have the competing task of positioning the mouse. Unlike the mouse, the keyboard is rock solid; it does not have to be held still while clicks are pressed. Dragging and double-clicking become much easier.

One can further add dual functions to transformed keys: an embedded or standby layer which is converted from off to standby when a hand position change converts the embedded layer to active/on. Then when a “shift transform” key is depressed and held down (or, if using a latching toggle ST key or a sticky key feature, depressed and released), the second layer is converted from standby to on and the first layer from on to standby. Thus if the transformed key is pressed while the shift transform key is down, its second/embedded function is triggered. The shift transform key can be an extra thumb key added to the wrist rest, a foot switch, or can be set up to be the space bar, an existing modifier key or a transformed key. Functions which would be particularly undesirable to inadvertently activate could be delegated to this shift transform set, whose keys require two keys to trigger instead of the usual single keystroke of this invention.

Note that in the standard QWERTY keyboard layout, most of the frequently used default shortcut keys (used with modifier) built into the computer's operating system are on the left side of the keyboard, including Quit, close Window, select All, Save, Duplicate, Find, Z, X, C, V, (undo, cut, copy, paste) and Bold. This puts left-handed “mousers” at a great disadvantage. The present invention can place any or all of these as single key shortcuts under the fingers of the right hand while the left is at the mouse, which is a special boon for left-handed mouse users (left-handed people comprise between 11 and 17% of the population). Likewise, for right-hand mouse users, functions which are normally inaccessible to the left hand, such as Enter, Backspace, Delete, command/control-U, -I, -O and -P can be caused to appear under the left hand while the right hand is at the mouse, and now activated with a single keystroke without need for a modifier key.

Any normally inaccessible shortcuts that do not fit into the desired size of a transformed keyset could be programmed into the top level of a contextual menu “plug-in” designed for integrated use with transformed keysets. Thus this invention could include the use of specially designed contextual menus, and the particular contextual menu activated by “right click” (or control-click on Apple/Macintosh computers), could depend on which transformed keyset is active at the moment, i.e., the particular contextual menu displayed would be determined by/linked to the particular transformed keyset active at the moment as well as by the usual contextual clues: text selected, object selected, etc.

This invention can be used with any keyboard layout and any style of keyboard, including split and single-handed. In the case of keyboards designed for single-handed use, the keyboard can be transformed whenever the non-keyboard hand (or foot, etc.) is sensed to be at the mouse, thus placing mouse click keys and/or new shortcut functions under the keyboard hand. This invention could also be used without an actual hardware keyboard, but instead with a virtual, light projected, printed or mock key array such as might be used with devices that detect finger position via sensors on the hands or via optical imaging with a video camera to generate key codes. The pointing device could be virtual also.

Using the present invention to transform one or more of the home keys lying under the non-mouse hand into mouse clicks removes the clicks from the pointing device and places them under the fingers of the non-mouse hand. This makes for enormously more relaxed mousing with less potential for mouse-induced Repetitive Stress Injuries since the mouse hand now has only one task, instead of the stress of doing two things at the same time. It completely eliminates the strain of attempting to keep the mouse from moving while clicking, which is an especially important issue while drawing or doing CAD work. The click-less mouse is the most ergonomic mouse. The present invention is beneficial for the more ergonomic use of all types of pointing devices, particularly for mice, computer pens, tablets, touch pads and touch screens. In addition, eliminating the constraint of having to integrate click buttons into the design of a pointing device opens up a wider range of creative options for the design of highly ergonomic pointing devices.

Additional mouse controls can be included in the transformed keyset lying under the non-mouse hand, including either momentary or toggling controls for mouse sensitivity or speed, controls for toggling between acceleration and absolute modes, scroll settings, zoom controls, axis interchange control (to provide z-axis motion), and a momentary disengage clutch control to allow particular types of pointing devices to be repositioned without moving the cursor. Furthermore, since “mouse click” switches are no longer needed on the mouse, any switches on the mouse could now be reassigned to less frequently used functions such as the mouse controls just mentioned above, particularly those of the latching toggle type so that they do not have to be held down. Alternatively, one could have just a scroll device on the mouse.

The clutch control mentioned in the above paragraph would be a momentary switch on either the mouse or the keyboard to temporarily prevent the motion/position signal output of the pointing device from having any effect. This could take the form of interrupting data output, or of preventing response to data output. It would eliminate the need to lift a mouse off a surface to reposition it, and would allow recentering a pointing device without having the cursor centered on the screen, which can be of special value when using certain types of pointing device in a “slow” mode where the full pointing device range covers only a small area of the screen (as when doing high resolution or pixel-by-pixel work).

One can choose to have keyset M (for used with Mouse) enabled by either the mouse hand's absence from its typing position −tp (requires sensor tp at keyboard) or its presence at the mouse +m (requires sensor m at mouse). Transformations activated by the −tp state become available to the non-mouse hand the instant the mouse hand leaves its typing position (i.e., when the tp sensor at the keyboard indicates that the mouse hand is absent from its typing position. Simultaneously the native letter and punctuation functions of the transformed keys become unavailable. The mouse hand can be taking a rest or a stretch anywhere, or be at the mouse. It could return to the keyboard without traveling all the way to the mouse: if one needed brief access to transformed functions and then wanted to resume typing without needing to move the mouse, one could briefly back or roll away from typing position to cause transformation, and then return to native state to continue typing.

Transformations activated by +m, the presence of the mouse hand at the mouse, allow normal typing by the non-mouse hand until the mouse hand arrives at the mouse and activates the m sensor, but do not provide transformation functions until then. With the sensor m at the mouse and the mouse hand at the mouse, if it becomes desirable to briefly type a few characters with the non-mouse hand that were disabled due to the transformation, and then quickly return to mousing again, the hand could back or roll off the mouse slightly to briefly return the keys to native state.

Absence of the mouse hand from both typing position and mouse can be used to activate keyset T (for Transition), a second transformed set for the non-mouse hand. This additional transformed keyset usually requires both a −tp sensor at the keyboard and a +m sensor at the mouse (or a pair of sensors on each side of the keyboard, to be described later). It would be activated when the mouse hand is neither at its typing position nor at the mouse (it could be in transition between them, or anywhere else). Thus when the mouse hand leaves its typing position, the keyboard transforms from native (N=No transformation) to keyset T; when it arrives at the mouse, the active transformed set switches from T to M; when it leaves the mouse, back to T; and when it returns all the way to its keyboard typing position, it changes to native keyboard.

Absence of the non-mouse hand from its keyboard typing position can be used to activate a keyset Z for use by the mouse hand at the keyboard. In this way the present invention can create a new keyset for the mouse hand at the keyboard when the non-mouse hand is absent. This requires sensors at the keyboard under both hands (Left and Right tp sensors).

All transformed keysets can include and employ any combination of momentary and toggling keystrokes. Keys transformed into single-stroke actions can be used for any purpose such as zoom, mouse, or scroll controls (keyset M or T), for selecting drawing tools directly without needing to move the mouse to an on-screen toolbar (keyset M and particularly keyset T), for selecting CAD or drawing fill patterns, objects, colors, or textures (keyset T or Z), or for toggling between a numeric/calculator keypad, telephone keypad and a multimedia remote control key array for the mouse hand (keyset Z). Any or all keysets can be application specific. Keysets can also be user specific, i.e., linked to user name.

To summarize the possible transformed keysets for individual sensors under each hand (pairs of sensors under each hand provide additional options and will be introduced later in the detailed discussion of FIGS. 18 and 19) one can employ either (the term keyset as used below always also indicates transformed state):

| | | |
|---|---|---|
| 1) | keyset M only, activated by either −tp or +m; | needs tp or m sensor |
| | (or software/firmware monitor of mouse and | |
| | mouse side of keyboard activity) | |
| 2) | keysets T and M (M activated by +m); | needs L&R tp sensors |
| | | and m |
| 3) | keysets T and M (+m) and Z; | needs L&R tp sensors |
| | | and m |
| 4) | keysets M (−tp) and Z; | needs L&R tp sensors, |
| 5) | keyset Z only; | needs L&R tp sensors |
| 6) | keyset −K; | needs L&R tp sensors, |
| | | and m, |

or L&R and a reference sensor on the keyboard (see FIG. 11D). (Additionally the use of a pair of sensors on each side of the keyboard will provide additional options; to be discussed in the detailed description.)

Example of M transformed keyset in action (described for right-handers):

0) Beginning with both left and right hand in typing position.

1) Right hand moves from keyboard to mouse, causing transformation (either via −tp or +m) from native to keyset M, palette for M appears on left side of screen showing new M keyset functions now available for the left hand home keys plus for the rows of four keys above and below the home keys.

2) Right hand returns to typing position, transformation reverts back to native, palette disappears.

Example of T and M transformed keysets in action (described for right-handers):

0) Beginning with both left and right hand in typing position.

1) Right hand is removed from typing position, causing transformation from native to keyset T, palette for T appears on left side of screen showing new T functions for left hand home keys plus for the row of four keys above home keys.

2) Right hand arrives at mouse, causing transformation from T to M, palette and functions for T are replaced by palette and functions for M.

3) Right hand leaves mouse, M keyset and palette automatically transforms back to T.

4) Right hand returns to typing position, transformation reverts back to native, palette disappears.

Hand location responsive transformation can also be used, not only for the transforming of keyboard key switch functions, but for providing an alternate set of actions for mouse motions, mouse buttons and/or scroll device functions for pointing devices while in a transformation state.

### FURTHER ADVANTAGES

Keyboard keys are more ergonomic to use for mouse clicks than buttons on a mouse partly because keyboard keys have a longer stroke, allowing the finger to attain some momentum before bottoming out, like piano keys. The stroke can be relaxed and satisfying, whereas the sensitive, low momentum short stroke of a mouse button (which is necessary in order to avoid moving the mouse at the same time) is often more of a quick spasm, which tends to build tension in the mouse hand over time, particularly because of the added strain of holding the mouse motionless while clicking (which has become even more of a problem in the new low friction easy-gliding optical mice) and compounded by the less than ergonomic nature of the muscle and joint movements used in positioning the mouse. Because the mouse button has to be so sensitive, it is easy to activate it inadvertently. Preventing inadvertent activation can add even more tension. Therefore using the non-mouse hand to click by pressing keyboard home keys is much more ergonomic than clicking on the pointing device. Ideally, keyboard layouts should have at least one click key in a home key position, for example in place of where the letter F and J keys are in QWERTY. The present invention effectively provide this: the ability to use keyboard home keys for clicking via hand position responsive transformation of the keys into mouse click functions while the mouse hand is at the pointing device, the mouse clicks being provided by the keyboard home keys, which are the most ergonomically placed of all the keyboard keys with the fingers already in position since they normally rest in relaxed fashion on these keys when idle. This is an extremely good ergonomic solution in most cases. Nevertheless, for some people who spend long hours working with CAD or other drawing programs that involve large amounts of clicking, the highly repetitive clicking by the same finger on the standard keyboard keyswitch can become a problem. One solution is to transform more than one of the home keys into the same click function, thereby providing a choice of two, three, or four keys (and therefore also fingers) to click with. Having two or more fingers alternately share the workload would prevent the problem. Another solution would be to share the clicking workload between the two hands by using standard mouse button(s) on the pointing device with one hand and keyboard home keys transformed into click switches with the other hand. Thus the present invention provides the new and unique ergonomic options of either: 1) using no buttons at all on the mouse, employing only the transformed keyboard for clicking; 2) using a only a single button on the mouse with the transformed keyboard sharing the workload via a keyboard click switch and optionally a double click switch (which provide the additional benefit of separating the task of moving the mouse from the task of holding down the click button while dragging, and also the extremely valuable benefit of not having to worry about inadvertently moving the mouse while clicking or double clicking); 3) on two or three button mice, with the transformed keyboard taking over all other mouse click functions, all buttons on the mouse can be programmed to trigger left click so that the workload can be alternately shared between two or three fingers on the mouse hand. Right click could either be a dedicated transformed keyboard keyswitch, or the keyboard modifier could be held down together with either the mouse or the keyboard left click switch to open a contextual menu. To summarize, it is easy to use the present invention with a two button mouse in such a way that left click is shared between four fingers, two on each hand, with many similar options possible.

For a right hand mouse user while the right hand is at the mouse, the left hand at the keyboard is capable of contributing to editing only by fumbling to depress a usually awkwardly placed modifier key along with a letter key to cut, copy, paste, select all, etc. Other very important functions needed very frequently during editing are the four arrow keys, Bold, Italics, Underline, Print, comma, period, parenthesis, Backspace/Delete, Forward Delete and Enter, none of which are easily accessible to the left hand at the keyboard. This requires the mouse hand to make many extra trips back and forth between keyboard and mouse, even when not typing alphanumeric characters. With the automatic hand position responsive keyboard transformation of the present invention, it is possible to make available all of the above functions to the left hand in an ergonomic fashion, as well as to take some or all of the clicking workload off of the mouse hand. In addition, the original, i.e. native functions of the left side of the keyboard can be made instantly available by simply holding down an “OverRide Transform” or ORT key (either a mouse button on the pointing device assigned for that purpose, or any modifier key such as shift or command, set up in preferences to override transformation and apply a command modifier to whatever alphanumeric key is pressed at the same time), thus causing the triggering of Select All when a is also pressed, Save when s is also pressed, etc.

A nearly infinite number of configurations of transformed keysets are possible, each with its own advantages, and the particular one chosen depends on the applications being used and the individual workstyle and preferences of each user.

### SUMMARY OF ADVANTAGES

The present invention provides:

1) More relaxed clicking and mousing.

2) Less traveling back and forth between keyboard and mouse, and less stress on the mouse hand.

3) The screen cursor will not move even a single pixel while a click is being actuated.

4) Standard keyboard shortcuts can be triggered by a single keystroke without reaching for a function key and without needing to press a modifier key.

5) Standard keyboard shortcuts not normally available to the non-mouse hand can be made accessible to it (particularly helpful to left-handed mouse users).

6) Enter, Backspace, Delete and Tab functions not normally available to the non-mouse hand can now be accessible to it (particularly helpful for right-handed mouse users).

7) Less mousing to title bars to drag down menus.

8) Tool selection from application-specific palettes without using the mouse.

9) Provides easily accessed alternative functions for mouse motions, mouse buttons and scroll wheels on pointing devices.

10) Lightning fast surfing and editing.

The beauty of having automatic sensing of hand position activate keyset transformation is that the user does not have to do anything extra, anything intentionally, consciously or purposefully to activate transformation. Transformation simply occurs in the course of the normal use of pointing device and keyboard. The non-mouse hand fingers of the user very quickly come to subconsciously, automatically know that when the mouse hand is absent from the keyboard (or present at the pointing device) the new set of functions are now under the fingertips, and usage becomes completely transparent.

Additional Features

A shift transform ST key can be designated to activate secondary functions embedded in some or all keys of an active transformed set. One can activate secondary functions in a transformed keyset by first pressing and holding the shift transform or ST key. One of the best ways to actuate ST is via a mouse button on the pointing device. Having most or all click functions taken over by the keyboard home keys frees up mouse buttons to be reassigned to less intensively used functions such as ST. The ST function could also be assigned to an existing modifier such as the shift or the command key, to an extra thumb switch or thumb key added to the bottom edge of the keyboard or the top edge of the wrist rest, or can be set to be the space bar, a transformed key or a foot switch. Functions which would be particularly undesirable to inadvertently activate could be delegated to this embedded shift transform set. Thus, depressing a shift transform key simultaneously with a transformed key can be used to trigger a second function for that key, if that secondary function was previously programmed into that key at the embedded level. The shift transform key could be set up to either have no effect on other keys of the set, act as a modifier for some or all of them, and/or revert some or all of the other keys back to their native functions. It could be set to be a momentary, a toggle or a sticky key. It could be a modifier key that is set up to simultaneously perform the shift transfer function when transformed; in this way it would shift embedded functions to the active state, modify them, and still be available to use as a modifier of mouse clicks or alphanumeric keys.

If the shift transform key is a mouse button it can be momentary. It can also be momentary if it is a thumb key because it is easy while holding down the thumb to trigger the new functions it brings up with one of the other four fingers. A momentary shift transform thumb key can be either a modifier key reachable by the thumb, or a centrally located dedicated extra thumb key, below the space key on a traditional keyboard. A shift transform key can also be set up to be either a sticky key, a latching toggle key (analogous to a caps lock key), or a toggle key with automatic time-out release (set to release in a preset number of seconds, preset within a range of, for example, 3 to 8 seconds, enough time to cut and paste). A sticky or a toggle type allows a wider range of shift transform key positions and actuating fingers without interfering with the subsequent triggering of the functions it brings to the active level. The shift transform key itself could be a transformed key.

Optionally included in this invention is the ability to provide a choice of more than one transformed keyset for each hand position, i.e., more than one each of keysets M, T, and Z. The choices could be selected by setting preferences, by a menu, by toggling sequentially through choices with key or voice commands while in that hand position, and/or by using palettes with toggle keys or multiple selectable tabs. The use of dual sensor pairs, to be described in the detailed description of the figures, provides two additional Z keysets based on different combinations of hand positions. If set up to be application specific, the keyset designed for and linked to a particular application would be automatically chosen.

An optional override transformation, or ORT key can be included. It can be designated to be any existing switch as mentioned above for the ST key, and can be momentary, sticky or a latching toggle; it can be universal (override all transformation) or selective/partial; it can act alone, or it can include automatic activation of a modifier key for all or for only some of the keys in the set. Overriding all transformation would allow normal (native) typing with the non-mouse hand. A momentary ORT switch or key (preferably actuated by a mouse button on the pointing device or by the thumb of the non-mouse hand) can be set up to selectively revert only some transformed keys back to their native assignments, while leaving others transformed. This would be useful when some of the keys in a transformed set are used with a modifier key as shortcuts when in native mode. If the native shortcut modifier key (“control” key in the PC world, “command” key in Macintosh) is set up to transform into a selective override switch which temporarily disables transformation for keys with native shortcut functions while at the same time still generating its modifier function, then when the latter keys are pressed together with this modifier key, they revert to their native functions, and since they are typed while holding down the modifier, they produce the original native shortcut. Because this override switch is selective, it still allows transformation of other keys. When the key that is serving as both override and modifier is released, then the native keys again become transformed. As mentioned previously, a shift transform key also can serve as a selective override switch, shifting some transformed keys to secondary transformed functions, while reverting others back to their native functions.

For particular keysets, some native keys could be transformed and other native keys disabled. For situations where a pointing device is extremely close to, or is on the keyboard, the sensing of a shift in mouse-hand position (to operate the pointing device) can be used by this invention to not only activate the transformation of keys under the non-mouse hand, converting them to a new keyset (set M), but also to disable keys lying near or under the mouse hand when it is in “mousing” position, thus preventing an inadvertent keypress (in the course of using the pointing device) from producing an action. For the purpose of this invention, “absent from keyboard” is defined as when the sensor detects absence, this preferably being when the fingers can no longer reach to actuate the keys. Keyset transformations are activated by hand position/location in the course of making natural hand movements to remove the fingers from the keys and/or to travel to the mouse.

Hand Position Sensors

Any method of detecting hand location, absence from or presence at keyboard typing position, or absence from or presence at pointing device may be employed in this invention. Hand position/location sensor(s) can be incorporated into the keyboard or its wrist rest and/or into the pointing device. The blocking/unblocking of ambient light, the interruption or unblocking or reflection of a light beam, or any type of proximity, contact, touch or pressure sensor can be used (for example, utilizing capacitance, resistance, light, heat, or ultrasound) with the exception that mechanical sensors would not be used at the keyboard. Keyboard sensors need to be of a non-contact type with some distance range, since often the heels of the hand are lifted above the keyboard/wrist rest while typing. Sensors can be integrated into the keyboard, the pointing device, or into a wrist rest or hand rest associated with either. Any combination of detector types may be used, i.e., one type at the keyboard and a different type at the pointing device. Usually sensors would be designed to activate in a momentary (as opposed to on/off toggle) fashion. One type of sensor embodiment would be a momentary type of proximity, pressure or contact sensor at the mouse. Another embodiment of a mouse sensor could use a single photosensor which is covered by the hand while the hand is at the mouse. This photosensor would detect the blocking of ambient light. A threshold control would be needed to adjust for the amount of ambient light. A preferred sensor embodiment for the mouse, especially if the ambient light intensity fluctuates, is to add a second photosensor which is never blocked and serves as a reference for the ambient light intensity. The ratio of the outputs of these two photosensors would be completely independent of ambient light intensity over a very wide range, and would provide a signal which indicates when the first photosensor is covered by a hand. For the keyboard, the simplest sensor would be analogous to the single photosensor mouse sensor embodiment. One could just use only one photosensor under the mouse hand at the keyboard, or, for an ambidextrous keyboard sensor means (i.e., one that can be used with the mouse on either its left or its right side), one under each hand.

A first sensor embodiment for the keyboard is an inexpensive, reliable and ambidextrous position sensor method which utilizes a pair of upward looking photodetectors (such as tiny phototransistors, one under each hand) embedded either in the keyboard between keys or below the keys or incorporated into a narrow strip attached to the keyboard surface or below the bottom edge of the keyboard, or in the wrist rest. They would be positioned so that in normal typing position each hand at least partially blocks ambient light from falling on the detector underneath it. If one hand departs from its typing position, the photodetector that was under it will see more than, for example, double the ambient light than the other photosensor, which still has a hand over it. This activates key transformation, which remains in effect until the ratio of light detected drops below, for example, 1.6 (1.6 providing a comfortable 20% hysteresis differential from the trigger threshold of 2.0). Electrically this can be carried out by ratioing the output of the two light detectors, and then comparing this ratio to reference voltages via comparators which have hysteresis. This method provides immunity to changes in overall ambient light intensity over a very wide range, since each photosensor serves as an ambient light intensity reference for the other, and it is only the ratio of the two intensities that activates transformation. In a darkened room, the smallest reading lamp can provide enough ambient illumination for proper photosensor functioning. Those who prefer or need to use their computer in as dark an environment as possible could satisfy the requirement for ambient light with an IR LED or other IR source. If both hands are absent from their typing positions, no transformation will occur.

A second type of optical hand position/location sensor embodiment is a beam of light (preferably IR, from an Led) together with a photosensor mounted fairly closely alongside the led and facing in approximately same direction. The light source would be pulsed, and the output of the photoreceptor would be filtered synchronously in phase lock with the pulsing of the light in order to effectively blind the photoreceptor output to ambient/background light. When the hand is absent, the receptor output contains very little signal from the pulsed light; whereas when the hand is located so that some of the pulsed light reflects off it and back to the photoreceptor, the photoreceptor output registers the presence of the hand. The sensitivity of this sensor arrangement could easily be adjusted to detect the hand within a range of zero to three inches, which would be the approximate desired range for distinguishing between presence and absence of the hand at mouse or at keyboard typing position. If pulsed light sensors are used under both hands at the keyboard, in order to prevent crosstalk the L and R sensors could be operated at different frequencies.

A third type of optical hand position/location sensor embodiment can be a beam of light (from a Led) which impinges on a photosensor, where the hand can block the beam, preventing it from reaching the photosensor. This could also include pulsing the light, and filtering the output of the photoreceptor in phase-locked fashion with the light source, in order to eliminate interference by ambient/background light. The LED and sensor can either be facing each other at opposite ends of the light beam, or both facing in the same direction and placed close together with the beam reflected off a retroreflector, or off a mirror (concave, or with a pcx lens in front of it). The beam can be positioned to be blocked by the presence of the hand at the keyboard or the mouse, or to be blocked by the hand when it is in transit between the keyboard and mouse. The latter would require it to be used as a toggle, as opposed to momentary mode (an ambient sensor could also be set up as a toggling transit sensor).

Unlike momentary sensors, toggling transit sensors can allow a person to purposefully bypass (for example, over or around) the sensor when the hand is moving in either direction. To prevent confusion, it would be best if toggling-type transit sensors of any type have the ability to sense the direction of the transit pass, for example, to toggle transformation on when passing from keyboard to mouse, and off when moving from mouse to keyboard. A pair of ambient sensors or parallel beams side-by-side, together with the electronics to determine which beam is interrupted first, would accomplish this purpose.

Another hand position sensor method is the use of a capacitative proximity sensor, consisting of a (thin) conductive electrode mounted on, in, or under the surface of the keyboard, wrist rest, or pointing device and connected to a capacitance measuring circuit.

Any other means of sensing hand presence at mouse or keyboard or absence from typing position at keyboard could be used including, but not limited to, the use of heat radiating from the hand, the sensing of an object attached or adhered to finger, hand or wrist such as ring or small object or bracelet, or the optical imaging of hand position by a video camera together with image processing firmware and/or software. In any case, the keyboard and/or pointing device themselves can be either actual hardware, or can be virtual. In summary, hand position detection can be carried out by either A) discrete sensors (which can include imaging type sensors), or by B) firmware or software monitoring of normal data output from the pointing device and from the mouse-hand side of the keyboard.

Transformation Indicators and Palettes

Transformation indicators may optionally be incorporated into the present invention. Any method for indicating when and which transformation has occurred may be used. The indicator can utilize sound, for example a brief rising tone when a transformation occurs, and a falling tone to signal when the keyboard has been returned to normal. It could also or instead use light, such as a LED on the keyboard or on a processor/junction box, or an icon on the screen, using for example green for normal/native and a different color for each transformed keyset. Instead of or in addition to an icon on the screen, the cursor itself could be automatically transformed by hand position along with the keyset. Cursor color, shape, and/or animation can be used as an indicator. Visual transformation indication can also take the form of hand location specific (and optionally application specific) on-screen floating palettes/windows containing a diagram of the transformed keys in the same pattern as they are arrayed on the keyboard. These palettes can be customizable, editable, resizable, movable, optionally transparent, and can, along with their keyset, automatically change to match the open application. Changing automatically to match the open application can be employed for keyset T or Z when used for tool selection, where one expects to look at the palette to find tool location each time anyway. The main general use keyset, keyset M, should remain relatively constant so that the fingers remember it kinesthetically and one does not have to look at the palette while using its keys. Palettes can be programmed to become visible (or to change appearance such as by becoming highlighted or outlined) only when the keyset they display is activated. They can also be used to reprogram or help in reprogramming the functions of the keys to be transformed, and as a visual reminder of the pattern of transformed functions on the keyboard, as well as showing the secondary functions that are embedded and ready to be enabled by the shift transform key. The particular palette that appears on screen depends on which keyset has been automatically selected by the hand position sensors. If the keyboard consists of a LCD touch-screen, the letter labels on each key could automatically change to reflect their function at the moment.

If desired, the palettes could be programmed so that in addition to pressing keyboard keys to trigger actions, functions can actually be clicked inside the palette to trigger them, like normal tool bars, except that in this invention the particular palette that is on screen at the time depends on the hand position at that time. (But it is much more convenient to simply click the transformed key directly on the keyboard instead of mousing to the tool bar.)

Thus palettes can serve as indicators of activation of each transformed set as the hand(s) change positions. They could also indicate each key depression by highlighting the triggered function. The palettes and the transformed keysets they depict can be right or left-handed user specific, and can be individualized further for each user. They provide intuitive eye-to-hand pattern transfer for selection and activation of desired functions and tools via the keyboard. This use of palettes together with autosensing of hand position to automatically transform keys brings a new level of integration to keyboards and pointing devices.

Setup and Programming

Setup and programming in this invention refers to selecting and configuring keysets to be transformed, and selecting and customizing palettes. Setup can consist of: 1) entering user name, 2) designating right or left hand use of mouse, 3) choosing palettes for each hand position, 4) specifying whether a palette is for general use or is to be application specific, 5) choosing on-screen location and other characteristics for each palette. Programming can be accomplished in any number of ways including via the keyboard alone, or with keyboard and on-screen palette, together with any kind of “program” key. For example, the user could in sequence: 1) press the program key, 2) press the key in the location to be transformed (either on keyboard or by clicking in palette), 3) press the keyboard key or macro desired for that transformed location to activate, 4) save by either pressing the program key again or a save key. The user would also choose and program a shift transform key when secondary functions are to be used. A toggle key could be specified to use for removing palettes from the screen. The large number of potential combinations and permutations of the features and options offered by this invention would of course be narrowed down through beta testing to the most generally desirable and efficient configurations in practice, while still leaving some preferences and programability to the individual user. Users can choose to use a preprogrammed keyset, or to create their own. The present invention can be configured very simply at first, and more capabilities can be added later if desired. For example, initially a transformed set could consist of only a transformed home row containing left click, double click, right click, and enter, and then later more rows and eventually the use of a shift transform key could be added. Users can tailor the features to their particular needs. This invention provides tremendous benefits to the user, and its operation becomes second nature in a very short time.

### DRAWINGS—FIGURES

FIGS. 1A to 1D show an overview and operation of a preferred embodiment, depicted for right hand mouse users.

FIGS. 2A to 2D illustrate the use of a three-sensor embodiment by a right hand mouse user.

FIGS. 3A to 3D show a retrofit carrier strip with two hand position sensors and optional extra thumb keys for use with preexisting keyboards and laptops.

FIGS. 4A to 4D show a retrofit wrist rest with embedded sensors and extra thumb keys for use with preexisting keyboards and laptops.

FIG. 5 shows an optional junction box with sensor inputs and containing logic for selecting transformed keysets.

FIGS. 6A to 6C show a strap-on thin sensor-carrying strip for retrofit to the tops of existing keyboards and laptops.

FIGS. 7A and 7B show a clip-on thin sensor-carrying strip for retrofit to the tops of existing keyboards and laptops.

FIGS. 8A and 8B show an elastic slip-on thin sensor-carrying strip for retrofit to the tops of existing keyboards and laptops.

FIGS. 9A to 9E illustrate some possible sensor locations and combinations, together with a truth/logic table showing the transformed keyset activated by different hand locations.

FIGS. 10A to 10E show preferred embodiments of ambient light detecting hand position sensor and demonstrates their use.

FIGS. 11A to 11D show alternate embodiments of ambient light detecting hand position sensors.

FIGS. 12A and 12B show hand position detectors on keyboards with built-in pointing devices.

FIGS. 13A to 13E demonstrate examples for implementing the keyset selector logic tables of FIG. 1C and FIG. 9A through 9E, using ambient light sensor configurations of FIGS. 10A through 10E and FIGS. 11A through 11E.

FIGS. 14A and 14B show schematics for manual and automatic sensor balancing.

FIGS. 15A to 15E show the use of hand location responsive transformation to provide an alternate set of functions for mouse movements, buttons, and scroll device.

FIGS. 16A to 16C show the use of hand location responsive transformation to provide two alternate sets of functions for an auxiliary keypad.

FIGS. 17A and 17B show the use of hand location responsive transformation to provide alternate sets of functions for mouse functions and an auxiliary keypad when they are used together.

FIGS. 18A to 18E introduce and demonstrate the use of sensor pairs on one side of a keyboard.

FIGS. 19A to 19K demonstrate the use of dual sensor pairs on a keyboard.

FIGS. 20A to 20C show thin sensor pair strips for retrofit to keyboards.

FIGS. 21A to 21C show thin sensor pair strips for retrofit to keyboards, with variable distance between sensors.

FIGS. 22A and 22B show pulsed IR hand position sensors.

FIGS. 23A and 23B show capacitative proximity sensors.

FIG. 24 shows hand position sensing via optical imaging of the hands.

FIGS. 25A to 25C detail the detection of hand location via software/firmware monitoring of data output from the mouse and the mouse hand side of the keyboard (no discrete sensor).

FIGS. 26A to 26D show some possible on-screen indicators of transformation, including alternative cursors.

FIGS. 27A and 27B show automatic palette zoom methods.

FIGS. 28A to 28C illustrate three basic types of QWERTY keyboard key matrix layouts for the purpose of showing the derivation of the rectilinear palette matrix used for on-screen palettes.

FIGS. 29 and 29′ illustrate keysets and on-screen palettes with their four home keys transformed into clicks and Enter or Tab.

FIGS. 30 and 30′ demonstrate the keysets and palettes of FIG. 29, but with the ORT key depressed, overriding all transformation.

FIG. 31 illustrates possible chording of the transformed keys of FIG. 29.

FIGS. 32A to 32B′ demonstrate the effect on a simple transformed keyset of pressing an ORT key which is combined with a modifier.

FIGS. 33A to 33D display native keyboard alphanumeric assignments and preferred palette/transformed keyset embodiments for transformation state M.

FIGS. 34A and 34B show the method of using a transformed key to toggle between two different M keysets, Mg1 and Ma1.

FIGS. 35A to 35C illustrate examples of palettes designed particularly for standard staggered row keyboards, with general use and navigation functions for transformation state M, and another palette without any click functions for a state M or T.

FIGS. 36A to 36C show basic palettes for use with standard staggered row keyboards in CAD applications; palettes shown first with alphanumeric character assignments for text tool, then with M keyset and then T keyset.

FIGS. 37A and 37B show windows on a computer screen containing two possible configurations of multiple on-screen palettes for use in selecting tools in CAD applications, using the standard keyboard.

FIGS. 38A and 38B show basic palettes for use with rectilinear keyboards in CAD applications; palettes shown first with alphanumeric character assignments for text tool, and then with M keyset.

FIGS. 39A and 39B are palettes displaying a synergistic pair of keysets, M and T, for CAD, using rectilinear keyboards.

FIGS. 40A and 40B show computer screen windows with two different configurations of multiple on-screen palettes for use in selecting tools in CAD applications, using a rectilinear keyboard.

FIG. 41 shows detailed keyboard output code signal routing.

FIGS. 42A and 42B show an example of a keyboard code transformation list and the implementation of code transformation list toggles.

FIG. 43 shows examples of implementation of code transformation list pointing device clutch.

FIGS. 44A and 44B show examples of implementation of code transformation list pointing device speed control

FIG. 45 shows detailed signal routing for transformation indicators and on-screen palettes.

FIG. 46 is an example of the contents of a setup and preferences window.

FIG. 47 is an example of an on-screen window for programming transformed keysets via a keyboard and palettes.

FIG. 48 shows a junction box embodiment with firmware detection of hand location (no external sensor), and with choice of preprogrammed transformed keysets.

FIG. 49 shows a junction box embodiment with discrete proximity sensor at mouse and with programmable firmware.

FIGS. 50A and 50B show a junction box embodiment with left and right sensors added below and on top of a standard keyboard, with preprogrammed transformed keysets and reprogrammable firmware.

FIG. 51 shows the embodiment of FIG. 50A with the addition of a hand sensor at the mouse.

FIG. 52 shows an embodiment that incorporates the functions of the junction box of FIG. 51 into a wrist rest, with sensors in the wrist rest and optionally also in the pointing device.

FIGS. 53A and 53B show external keyboard embodiments that incorporate features of junction box embodiments of FIGS. 48, 49 and 50A. (FIG. 53B is the first preferred embodiment).

FIGS. 54A and 54B show software-only embodiments, without any discrete hand position sensor; all features reside in software installed on any desktop or laptop computer. (FIGS. 54A and 54B comprise the third preferred embodiment).

FIGS. 55A and 55B show an embodiment consisting of software installed on any desktop or laptop computer, and including a discrete sensor built into the pointing device, where the sensor signal is incorporated into scan code sent to the computer.

FIGS. 56A to 56C show an embodiment consisting of software installed on any desktop or laptop computer, and including discrete sensors and junction box built into a wrist rest below the keyboard, or sensors in a retrofitted strip on the keyboard with external junction box.

FIGS. 57A to 57C show the embodiments of FIG. 56A to FIG. 56C with the addition of a discrete hand position sensor in the pointing device (and thus a combination of FIG. 55 and FIG. 56).

FIG. 58 shows an embodiment consisting of software installed on computer, plus an external keyboard with built-in sensors and optional sensor built into pointing device. (FIG. 58 is the second preferred embodiment).

FIG. 59 shows a laptop embodiment containing all of the features of the present invention.

FIG. 60 shows a keyboard (which can either be an external keyboard, or the keyboard of a laptop computer) that includes dual sensor pairs with variable spacing.

FIG. 61 is a summary that illustrates possible hand location combinations and the transformed states they can provide as a result of hand location detection.

FIG. 62 is an overview flow chart summarizing the discrete sensor method of hand location detection.

### DETAILED DESCRIPTION OF THE DRAWINGS

Note: Most of the drawings illustrate configurations for operation by right-hand mouse users. For left-hand mouse users a mirror image should be visualized, reversing left and right in the drawing and in its description.

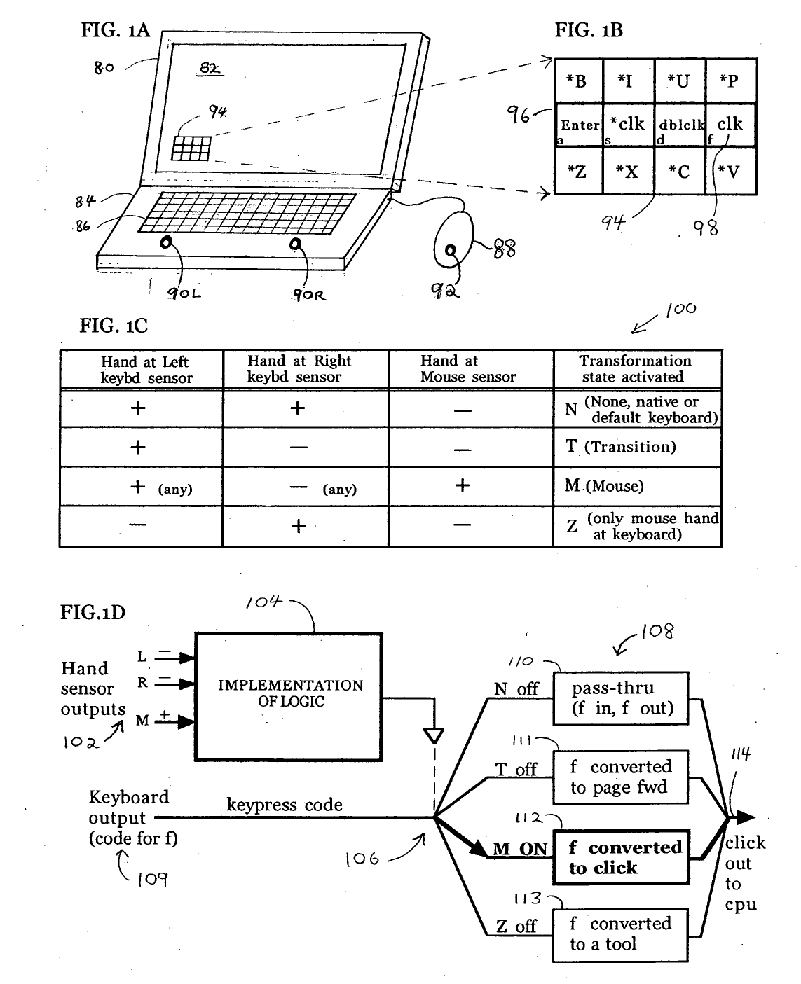

FIGS. 1A, 1B, 1C and 1D provide an overview and demonstrate the operation of a preferred embodiment shown for right hand mouse users”. FIG. 1A illustrates monitor 80, monitor screen 82, keyboard 84, keyswitches 86 and pointing device 88 of a laptop or desktop computer, with three hand-position (presence/absence) sensors: 90L under the left hand typing position, 90R under the right hand typing position, and 92 in pointing device. On-screen floating palette 94 appears and remains present on the screen whenever transformation is in effect, thus functioning as a visual indicator of transformation, and displaying the transformed function for each key of the transformed keyset, arranged in a pattern which matches the actual layout of the new functions on the keyboard.

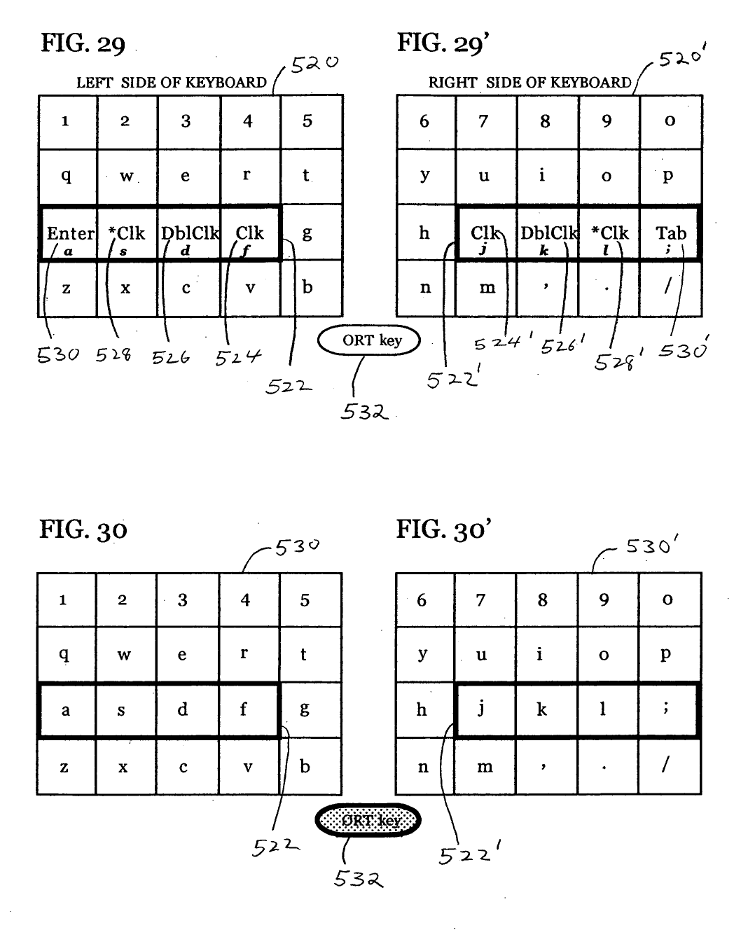

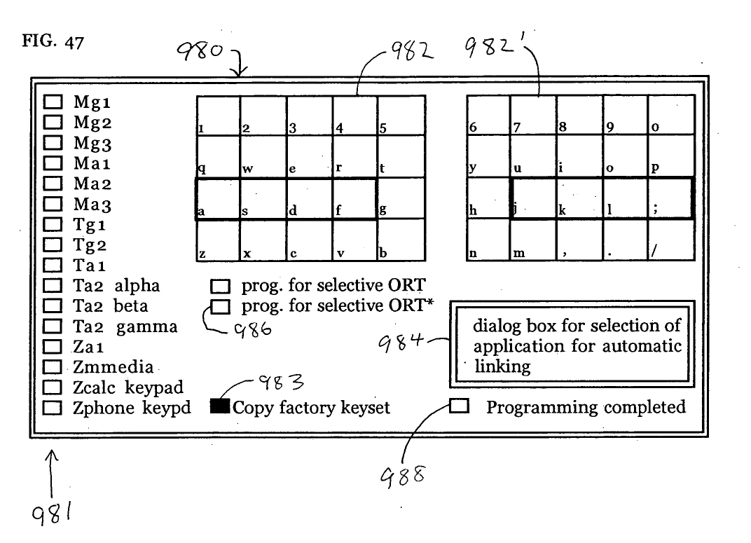

FIG. 1B shows an enlargement of optional on-screen palette 94, detailing the new/transformed actions of the keys in keyset M, with the central more thickly outlined rectangle 96 enclosing the “home keys” labeled a, s, d, and f in the lower left corner of each square to provide positional correspondence to the actual physical keyboard keys 86. The labels in the center of each square of the palette show the transformed functions, with “a” being transformed into Enter, “s” being transformed into Right- or Control-Click. The asterisk * is used throughout this patent application as a “wild card” to indicate a simultaneous modifying command, usually “Control” in the PC world, and “Command” on Macintosh computers (except on Macs when shown with click it is Control). The “d” character key is shown transformed into Double-Click, “f” into Click (98), and in the lower row, “z” into Undo, “x” into Cut, “c” into Copy, “v” into Paste, and in the upper row, “q” into Bold, etc. Note that these new functions need only a single keystroke, without a modifier key. The palette 94 can serve four purposes: 1) as a visual indicator of transformation; 2) to show which particular keyset has been activated (see FIGS. 29 through 40); 3) as a reminder of the action and location of each transformed key; 4) as an aid to creating and reprogramming transformed keysets (to be detailed further during the discussion of FIG. 47). The user can resize or reposition the palette, and adjust its color and transparency. Each particular palette would preferably be positioned to appear on the same side of the screen as the side of the keyboard that it represents.

FIG. 1C is a truth table (100) showing the logic rules by which the transformed keyset state/keyboard mode is automatically determined. The transformed states are : N (None, native or default keyboard), T (Transition), M (Mouse) and Z (only mouse hand at keyboard). The choice of state is determined by the current combination of sensor outputs indicating: presence (+) or absence (−) of a hand at each sensor (keyboard 90L, keyboard 90R and mouse 92) and the logic rules. The on-screen palette and the keyset functions change together as the transformation state changes.

FIG. 1D is a schematic flow diagram that illustrates the choosing of state and keyset M as determined by the outputs of the hand position sensors (in this example the inputs from keyboard left and right sensors 90L and 90R are low, and input from mouse sensor 92 is high. Box 104 represents circuitry, logic, firmware and/or software that chooses a transformation state from a logic table such as shown in FIG. 1C, based on inputs from the hand sensors outputs 102. The transformation state chosen determines the route and conversion of the keypress code via the key function code conversion look-up tables 108. FIG. 1D shows how a high output from the mouse sensor (102, also see FIG. 1C, 100) throws electronic switch 106 into the state M position, so that when the “f” key is depressed, the keypress code for “f” (log) is routed by switch 106 to code conversion table/list 112 for keyset M, which transforms log into click output 114, 98. (Note that in FIG. 1B, palette 94 displays a click (“clk”, 98) in the position of the “f” home key). Other combinations of hand sensor output states 102 (see FIG. 1C, 100) would cause 106 to switch to 110 for N, 111 for keyset T, or 113 for keyset Z. If on-screen palettes are being used, the contents of palette 94 would change to reflect the new keyset functions in each case. All keys that are not included in the currently transformed keyset retain their native functions.

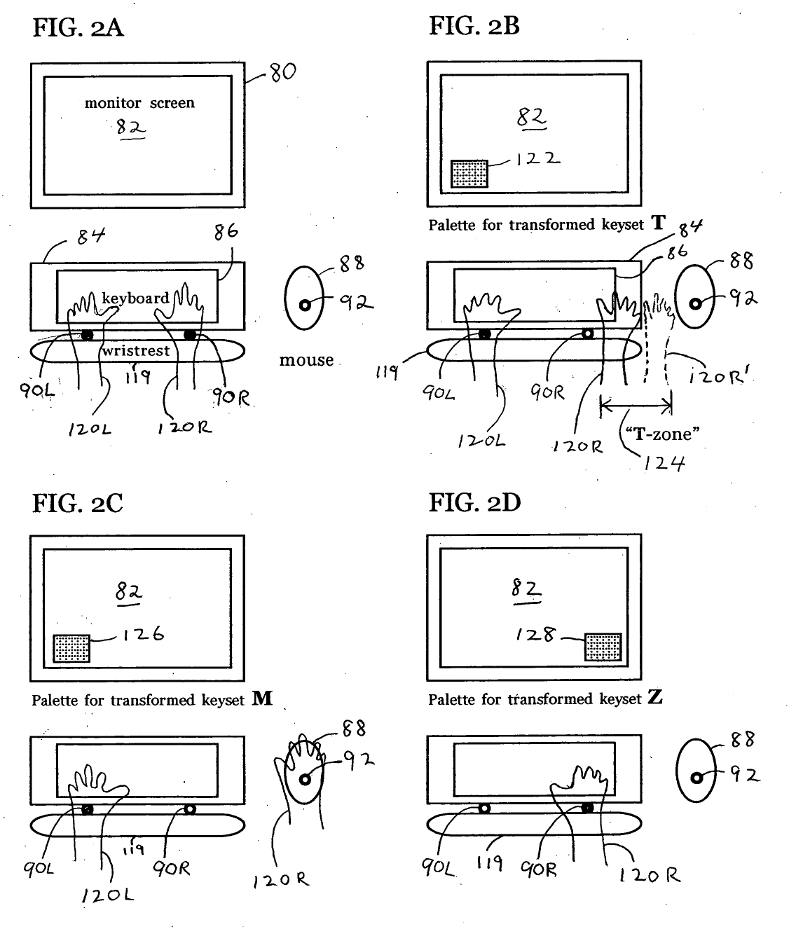

FIGS. 2A, 2B, 2C and 2D are illustrations of the use of a 3-sensor embodiment by a right hand mouse user. A mirror image of these drawings would be used by a left hand mouse user. These figures show top views of keyboard 84, and front views of monitor 80. In these figures the keyboard hand position sensors 90L and 90R are positioned between the keyboard 84 and the top of wristrest 119. An open circle for a sensor indicates that it is sensing hand absence, and a dark dot indicates that it is sensing the presence of a hand. FIG. 2A shows the left and right hands (120L, 120R) present (+,+) in typing position at the keyboard 84, which, by reference to truth table FIG. 1C, results in normal, i.e. “Native” keyboard operation, with no transformation. FIG. 2B shows the right hand 120R having departed its keyboard typing position, (+,−) but not yet at the mouse. This results in State T and transformation into keyset T, for which the on-screen palette for T (122) appears on the left side of the screen 82. Keyset T is in effect whenever the right hand 120R′ is within “T-zone” 124. FIG. 2C shows that when the right hand reaches the mouse, transformation switches to State and keyset M, with the on-screen palette changing to 126 for keyset M. FIG. 2D shows the right hand present at the keyboard the left hand absent (−+). This, by reference to the truth table of FIG. 1C, causes the activating of State Z and keyset Z with its corresponding palette 128 appearing in the right hand side of the screen. In this example, the status of the keyboard as either native or transformed into T, M, or Z keysets is dependent only on the combination of states of the hand position sensors (via truth table), and is completely independent of status history or sequence of hand positions or movements (except for a modest amount of hysteresis built into the sensors or sensor processing circuits for the sake of stability).

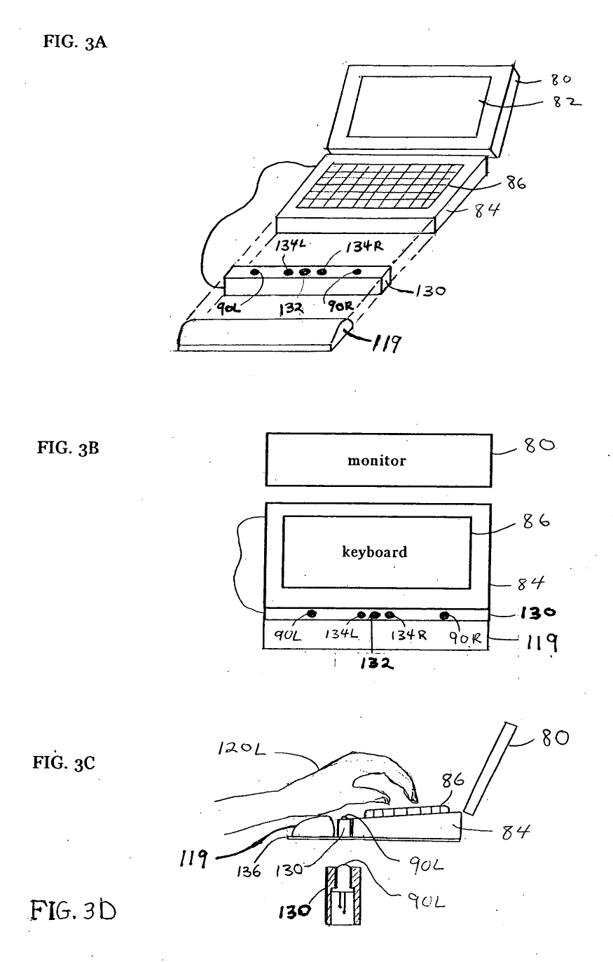

Sensors and Sensor Configurations and Logic (FIGS. 3 through 12)

FIGS. 3A, B, C, and D illustrate hand-position sensors and optional extra thumb keys to use with preexisting keyboards and laptops, using a retrofit carrier strip. FIG. 3A is an exploded perspective view of a retrofit carrier strip or box 130 carrying left and right hand position sensors 90L and 90R, and also optional extra thumb keys/switches, 132 in the center (for ORT) and 134L and 134R (both for ST) on either side. Box is positioned between a computer keyboard 84 and wrist-rest 119. FIG. 3B is a top view of the same arrangement, and FIG. 3C is a side view cross-section illustrating the presence of the left hand 120L in proximity to a keyboard sensor 90L, and also showing optional thin base plate 136 with attached wrist rest 119 and box 130, with keyboard 84 resting on baseplate 136. FIG. 3D is a side view cross-section showing a detail of sensor 90L (in this case an upward facing phototransistor) of FIG. 3A, B and C embedded in box/carrier strip 130. Alternatively, a flat type of photosensor could be affixed directly to base plate 136 between the keyboard 84 and wrist rest 119.

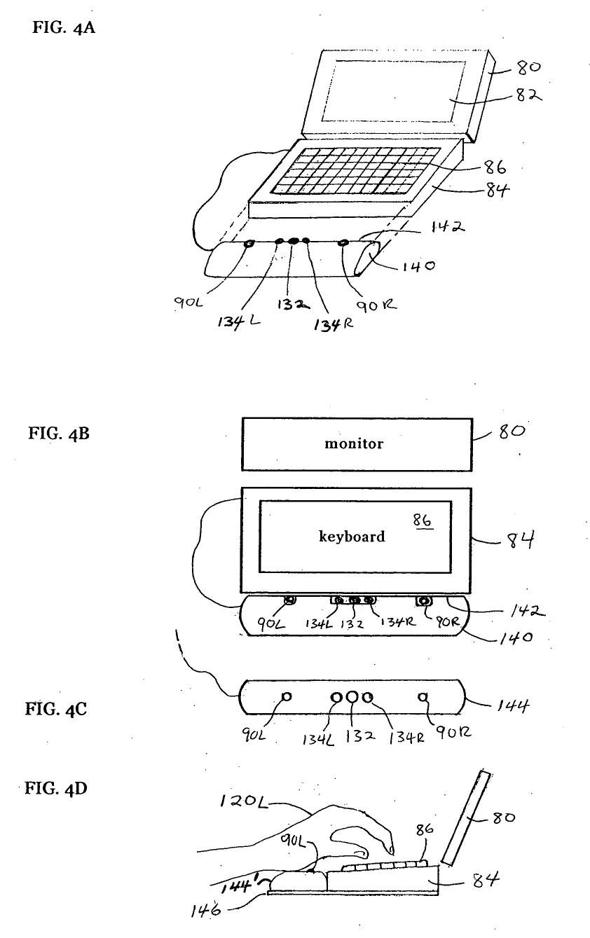

FIGS. 4A, B, C and D show hand position sensors and optional extra thumb keys to use with preexisting keyboards and laptops, using a retrofit wrist rest carrying embedded sensors and thumb keys. FIG. 4A is an exploded perspective view of a retrofit wrist-rest 140 with sensors 90L, 90R, and thumb keys 132, 134L and 134R mounted in its the upper edge 142. FIG. 4B is a top view of the same wrist-rest 140, showing upper edge 142 retrofit against bottom of keyboard 84. FIG. 4C is a top view of a slightly different wrist-rest 144 with sensors and thumb keys embedded more centrally in the wrist-rest. FIG. 4D is a side view cross-section of a variation of FIG. 4C, illustrating sensor 90L under the left hand 120L while the left hand is in typing position, plus optional base plate 146 to which wrist-rest 144′ is attached and which ties the whole assembly together.

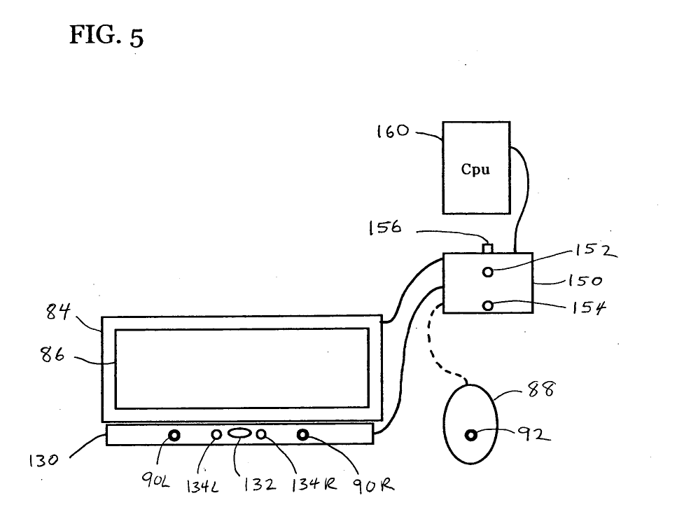

FIG. 5 shows an optional junction box with sensor inputs, and containing logic for selecting transformed keysets. Hand sensor carrier strip/box 130 of FIG. 3 is shown here connected to a junction box 150 which contains sensor signal conditioning circuitry and logic, and led indicator of sensor status 152. Junction box 150 can also contain optional reference sensor 154 and optional sensor adjust/balance control 156. The junction box is connected in turn to computer 160, and in one embodiment sends a signal to transforming software inside the computer which tells it when to transform the output of keyboard 84 and which keyset to transform into; in another embodiment all transformation is done inside the junction box 150 by firmware. The sensor inputs into the junction box can either be from hand position sensors 90L and 90R, from pointing device sensor 92, or from all three sensors.

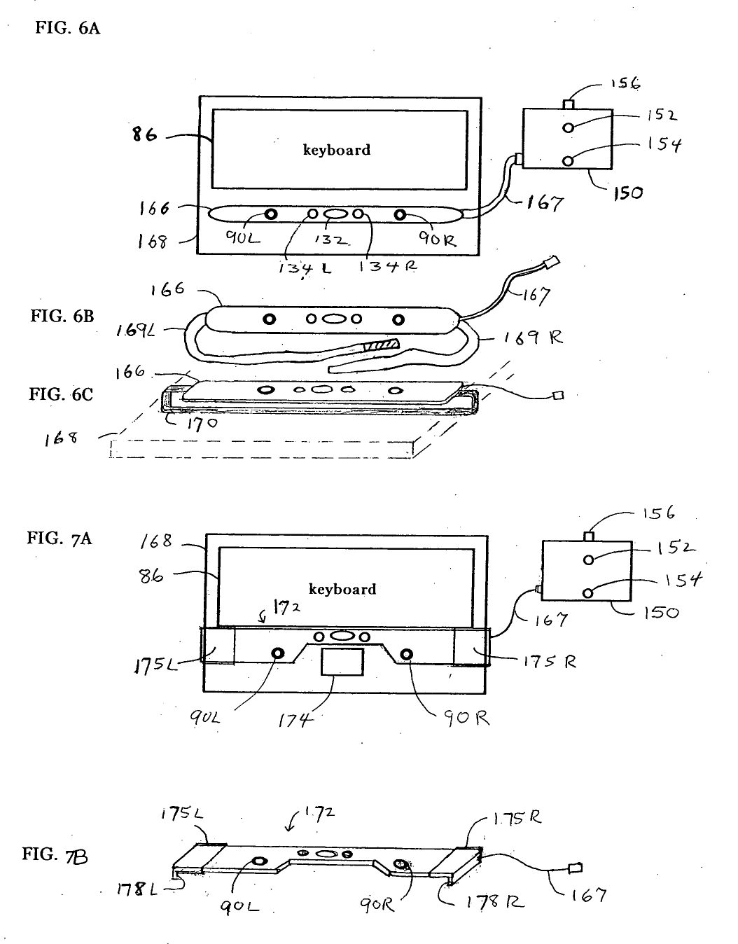

FIGS. 6 and 7 show three different versions of thin sensor-carrying strips for retrofit to the top surface of existing keyboards and laptops. FIG. 6A is a top view of a thin strip 166 carrying sensors 90L and 90R, plus optional extra thumb keys 132, 134L and 134R, resting on top of standard external keyboard/standard laptop 168, and connected by a cable 167 to junction box 150. (Thin strip 166 could easily be less than ¼″ thick, since, for example, suitable phototransistors are available in flat packages less than 3/32″ thick, and membrane momentary switches are available in similar thicknesses.) Carrier strip 166 could either be fixably or removably adhered or attached by any means to the top surface of keyboard 168 or, as shown in the top view FIG. 6B could include flexible straps 169L and 169R originating from the left and right ends of the strip and attached together underneath the keyboard to removably mount the strip to the keyboard. FIG. 6C is a perspective view of strip 166 having, instead of flexible straps, a loop of elastic strap 170 with each end of elastic strap 170 attached to each end of carrier strip 166 to hold it in place on laptop keyboard 168. The position of the keyboard 168 is shown (as if transparent) by dashed lines, and elastic loop 170 is shown stretched under the keyboard and conforming to its shape. FIG. 7A shows a laptop keyboard 168 with sensor carrier strip 172, similar to strip 166, but modified in shape to accommodate the built-in pointing device 174, and with optional axially sliding/telescoping ends 175L and 175R. FIG. 7B is a perspective view of strip 172, showing side tabs/clips 178L and 178R on ends 175L and 175R. Thus strip 172 can be adjusted in length to accommodate any size keyboard, with a spring loaded and/or a locking mechanism to hold it in place. Instead of the sensors 90L and 90R being on the center portion of carrier strip 172 as shown, they could be on the ends 175L and 175R.

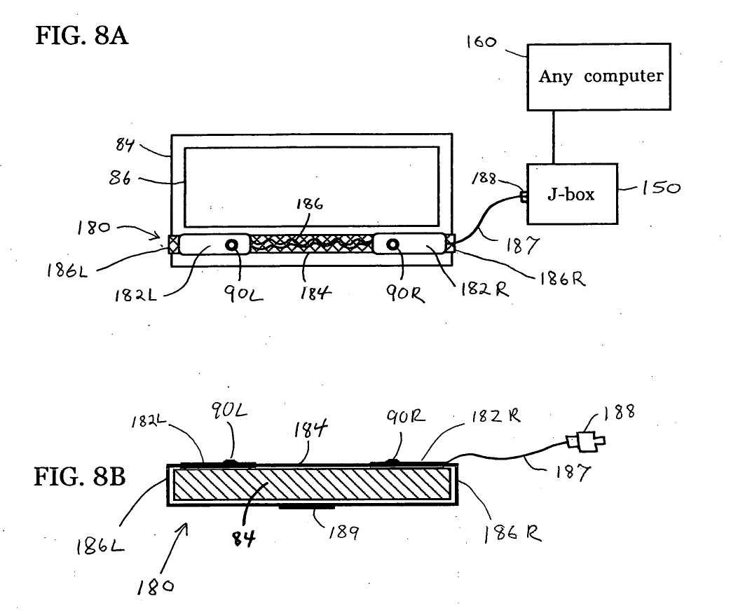

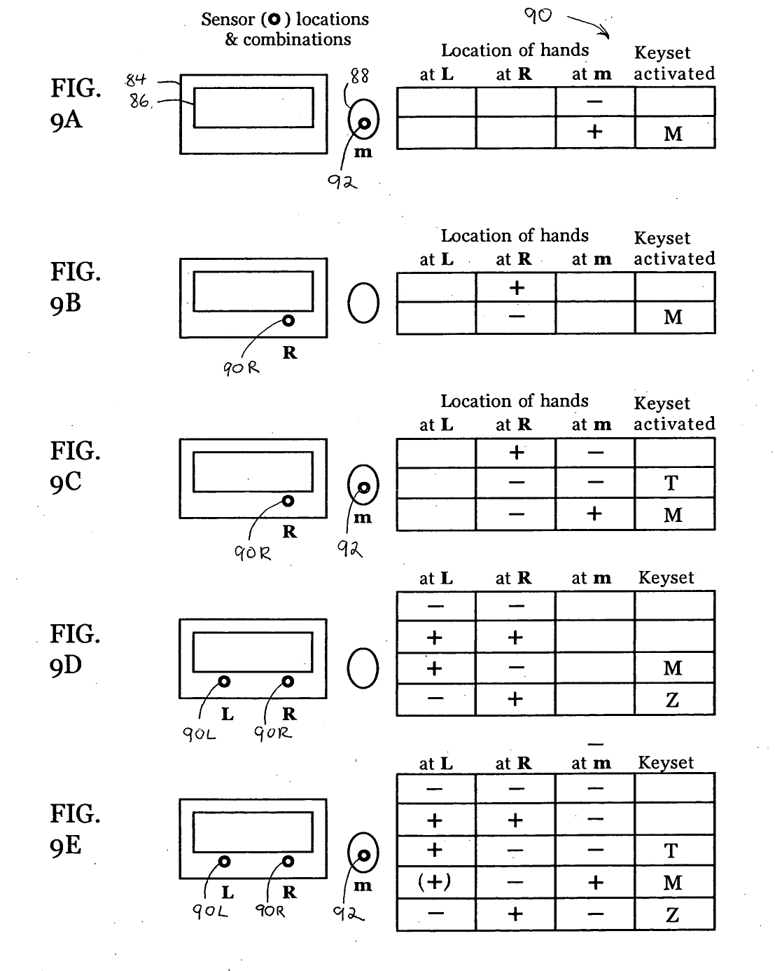

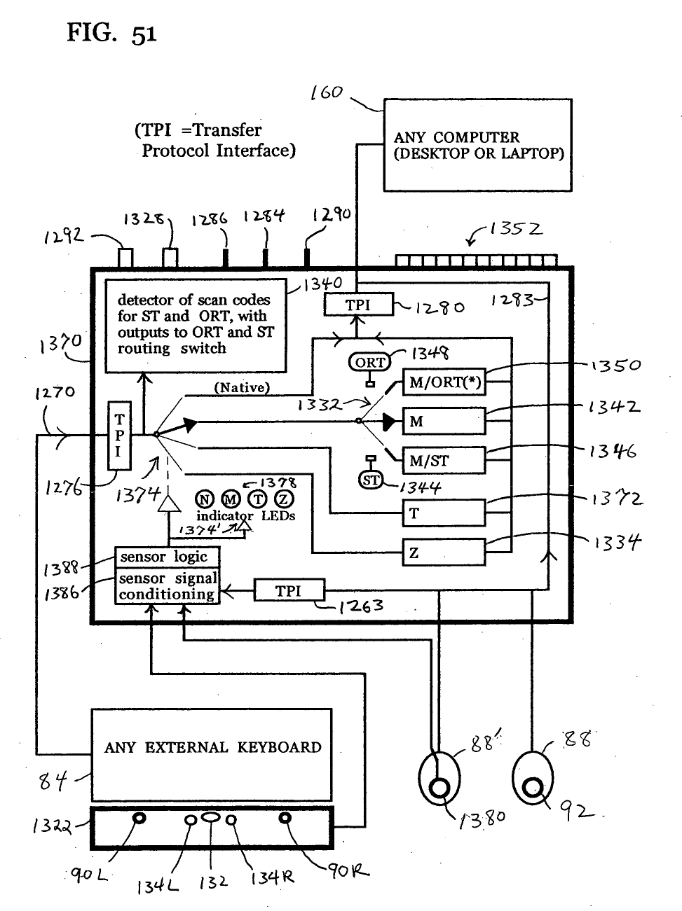

FIGS. 8A and B are top view and front edge view respectively of a portable sensor bearing device 180 that can removably attach sensors 90L and 90R to most standard external keyboards 84 or to a laptop keyboard. Device 180 consists of two sensor carrying short thin strips 182L and 182 R connected together by elastic strap 184 which has two or more sensor-signal-carrying flexible conductors 186 woven into or wrapped around elastic strap 184 in such a manner that they are longitudinally extendable without impeding the stretching of the elastic strap. Conductors 186 carry signal from sensor 90L to strip 182R, where it is joined by conductors from sensor 90R into thin multiconductor cable 187 terminating in plug 188 carrying sensor signals to junction box 150, which could alternatively be a box under a wrist-rest, and is connected to computer 160. The junction box contains sensor conditioning circuitry, and either transformation electronics such as in the embodiment described in FIG. 51 or carries only sensor signal encoding electronics which sends sensor status signals to transforming software installed on the computer. Attached to the left edge of strip 182L and right edge of strip 182R are flexible non-elastic straps 186L and 186R which wrap under the keyboard and are adjustably joined together under the keyboard by a fastener system 189 such as “Velcro” (for clarity FIG. 8B is drawn with a nonexistent space between the sides and bottom of the keyboard and the non-elastic straps). The elastic strap 184 on top allows adjustment of the distance between the sensors (thus optimizing their placement) through adjustment of the tension on strap 184 by the setting of fastener 189 under the keyboard. Preferably the underside of short thin strips 182L and R are non-slip surfaces, such as could be provided for example by a thermoplastic elastomer with a “sticky” feel. Device 180 is similar in function to strips 166 and 172 of FIGS. 6 and 7 (except for not having the extra thumb keys, which could be added), but has the extra advantage of an adjustable distance between the sensors to match each keyboard and each user's keyboard typing position, flexibility to conform to contoured keyboards, and the ability to roll up into a tiny package for portability. The sensor bearing device 180 could be on the order of ¼″ wide so that it could fit between the keyswitches and the built-in pointing device of laptop computers.

The determination as to whether the keyboard hand position sensors should be mounted on the keyboard (as in FIGS. 1, 6, 7 and 8) or mounted in front of the keyboard (as in FIGS. 2, 3, 4 and 5) depends on the type of sensor, what it is sensing, and the distance from the center of the home keys (as a reference line) to the front of the keyboard. For example, if ambient light blockage sensing of the hand directly is being used, the preferred distance for the sensors forward of the center of the home keys is two and one-half to three inches. If the keyboard extends for three inches or more in front of this reference line, there is room for the sensors on the keyboard itself. If the keyboard extends for less than two and one-half inches, the sensors must be mounted in front of the keyboard. Note that when using discrete sensors, in order to determine that a hand is absent from its keyboard typing position or is present at the pointing device, it is not necessary to sense the hand itself directly, since sensing of the position of the wrist or forearm could also serve this purpose. Thus anywhere in this patent application that the phrase “keyboard hand position sensor” or the like is employed, it should be taken to signify any means, direct or indirect, that is able to determine if the hand is absent from its typing position or is present at the pointing device.

FIG. 9A-E illustrates sensor locations and combinations, and contain logic/truth tables 90 showing the possible combinations of hand location and the keysets they activate. The keyboards 84 are a standard keyboard for typing with two hands. The sensors can be any type of discrete sensor, or combinations of types. The table of FIG. 9E is identical to the truth table of FIG. 1C, and the other rows illustrate five additional sensor configurations together with the rules by which transformed keysets are selected by each as a function of hand position/location. The plus sign means hand is sensed to be present (in typing position, or at or near to mouse), and the minus sign means hand is sensed to be absent. “L” is sensor 90L, “R” is sensor 90R, and “m” is mouse/pointing device sensor 92. FIG. 9A shows a single sensor m at mouse, and that when the hand is absent from the mouse, no transformation occurs, i.e. no transformed keyset is activated the keyboard remains in its “Native” or “N” state; transformed keyset M is activated only when the m sensor indicates that the hand is present at the mouse. FIG. 9B shows only a right-hand sensor at the keyboard, and that when it indicates that the hand is absent, keyset M is activated. FIG. 9C shows a combination of the sensors of 9A and 9B, and that when both sensors indicate absence, keyset T is activated; when m indicates presence, keyset M is activated. FIG. 9D shows L and R keyboard sensors, and that when both indicate the same, either both absent or both present, no transformation occurs (although when both are absent, it does not really matter whether or not transformation happens). When L sensor indicates presence and R indicates absence, keyset M is activated, and when L indicates absence and R presence, keyset Z is activated. FIG. 9E, with all three sensors, transforms to keyset T when hand presence is detected only by L, transforms to keyset M whenever a hand is detected at m, and to Z when a hand is detected only at R. FIG. 9A could also be a single-handed keyboard or keypad being used only by the left hand, with the right hand being used for the mouse.

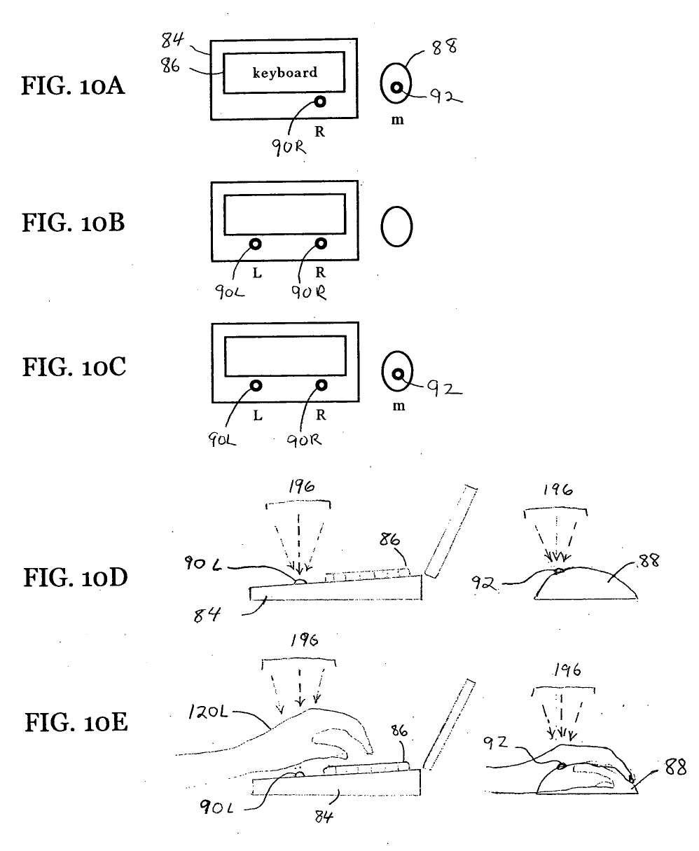

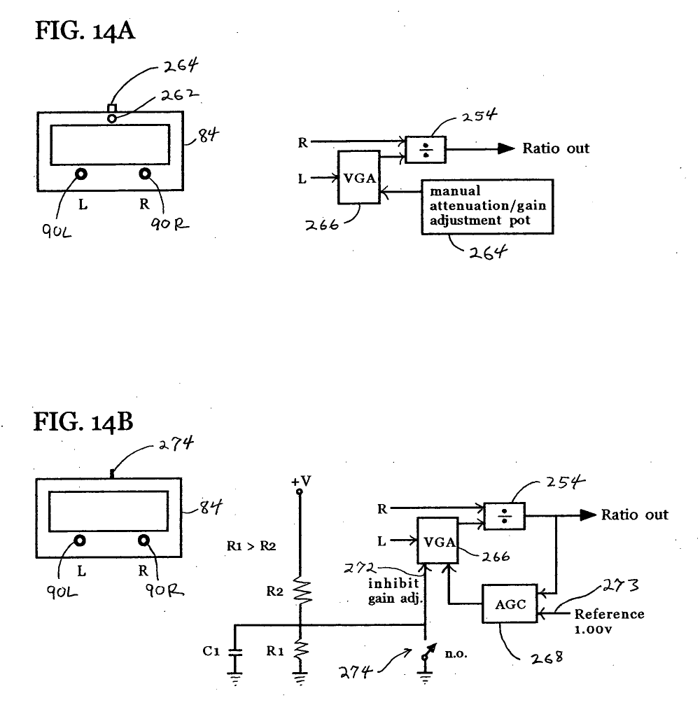

FIGS. 10A through 10E illustrate preferred embodiments of hand position sensors consisting of balanced groups of ambient light sensors. The external keyboard embodiments shown in top view in FIG. 10A and FIG. 10B (which relate to the logic of FIGS. 9C and 9D respectively) each consist of a pair of photosensors that are balanced against each other: in FIG. 10A, 90R and 92 (“m”), and in FIG. 10B, 90L and 90R. The embodiment of FIG. 10C relates to FIG. 9E and consists of three photosensors balanced against each other: 90L, 90R, and 92. The photosensors can be any type of photodetector, such as phototransistor or photodiode. FIG. 10D is a side view which illustrates unblocked rays of ambient light 196 impinging on photosensor 90L built into the keyboard 84, and also impinging on photosensor 92 built into pointing device 88. FIG. 10E is a side view showing a hand blocking much of the ambient light 196 from reaching keyboard sensor 90L, and a hand blocking much of the ambient light 196 from reaching pointing device sensor 92. In FIGS. 10A, B and C each photodetector serves two purposes: 1) as a reference of ambient light intensity for the other detector(s), i.e., they serve as reference for each other, and 2) as a sensor of light reduction when blocked by a hand. Initially, with all sensors unblocked and receiving ambient light (as shown in FIG. 10D ) their outputs are adjusted either manually or automatically (to be detailed in FIGS. 14A and 14B) to be approximately equal, or balanced. This balance then remains relatively independent of overall changes in ambient light. When one sensor is covered by a hand (as in FIG. 10E) and another remains uncovered, the outputs of the two sensors will generally differ by at least a factor of two, again relatively independent of changes in ambient light (as long as any changes since balancing occur equally at both locations, which is generally the case). FIG. 10A corresponds to the sensor configuration and truth table of FIG. 9C, 10B corresponds to 9D, and 10C corresponds to 9E. One of the best ways to implement the truth table for each sensor embodiment is by ratioing the output of the sensors against each other. This provides relative immunity to changes in ambient light, with each photodetector serving the above-mentioned dual purpose, i.e.: 1) as a reference of ambient light intensity for the other detector(s), i.e., they serve as reference for each other, and 2) as a sensor of light reduction when blocked by a hand.

Note that throughout this document the reference numbers 90L and 90R are used to signify left and right hand keyboard sensors. From FIGS. 1 through 9 they represent any type of sensor in those locations, and in FIGS. 10A through 10E and in many of the figures to follow they are particularly described as specifically representing sensors of the type that are ambient light photosensors.

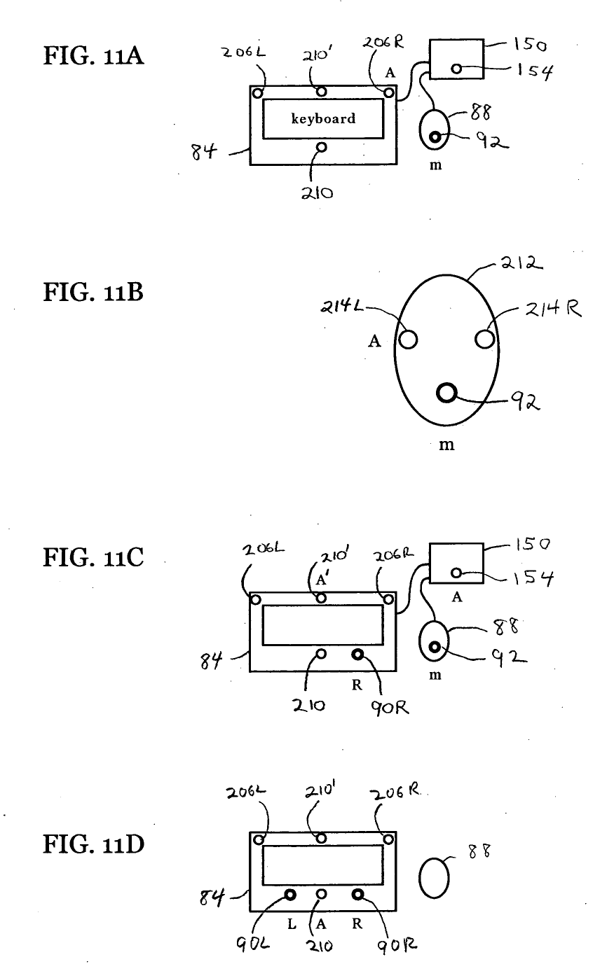

FIGS. 11A through 11D illustrate alternate embodiments of ambient light hand-position photosensors where each photosensor serves only one dedicated purpose, either as a reference (A) for ambient light intensity, or as a sensor (m,R,L) of ambient light blocked by the hand. These embodiments require more sensors than the embodiments of FIG. 10A, B and C. FIG. 11A shows a single m sensor 92, and five different possible reference sensor positions (only one of these, “A”, would be used at a time) one (154) on junction box 150, one (206R) on keyboard 84 for right-side mouse use, one (206L) on the keyboard for left-side mouse, and two (210 and 210′) on the keyboard for ambidextrous use. FIG. 11B shows a mouse 212 with m ambient light sensor 92 (for sensing blockage by the hand) and ambient light reference sensors 214L and 214R. Only one sensor 214 (“A”) would be used at a time, the one which remains uncovered when the hand is at the mouse (which depends on which hand the mouse is used with). FIGS. 11A and 11B correspond to the hand sensor and truth table of FIG. 9A. FIGS. 11C and 11D correspond to 9C and 9D, respectively. In FIG. 11C, reference sensor 154 on junction box 150 serves as ambient light reference for m sensor 92 on pointing device 88, and one (A′) of possible reference sensors 210, 210′, 206R or 206L on keyboard 84 serves as ambient light reference for keyboard hand-position sensor 90R. In FIG. 11D, reference sensor 210 “A” could serve as ambient light reference simultaneously for both keyboard photosensors 90L and 90R, or reference photosensor 206L could be the reference for 90L and 206R for 90R. The sensor configurations of FIG. 11D allow determination that no hands are present at the keyboard, which would activate transition state −K.

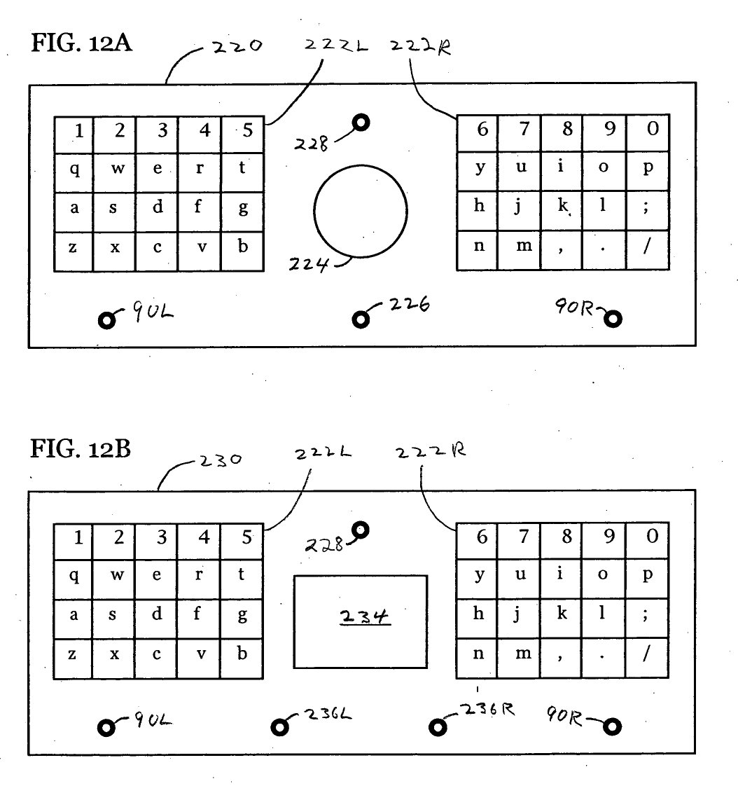

FIG. 12A is an example of a “split and separated” type of keyboard keyswitch layout. This is the most ergonomic type, with keyboard 220, left hand key group 222L, right hand key group 222R, and trackball pointing device 224 in the center. The keyboard typing position hand sensors are 90L and 90R. This figure is presented here to illustrate the use of hand position sensors at a pointing device mounted on a keyboard. In this example pointing device hand sensor 226 is an ambient light photosensor, and sensor 228 is its ambient light reference sensor (analogous to FIG. 11A, 92 and 206R). Reference sensor 228 is optional since 90L and 90R could serve as reference for 226 as well as for each other, as in the method illustrated in FIG. 10C).

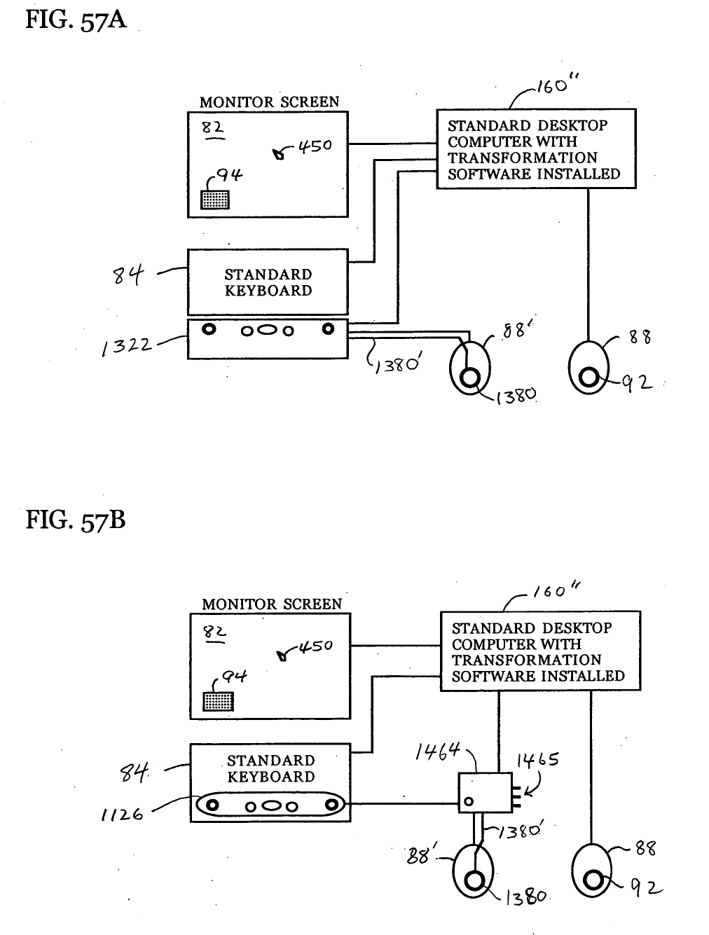

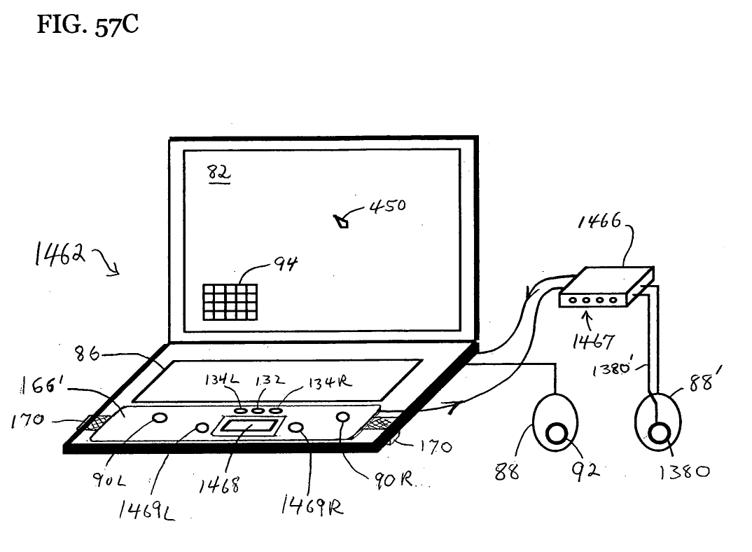

FIG. 12B depicts a keyboard 230 similar to 220 of FIG. 12A except that the central pointing device 234 is of the type (such as a track pad) best served by an off-center hand position sensor 236L or 236R. Only one of these would be active at a time, for example for users employing their right hand for pointing, 236R would be used. In either case, sensor 228 could serve as the ambient light reference sensor. A similar sensor arrangement could be used for traditional, non-split keyboards with built-in pointing devices such as in FIG. 57C, 59 and 60. Alternatively, reference sensor 228 could be eliminated, and a system such as is illustrated in FIG. 10C could be used.

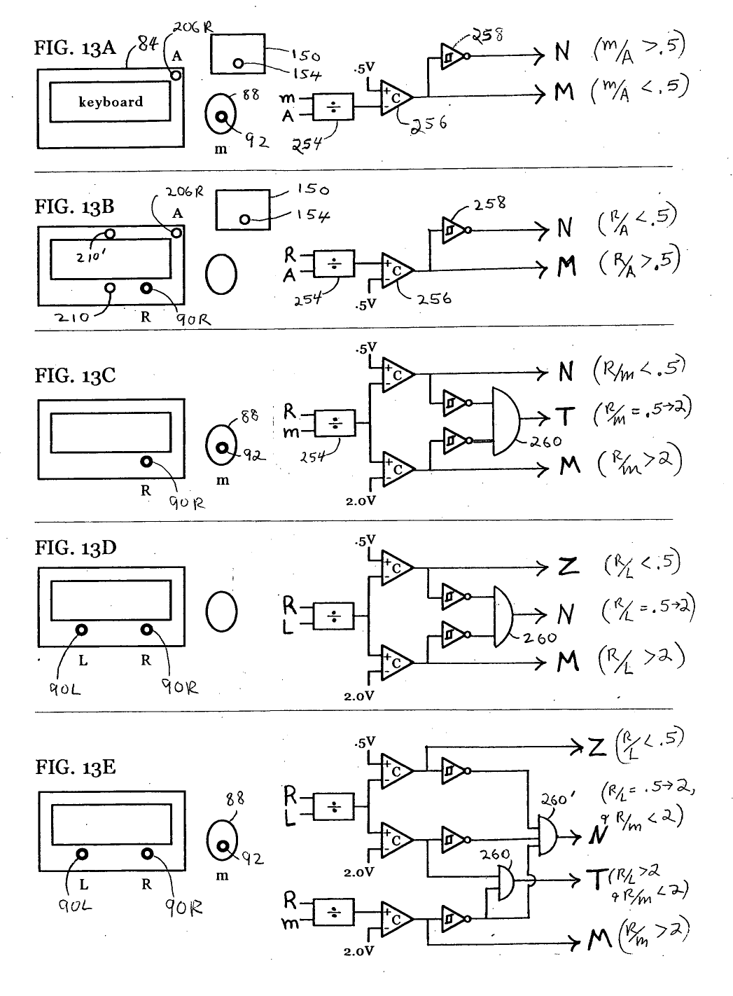

FIGS. 13A through 13E are schematic circuit examples for implementing keyset selector logic tables of FIG. 1C and FIGS. 9, using ambient light photosensor arrangements from FIGS. 10 and 11. FIG. 13A corresponds to FIGS. 11A and 11B, 13B to 11C (except without mouse sensor), 13C to 10A, 13D to 10B, and 13E to 10C. FIGS. 13A through 13E show a ratioing divider 254, comparators 256, Schmidt inverters 258 and “and” gates 260. In FIGS. 13A through 13E, “m”, “A”, “R” and “L” represent voltages out of the respective sensors (m from mouse sensor 92, A from reference sensor 154 or 206R or 210 or 210′, R and L from keyboard sensors 90L and 90R) being input into divider module 254, the 0.5V or 2.0V are relatively fixed reference voltage inputs to the comparators 256 which set the triggering thresholds. For stability, the comparators should have some hysteresis (i.e., a differential between the enabling threshold voltage and the disabling threshold voltage). “N” (No transformation, native keyboard), “M”, “T” and “Z” are the resultant transformation states activated by these circuits in response to the voltages from the sensors. The numbers on the far right in parentheses (260) are examples of actual threshold ratios used by each circuit to determine keyset selected. The divider module 254 operation and the comparator 256 and logic functions can be carried out by any means, including a discrete chip or chips, or a microprocessor.

FIGS. 14A and 14B illustrate two possible schemes for initial balancing of the photosensors, both shown for the case of a keyboard 84 carrying hand position sensors 90L and 90R as in FIG. 13D. This balancing compensates for different light sensitivities/gains of the two photosensors, and for different intensities of ambient light falling on each sensor in the absence of hands. FIG. 14A provides a manual method, with its keyboard 84 carrying an indicator Led 262 to assist in the manual balancing, and manual potentiometer 264. The schematic of FIG. 14A illustrates a portion of the schematic of FIG. 13D, the divider 254 and its inputs, but with the addition of a VGA (Variable Gain Amplifier) 266 and its gain/attenuation adjustment potentiometer 264 interposed between a sensor's output L and its input into divider 254. Manual potentiometer 264 would be used to initially balance the sensor signals by adjusting the output of the divider to a ratio of 1.0 (volt) while no hands are covering the sensors. This balancing would usually have to be done only once for any keyboard location unless there is a very unusual ambient lighting situation with large differential changes in high contrast shadows.

FIG. 14B illustrates an automatic version of FIG. 14A for balancing two sensors, employing an automatic gain control (AGC) loop consisting of a feedback of the ratio output from the divider via AGC module 268, with the VGA including an “inhibit gain adjustment” input 272 (in this example, logic high into 272 inhibits gain adjustment). Setting the AGC reference input 274 to 1.0 volt provides that when gain adjustment is enabled by pulling input 272 to ground (see 1 and 2 below), the gain becomes automatically adjusted so that the output of the divider also becomes 1.0 volt. This circuit provides automatic sensor balancing: 1) completely automatically upon power-up, when R1 momentarily holds inhibit gain input 272 low, and 2) upon command by momentarily closing normally open manual switch 274, which pulls 272 low.

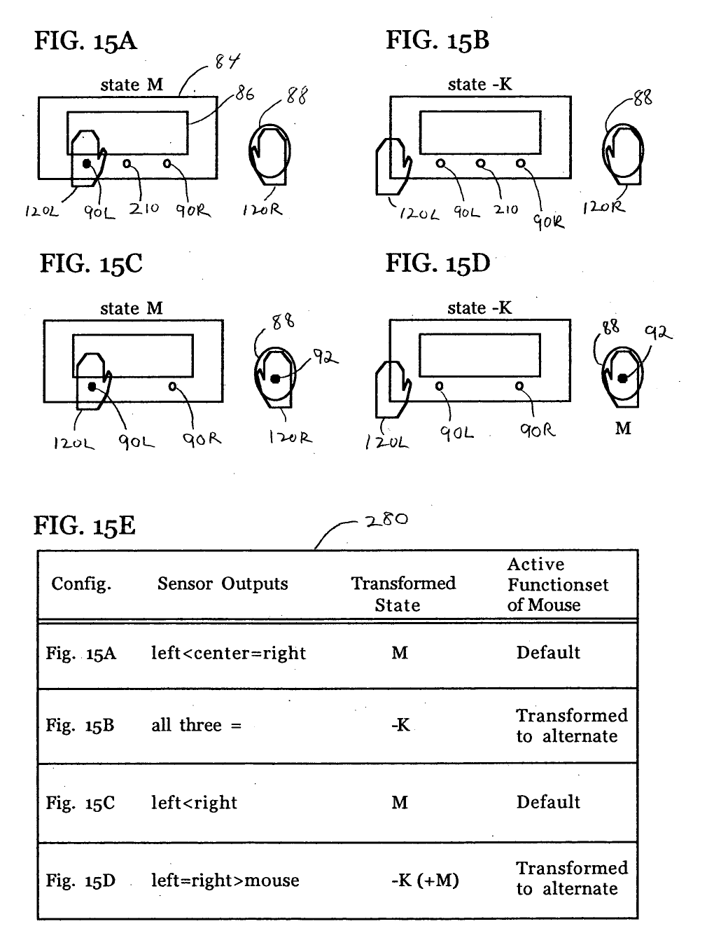

FIGS. 15 through 17 below demonstrate the use of an additional transformation state: no hands detected at keyboard, −K. They will show two possible configurations of photosensors for detecting −K. A sensor drawn as an open circle indicates that it is sensing hand absence, and as a dark dot indicates that it is sensing the presence of a hand.

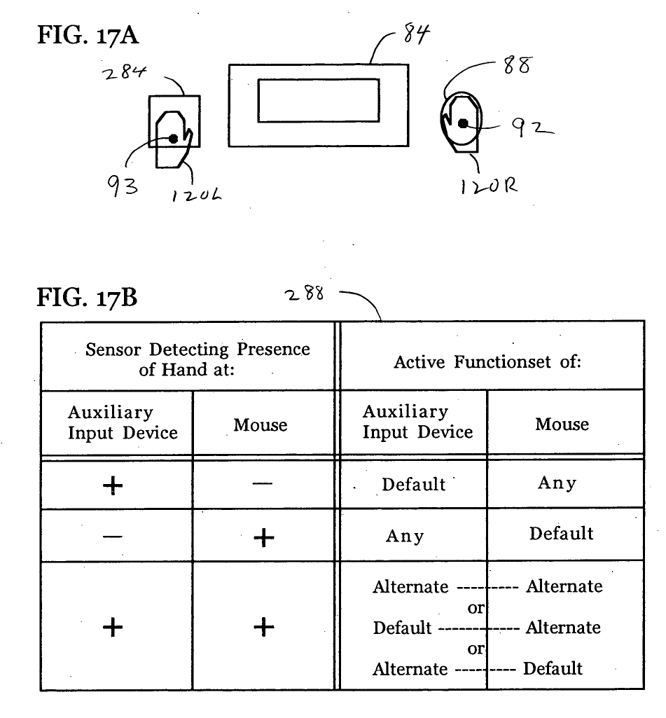

FIGS. 15 and 17 show the use of the -K transformation state to transform pointing device functions. Hand location responsive transformation of the default functions of mouse buttons, click switches, scroll wheel and/or of the output of the x and y motion encoders can be used to temporarily substitute an alternate function or set of functions (pre-chosen in preferences setup). FIGS. 15A and 15C illustrate transformed state M. An alternate set of functions for the mouse 88 can be linked to transformation state -K (no hand at keyboard) so that, when the mouse hand 120R is absent from the keyboard 84 (is present at the mouse), if the non-mouse hand 120L is also sensed to be absent from the keyboard as in FIG. 15B and 15D, (it could be lifted away from the keyboard or just rotated slightly away from its typing position thereby actuating transformation state −K) the alternate set of functions automatically replace the default functions of the mouse buttons, scroll wheel on the mouse and/or mouse x or y encoders. For example the left and right mouse buttons, formerly clicks, could convert to arrow key functions, either for general use or linked to a specific operation. Alternatively or simultaneously, hand location responsive transformation could be linked to change the function of any scrolling device (whether the scrolling encoder is on the pointing device, is part of another device, or is a stand alone scrolling device), for example causing it to convert from its default vertical scrolling function to horizontal scrolling, or from smooth scrolling to incremental. (If the scrolling device is not on the pointing device, it could either substitute for/replace the mouse 88 in FIGS. 15, or could be on the other side of the keyboard from the mouse, and operated by the non-mouse hand, with its function(s) still being transformed during transformation state −K.) The output of the y mouse motion encoder could be used to scroll with the mouse. Additionally, hand location responsive transformation may be used to link either any default or new mouse or scroll function to automatically select objects. These conversions would be momentary, that is, active only for as long as the hand location detector is sensing that the hand is absent from its typing position. Thus to access the alternative mouse functions while using the mouse, one only has to displace or rotate the non-mouse hand slightly away from its keyboard typing position.

Two different combinations of detector outputs that can result in detecting the absence of both hands from the keyboard and can activate transformation state −K are summarized by table 280 of FIG. 15E as follows:

1) In FIG. 15A and 15B, with left and right and reference sensor 210 on the keyboard (sensor at mouse is optional for this configuration), if the sensor outputs are for example, proportional to ambient light intensity, the signal output of all three sensors would be approximately equal, activating state −K; or

2) In FIG. 15C and 15D, with a sensor at mouse registering hand presence, if left and right sensors at the keyboard have approximately equal outputs, state −K would be activated. (Here the sensor at the mouse serves as a “reference” for the keyboard sensors to distinguish between both hands at keyboard and no hands at keyboard.)

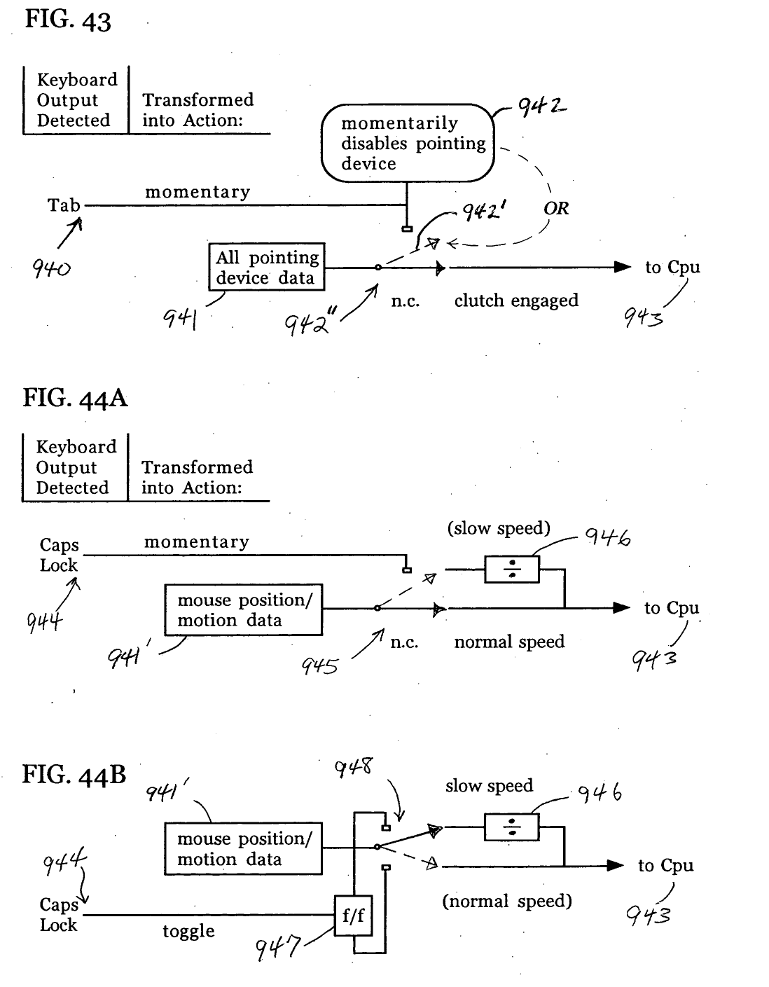

Optionally a small on-screen icon or alert of any kind can be used to indicate the transformation, or a small palette, chart or list can appear on the screen to display the new functions (or it can be on the screen all of the time, displaying all of the options at once, both the default and the transformed by state −K, with the active functions highlighted). This use of the present invention effectively doubles the number of functions of the mouse buttons and scrolling device. Additional possible alternative functions are as follows. For x and y motion: very slow, very fast, absolute tracking (as opposed to the usual acceleration sensitive tracking) completely disengaged (in order to reposition mouse without lifting it), x motion causing zooming of document, x motion linked to rotate a selected object, y motion linked to move cursor along z axis; for clicks: left click and right click could be reassigned to other clicks or to any macros or to causing scrolling of document with mouse motion (i.e., to activate the “grabber hand”); for scroll wheel: slower or faster vertical scrolling of document, vertical or horizontal scrolling of a selected object or of the window, Z axis scrolling, or rotation of a selected object or around any selected axis. Refer to FIGS. 43, 44A and 44B and their discussion for examples of implementation of transformation of mouse functions.

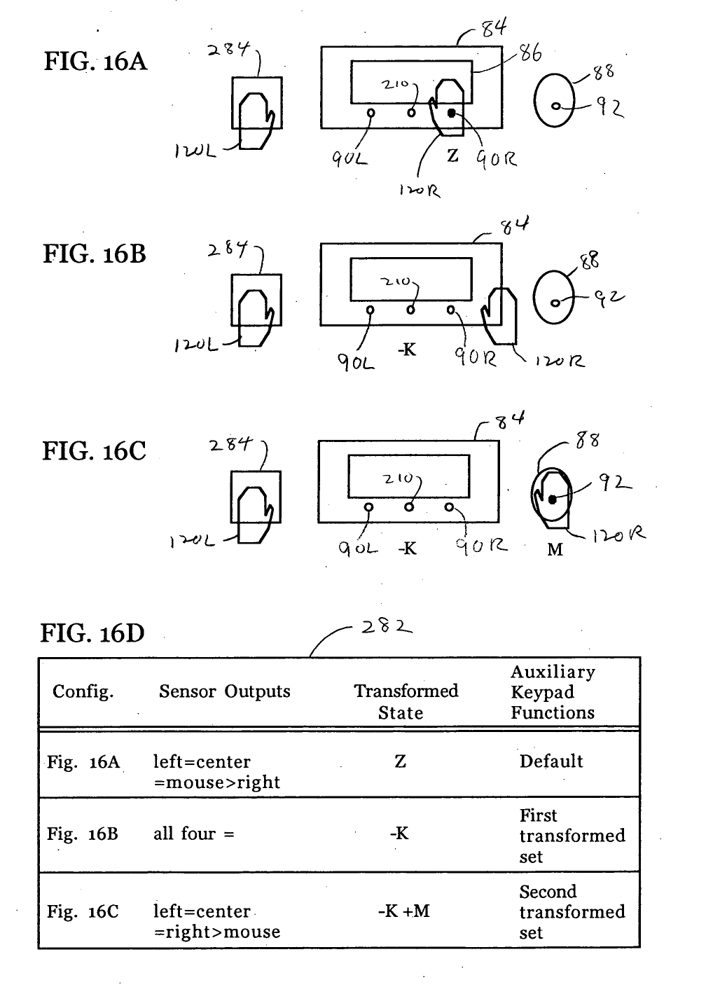

FIGS. 16A through 16D illustrate the use of hand position responsive transformation to transform the functions of an auxiliary keypad from its default set to two different alternative sets by using the transformation states −K and M. FIG. 16D is a logic table 282 that demonstrates the relationship of the transformation states of FIGS. 16A through 16C, and the function sets that result. The left hand 120L is shown at the auxiliary keypad 284. FIGS. 16A and 16D show that the Z state, with only the right hand 120R at the keyboard 84, provides the default set. FIGS. 16B and 16D illustrate the −K state (no hand at keyboard) providing a first transformed set, and FIGS. 16C and 16D show that the −K state, in combination with a hand 120R at the pointing device 88 having a sensor 92 (M state) can provide a second transformed set. Alternatively, a hand at the mouse as in FIG. 16C could be used to provide the default keypad set, etc. Auxiliary keypads are well-suited for use with the method of the present invention because they are rectilinear, and thus could yield three sets times at least 26 keys per set, or a minimum of 78 functions total. Hand location responsive transformation could either be used to transform only the auxiliary keypad, or also keyboard functions at the same time.

Many other uses of hand location responsive transformation of functions are possible, including the example illustrated by FIGS. 17A and B. This is one possible combination of the methods outlined in FIGS. 15 and 16, where when one hand 120L is on an auxiliary keypad 284 with auxiliary keypad hand-sensor 93 registering hand presence, and the other hand 120R is at the pointing device 88 with pointing device sensor 92 registering hand presence, the function set of either device or of both become transformed (see table 288, FIG. 17B.

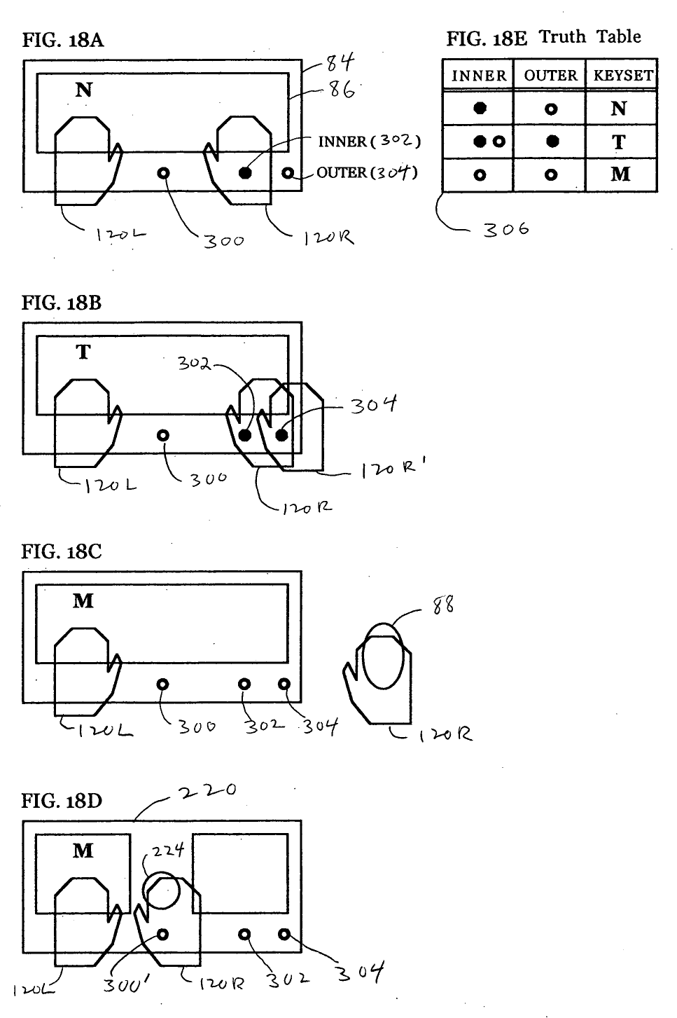

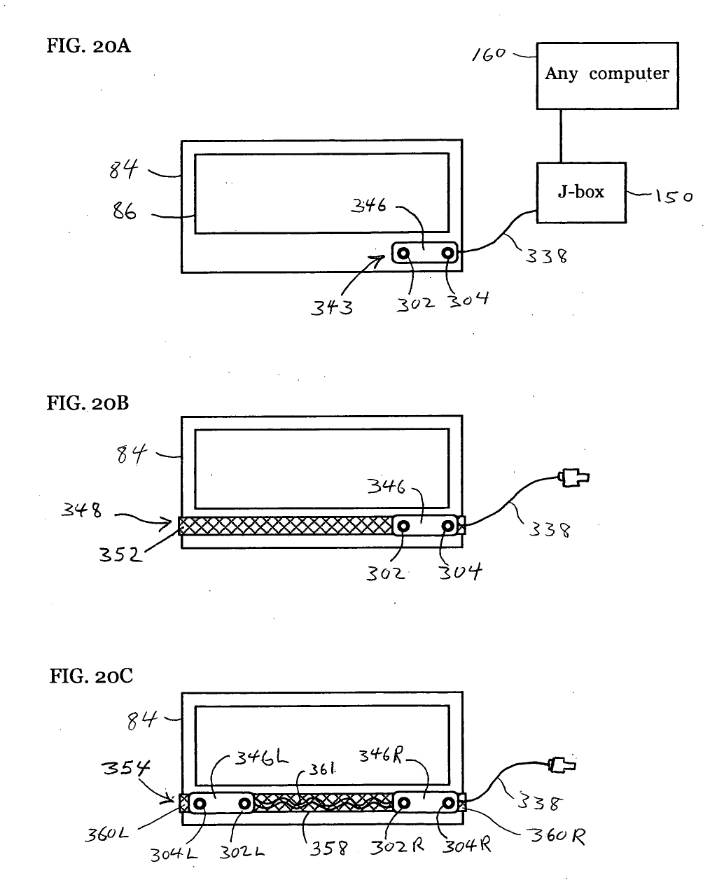

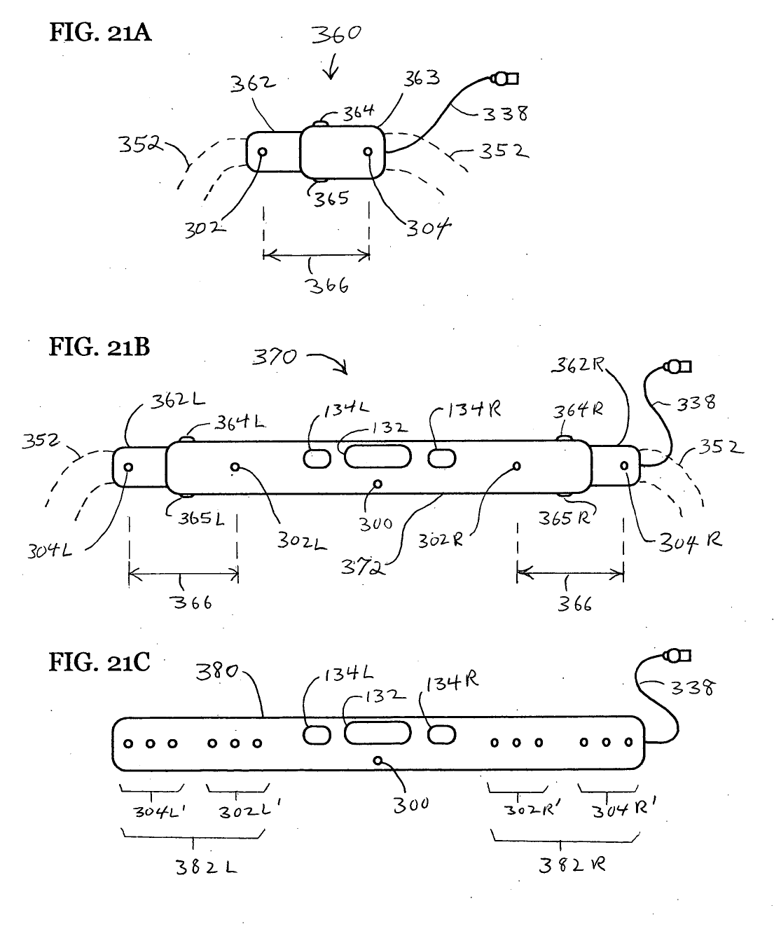

FIGS. 18A through E introduce the use of a pair of sensors under the non-mouse hand's typing position at the keyboard. The sensors of the pair can be set up to act as references for each other as described in FIG. 10. (Obtaining a reliable T keyset using ambient light sensing will require the use of central reference sensor 300.) Inner sensor 302 and outer sensor 304 could either be mounted directly in/on the keyboard, or retrofitted to a keyboard as will be shown in FIGS. 20 and 21. Transparent hand outlines 120L and 120R represent the left and right hands, respectively. The sensors are shown either as hollow circles (not detecting a hand), or as solid dots (indicating detection of a hand). FIG. 18A shows both hands present at normal typing position at the keyboard, with only the inner sensor 302 detecting a hand, resulting, according to the Truth Table 306 of FIG. 18E, in state N (no transformation). (The Truth Table does not include the central reference sensor 300). In FIG. 18B the right hand has moved about an inch to the right, away from typing position, and now actuates the outer 304 (or both) sensors, resulting in transformation to T keyset. In FIG. 18C the right hand has left the keyboard completely (and is shown at mouse 88), leaving both sensors registering absence and activating keyset M. FIG. 18D shows the sensor pair on an ergonomic split and separated type of keyboard as in FIG. 12A (220) with a central trackball 224, the right hand in the center of the keyboard at the trackball, and keyset M active. The beauty of this sensor pair method is that it provides the M keyset and the T keyset without the need for a hand position sensor at the pointing device, whereas in the method with separated individual 90L and 90R hand position sensors as in FIGS. 1A and C, FIG. 2, and FIG. 9, in order to provide a T keyset, the pointing device must have its own hand presence sensor).

Referring to FIG. 18, if one needs only to use keysets N and M: when the outer sensor registers hand absence the result is N, and when the outer and inner sensors register the same the result is M; no additional sensor is needed. But when using the ambient light type of sensors and it is desired to make use of the T keyset of FIG. 18B, in order to distinguish between T and M in changing light conditions one needs to add central ambient light reference sensor 300. Then when outer is greater than inner, the result is N, when outer is equal to (i.e., right hand as 120R in FIG. 18B) or less than (i.e., right hand as 120R′) inner and less than the reference, the result is T, and when inner, outer and reference are all approximately equal to each other (or in the case of 18D the inner and outer are approximately equal and are greater than the reference), the result is M. The result is M transformation state irrespective of whether or not the right hand is actually at the mouse (provided the mouse itself has no hand presence sensor). These rules, laid out in the Truth Table 306 of FIG. 18E, would be implemented by solid state logic means (either discrete or via a solid state array or microprocessor) set up to be analogous to FIG. 1D.

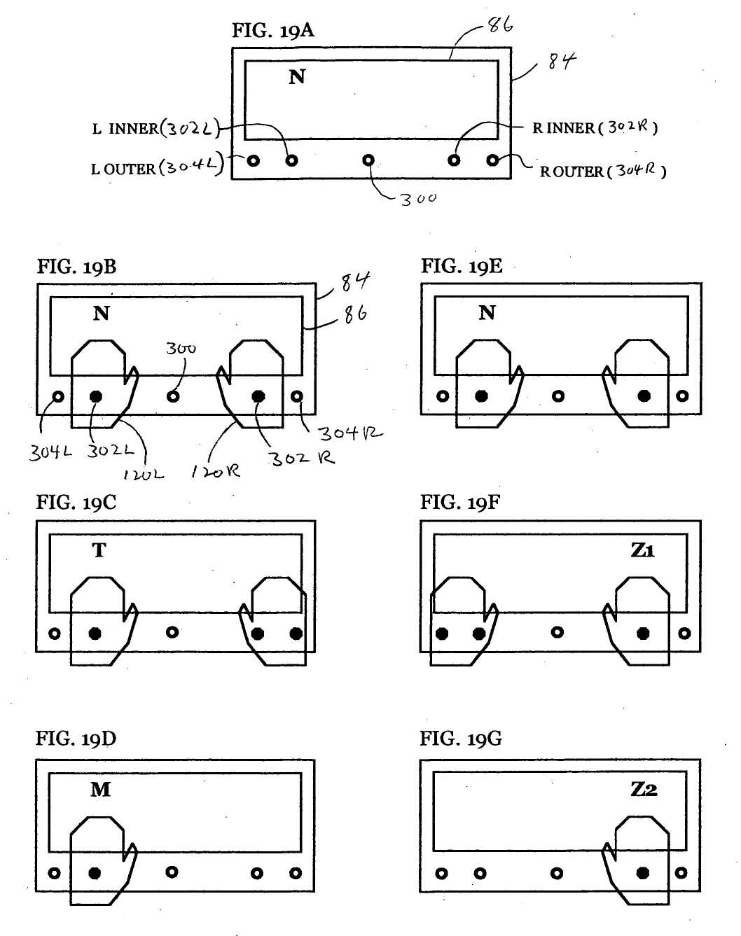

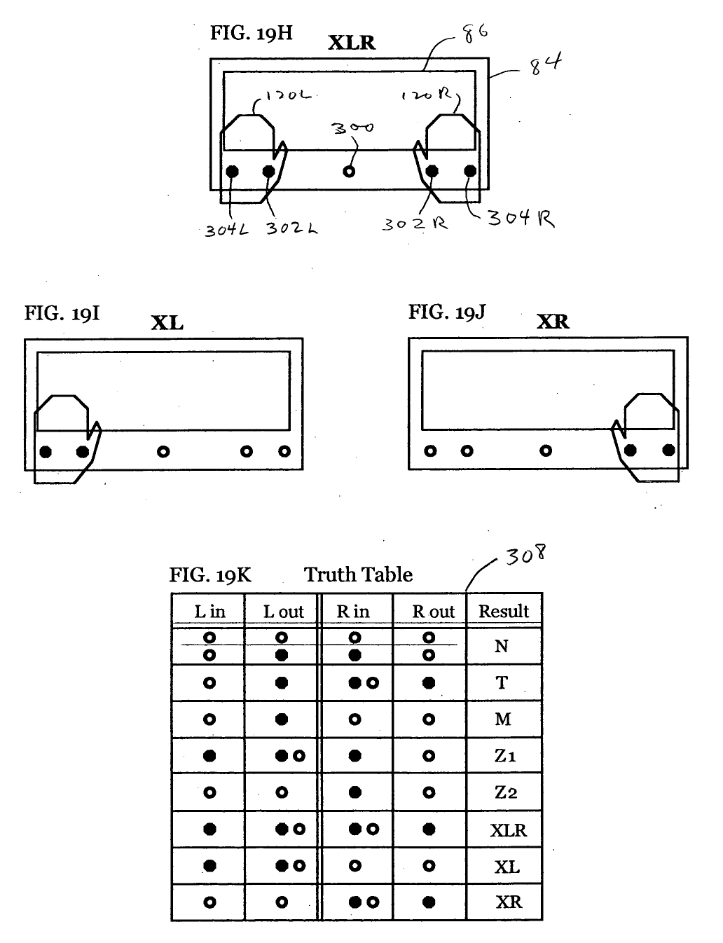

FIGS. 19A through K introduce the use of dual sensor pairs, i.e., left and right sensor pairs. These are an ambidextrous version of the single sensor pair of FIGS. 18. In these figures the inner sensors are 302L and R, and the outer sensors 304L and R. When a hand is in typing position, it covers only the inner sensor. When sensing ambient light the central reference sensor 300 is desirable in most cases. The sensors could be mounted directly into the keyboard, or mounted on sensor carrying strips (such as in FIG. 20C and FIGS. 21B and 21C). FIG. 19A shows both hands absent from keyboard 184, and FIG. 19B (and E, which is identical to B) has both the left hand 120L and right hand 120R in typing position, covering only the inner sensors 302L and 302R; both FIGS. 19A and 19B resulting in native keyboard, no transformation (refer to the Truth Table 308 of FIG. 19K). In FIG. 19C the right hand 120R is shown having moved about an inch to the right, now covering the outer or both sensors of the right side pair, resulting in transformed keyset T. In FIG. 19D the right hand has departed completely from the typing position area of the keyboard, exposing both 302R and 304R, which results in transformation into keyset M. FIGS. 19E, F and G show a similar sequence for the left (here the non-mouse) hand 120L departing its typing position in two stages, resulting in transformed keysets Z1 and Z2. The hand positions and sensor states in Z1 are the mirror image of those in T, and the hand positions and sensor states in Z2 are the mirror image of those in M.

There are additional hand positions detectable by dual sensor pairs that do not have either hand in a typing position. These are illustrated in FIGS. 19H, I and J, and could be used for convenient access to individual pre-assigned functions. FIG. 19H shows both hands moved outward about an inch covering all inner and outer sensors, resulting in the activation (see truth table in FIG. 19K) of XLR, i.e. of any function assigned to XLR (eXtra Left Right). FIG. 19I shows the left hand still outward, and the right hand absent, activating XL. FIG. 19J is the mirror image of 19I, and activates XR. These three extra non-contact hand position sensitive switches could be assigned to any frequently used functions, and used as either alternate action latching toggles or as momentary switches. The only extra switch usable while the right hand is at the mouse is XL. This could be used for example to toggle “autogrid on and off”, to “align to grid”, to momentarily change a scroll device from vertical scroll to horizontal, to change mouse speed from normal to slow, to disengage a pointing device clutch, etc. XR and XLR could be used for any other two functions desired, for example, *B, *I, *U, *T, check spelling of selection, etc.

Thus the dual sensor pair method adds the option to provide the two additional transformed keysets Z1 and Z2, plus the three hand-position responsive assignable non-contact switches XL, XR and XLR, and like the single pair, has no need for a sensor at the pointing device. Logic implementation for single or dual sensor pairs is analogous to that shown in FIGS. 1C, 9D, 13D, 14A and 14B for individual left and right sensors, including automatic compensation for fluctuations in ambient light intensity, with the addition of using central reference sensor 300 to distinguish between T and M.

In any of the embodiments of the present invention that are shown as using the individual/single left and right sensors, the single sensor pair or dual sensor pairs could be used instead. The sensors depicted in FIGS. 18 and 19 could be placed in front of (i.e., toward the user from) the keyboard's key switch matrix 86 in any way including being built-in, adhered directly, adhered via a strip, strapped on via a strip or strips, positioned between keyboard and wrist rest, or carried on a wrist rest.

FIG. 20A shows device 343 implementing the single sensor pair concept, with sensors 302 and 304 carried on a thin short strip 346 which is adhered to the surface of keyboard 84 (laptop or external keyboard) and connected to junction box 150 by cable 338. Adhesion could be achieved by any means, including a strip of double-stick tape. The sensors are spaced approximately two to three inches apart on strip 346. FIG. 20B depicts device 348 for removably attaching sensor carrying strip 346, bearing sensors 302 and 304, to keyboard 84 by means of elastic strap 352. One end of the elastic strap is attached to the left edge of strip 346 and the other end of the elastic strap is attached to the right edge of the strip, forming a loop which runs under the keyboard (similar to the loop of elastic belt 170 shown attaching device 166 to keyboard in FIG. 6C). For left hand mouse users, the position of this device can be reversed to place the strip under the left hand typing position, with the cable 338 and its end plug 339 coming off the now left edge.

FIG. 20C shows removable device 354 containing left and right sensor-pair-carrying strips 346L and 346R held to the keyboard 84 by a combination of elastic strap 358 and non-elastic flexible straps 360L and R in a manner identical to that described for device 330 in FIGS. 8A and 8B. Elastic strap 358 has woven into or around it two or more sensor-signal-carrying flexible conductors 361. The inner sensors are 302L and R, and the outer sensors are 304L and R. Additionally, a central short strip could be added to provide a reference sensor 300 and/or extra thumb keys. A similar central strip could be added to the sensor embodiments illustrated in FIGS. 8A and B and FIGS. 20A and B.

FIGS. 21A, B and C illustrate devices carrying pairs of hand position sensors designed to be retrofit to standard external keyboards to to standard laptop keyboards, and to be used with a junction box. They provide an adjustment of distance between the sensors in each pair. On most traditional (not split) keyboards, the ideal locations for the “inner” sensors 302L and 302R (which are the same as the single sensors 90L and 90R of FIGS. 1 through 14) is along a horizontal line that is parallel to and about two and one-half to three inches in front of (below) an imaginary line drawn through the centers of the home keys, with the left inner sensor placed perpendicularly in front of the point between the Caps Lock and “a” keys, and the right inner sensor placed perpendicularly in front of the point between the semicolon and apostrophe, resulting in a distance of seven and one-half inches between the inner sensors. In the case of non-traditional keyboards with split key groups, the angle of and distance between the hands is different. (Where the hands are parallel as in the split and separated Kinesis Contour keyboard, the best positions for the sensors are perpendicularly in line with the point between the “a” and “s” keys on the left, and between the “l” and semicolon on the right.) For proper hand sensing operation for the transformation and switching methods illustrated in FIGS. 18 and 19, each outer sensor needs to be spaced from the inner sensor of its pair by a distance of between two and three inches. The optimum spacing is dependent on hand size and angle, and therefore a range of adjustability is desirable.

FIG. 21A illustrates an adjustable version 360 of the portable (particularly suitable for laptops) “garter belt” sensor retrofit device of FIG. 20B, with loop of elastic strap 352, conductor cable 338 with end plug 339 to attach to junction box 150, and body consisting of two sections, 362 and 363, each carrying a sensor (inner sensor 302, outer sensor 304). One section telescopes inside of the other as shown, with a ratchet or friction lock controlled by side buttons 364 and 365. The telescoping can result in the desired adjustment range 366 for distance between inner 302 and outer 304 sensors of about two to three inches. This device is reversible for right or left side use. Instead of being attached to the keyboard by elastic loop 352, it could be directly adhered to the keyboard via the section bearing the inner sensor, with the outer sensor then being adjustable.

FIG. 21B depicts a stick-on or strap-on adjustable sensor carrying device 370 with body 372 bearing extra thumb keys 134L, 132, 134R, central reference sensor 300, and a fixed seven and one-half inch spacing between inner sensors 302L and 302R, the distance suitable for most traditional keyboards. Telescoping ends 362L and 362R carry the outer sensors 304L and 304R, with adjustment mechanism and range similar to the embodiment pictured in FIG. 21A. The width of the strip could be between three-quarters of an inch and one and one-half inch wide, and about ¼″ thick, especially if tactile membrane switches are used for the thumb switches.

FIG. 21C shows a different approach to adjustability, being a stick-on or strap-on thin strip 380 containing left and right linear arrays 382L and R, each composed of six or more tiny flat surface-mounted phototransistors. A miniature dip switch array in either strip 380 or the junction box 150 can be set to choose which sensor in each group of three will be active, thereby providing optimization of the inner and outer sensor locations for users with different hand sizes. (Alternatively, a single phototransistor on each side can serve as the left and right inner sensors with a fixed distance of seven and one-half inches between them, with three or more outer sensors on each side to choose from). This strip also has central reference sensor 300, and extra thumb keys. In general, extra thumb keys can have dual functions: in addition to serving as ST and ORT during transformation, they can be assigned functions for the native keyboard also, and thus provide 3 or 4 (the 4th by chording right and left) extra functions for the thumb.

The embodiments pictured in FIGS. 21B and C could be used in three different ways: either making use of all four sensors as in FIGS. 19, making use of only one inner/outer pair under the mouse hand side of the keyboard as in FIGS. 18, or using only the two inner sensors as in FIGS. 1 through 14B.

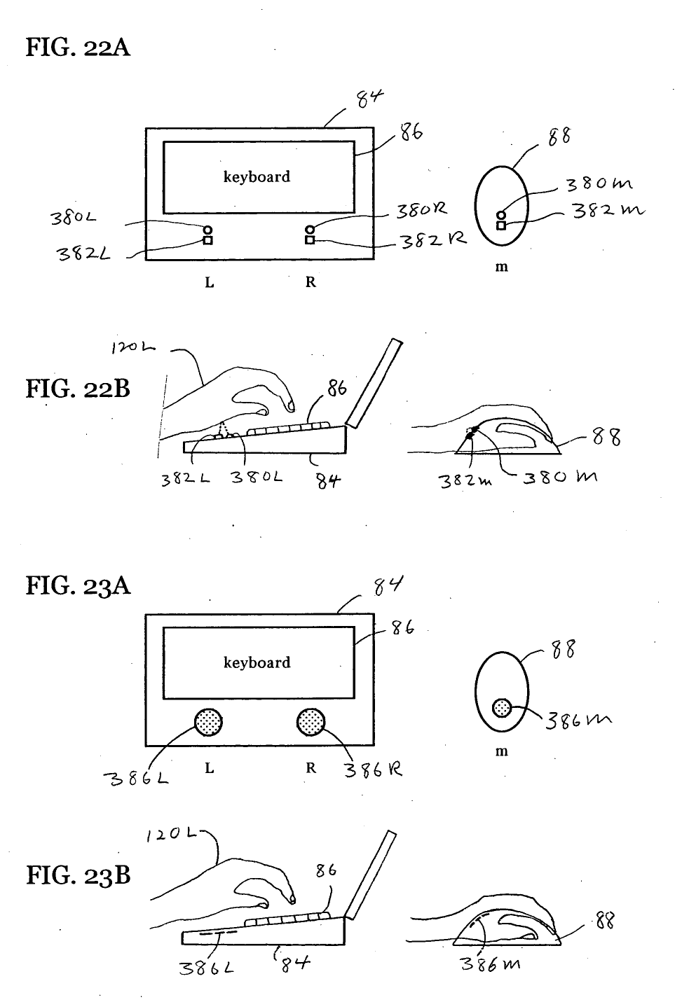

FIG. 22A and 22B illustrate an alternative type of photosensor embodiment, pulsed IR hand-position sensors, with FIG. 22A being a top view, and FIG. 22B a side view, each showing this embodiment mounted on a keyboard 84 and a mouse 88. This sensor embodiment consists of a generally upward facing pulsed light source 380 (preferably IR, from an Led) together with a photosensor 382 mounted fairly closely alongside the source and facing in approximately same direction as the light beam. The electrical output of the photoreceptor would be filtered synchronously in phase lock with the pulsing of the light in order to effectively blind the photoreceptor output to ambient/background light. When the hand is absent (FIG. 22A), the receptor output contains very little signal from the pulsed light; whereas when the hand is located so that some of the pulsed light 384 reflects off it and back to the photoreceptor (FIG. 22B), the photoreceptor output registers the presence of the hand. The sensitivity of this sensor arrangement could easily be adjusted to detect the hand within a range of zero to three inches, which would be the approximate desired range for distinguishing between presence and absence of the hand at mouse or at keyboard typing position. If pulsed light sensors are used under both hands at the keyboard, in order to prevent pulsing light reflected off one hand into the other hand's sensor from having any effect, the L and R sensors could be operated at different frequencies. Inexpensive off-the-shelf IR transceiver or remote control modules could be adapted to build the pulsed IR hand-position sensors of this invention.

FIGS. 23A and 23B illustrate another alternate hand sensor embodiment, capacitive proximity sensor electrodes, with FIG. 23A being a top view, and FIG. 23B a side view, each showing this embodiment mounted on a keyboard 84 and a mouse 88. This sensor embodiment consists of a (thin) conductive electrode 386 mounted on, in, or under the surface of the keyboard, wrist rest, or pointing device and connected to a capacitance measuring circuit or chip (for example, one of the charge transfer type presently marketed by Quantum Electronics, cost under $2.00 each). This proximity sensor could have a range of up to two to three inches if electrodes over 2 inches in diameter are used.

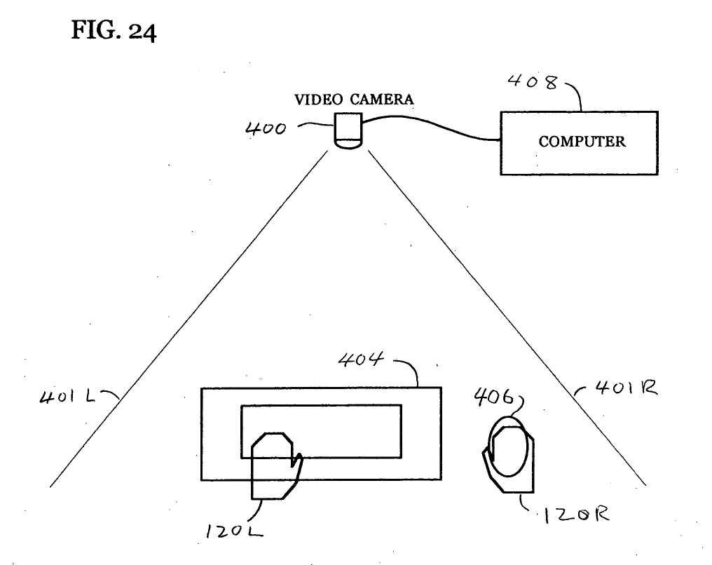

FIG. 24 is an illustration of hand position sensing via optical imaging of hands using a video camera and image processing firmware or software. Video camera 400 has field of view bounded by dotted lines 401L and 401R, within which right and left hands are shown located at the position of either a real, mock or virtual (light projected) keyboard 404, and showing dotted outline of right hand situated at position of a real, mock or virtual pointing device 406 (mock or virtual such as might be used with input devices that generate key codes by detecting finger position via sensors on the hands or via optical imaging with a video camera). Image processing firmware in video camera and/or software in computer 408 to which video camera sends data acts as an optical sensor of absence or presence of hand at pointing device or at keyboard typing position for activating transformation of key codes.

For the purposes of this invention, any direct or indirect means of tracking hand position, sensing hand absence from keyboard or keyboard typing position or presence at pointing device can be used, including for example the determination of location of forearm, wrist, heel of hand, palm of hand, back of hand, or fingers as a group of fingers. Generally, in the method and apparatus of the present invention, sensing (for the purpose of function transformation) of hand presence or absence at keyboard typing position would not be affected/activated by a change in the position of the fingers with respect to each other, but rather by a displacement and/or rotation of the forearm and/or of the whole hand.

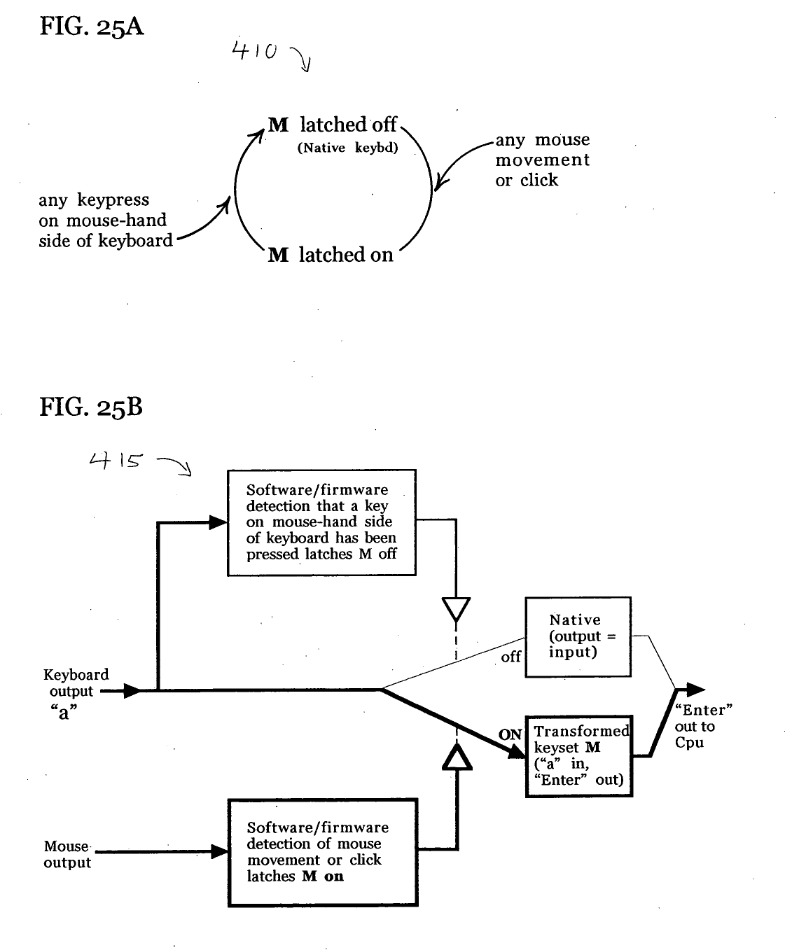

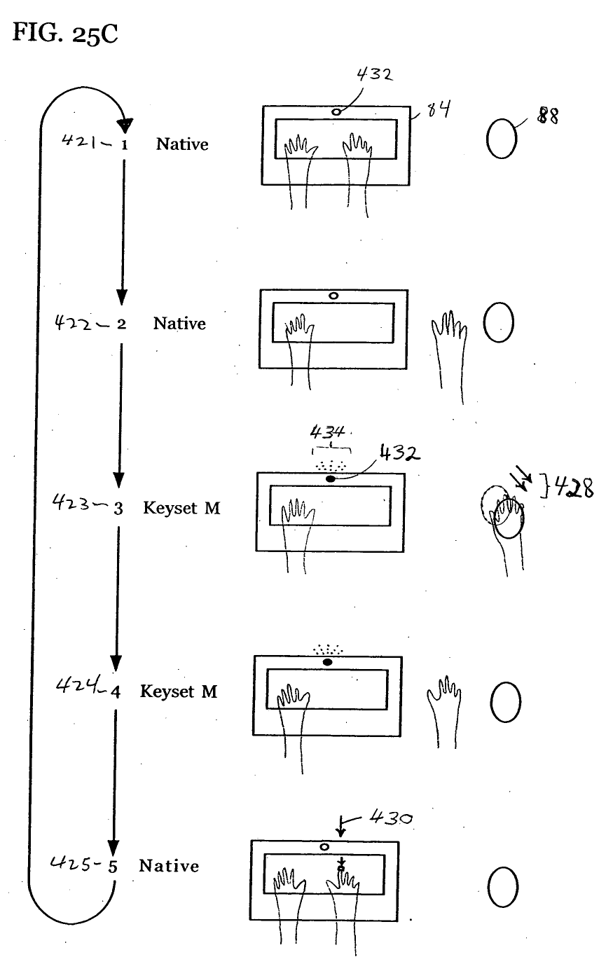

FIGS. 25A, B and C illustrate non-sensor hand location detection, which is a detection of hand location via software and/or firmware monitoring for any data output from mouse and mouse-hand side of keyboard, and the use of this detection to toggle transformed keyset M on and off. FIG. 25A is a diagram illustrating the transformation toggle cycle of keyset M being latched on and off by software or firmware monitoring of: any mouse movement or click, and of any keypress on the mouse-hand side of the keyboard. FIG. 25B is a flow diagram detailing the implementation of this cycle, where a click or a x or y movement output from the mouse (indirectly indicating that the hand is at the mouse) has latched M on via software or firmware detection, and the example is given of the “a” key then being pressed (“a” is on the non-mouse side of the keyboard, and therefore does not cause toggling) and transformed into “Enter”. Any keypress on the mouse hand side of the keyboard (indirectly indicating that the mouse hand is back at the keyboard) detected by the software/firmware would then toggle M off, returning the keyboard to its Native state. Once one is finished at the mouse, if the first native key that one desires to activate happens to be on the non-mouse side of the keyboard, one would first return the mouse hand to the mouse hand side of the keyboard and register its presence by briefly pressing any modifier key (any key that normally has no action on its own), which would automatically return the keyboard to its Native state. FIG. 25C further illustrates this cycle or directional sequence in practice as a sequence of steps 1 through 5 (reference numbers 421 through 425), being a top view showing keyboard 84, mouse or other type of pointing device 88, and the effect of the right hand moving the mouse (step #3, double arrows 428 indicating mouse movement) and then returning to press a key on the mouse side of the keyboard (step #5, arrow 430 indicating keypress). Indicator Led 432 is shown being on (radiating dotted lines 434) during the time that transformed keyset M is active. This type of hand-position sensing depends not only on hand position, but since it is of the latching type, also depends on history, or sequence and direction. In contrast, position detection by discrete sensors is usually not latching but is momentary in nature and therefore can be independent of history.

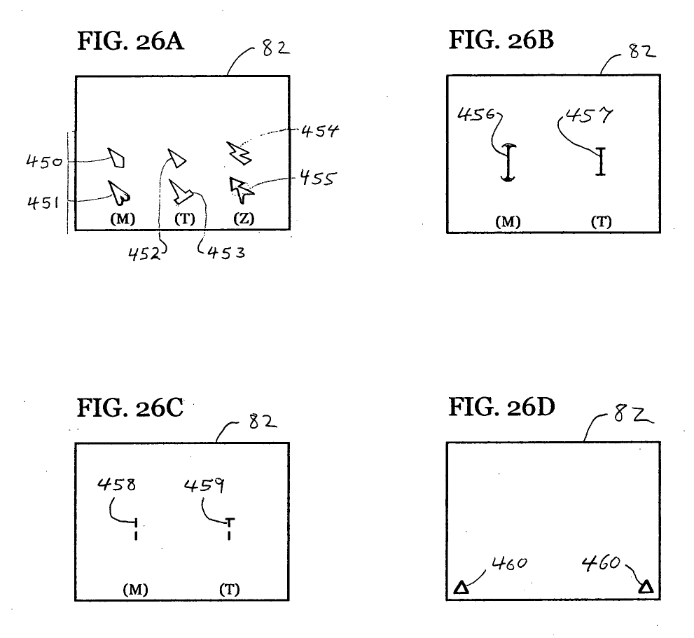

FIGS. 26A through D illustrate optional alternative types of on-screen (non-palette) indicators of transformation. For streamlined implementations of this invention on-screen cursors and palettes are unnecessary, since the user quickly becomes subconsciously conditioned to the non-mouse hand having different functions while the other hand is at the mouse. For fuller implementations, cursors may be useful, and palettes would be necessary. FIGS. 26A, B and C show computer monitor screen 82 displaying some possible examples of modified distinctive cursors, I-beams and insertion point markers which could be programmed to replace their standard versions when transformation to the keysets they represent/indicate, M, T, etc. is in effect. They would serve as an indication and reminder that the keys under the hand remaining at the keyboard are presently transformed to new functions, and could also indicate which transformed keyset (M, T, or Z) is active. For example, in FIG. 26A, alternate arrows 450 or 451 for M, 452 or 453 for T, and 454 or 455 for Z; in FIG. 26B, alternate I-beam 456 for M and 457 for T; in FIG. 26C alternate insertion point markers 458 and 459. Other types of cursors, such as the + or cross-hairs could also have a transformation modified version. FIG. 15D shows triangular indicator icons 460. Any type of indicator or icon could be caused to appear in the menu bar or elsewhere.

In order to enhance the value of the modified cursors of FIGS. 26A, B and C as indicators of transformation, optionally after each transition from native to transformed keyset and back again, instead of the cursor merely changing shape the cursor can be caused to smoothly and rapidly enlarge and then shrink back to normal size. This attract would attention to the transformation, as well as acting as an aid to help visually locate the cursor. Any other means of attracting attention to the change in cursor shape could be used, such as a diffuse transparent colored area around the cursor which expands and then contracts again at transitions, instead of the cursor itself changing size. This colored “aura” could itself be the transformation indicator, surrounding a standard cursor without modifying the cursor itself.

On-Screen Palettes and Their Use

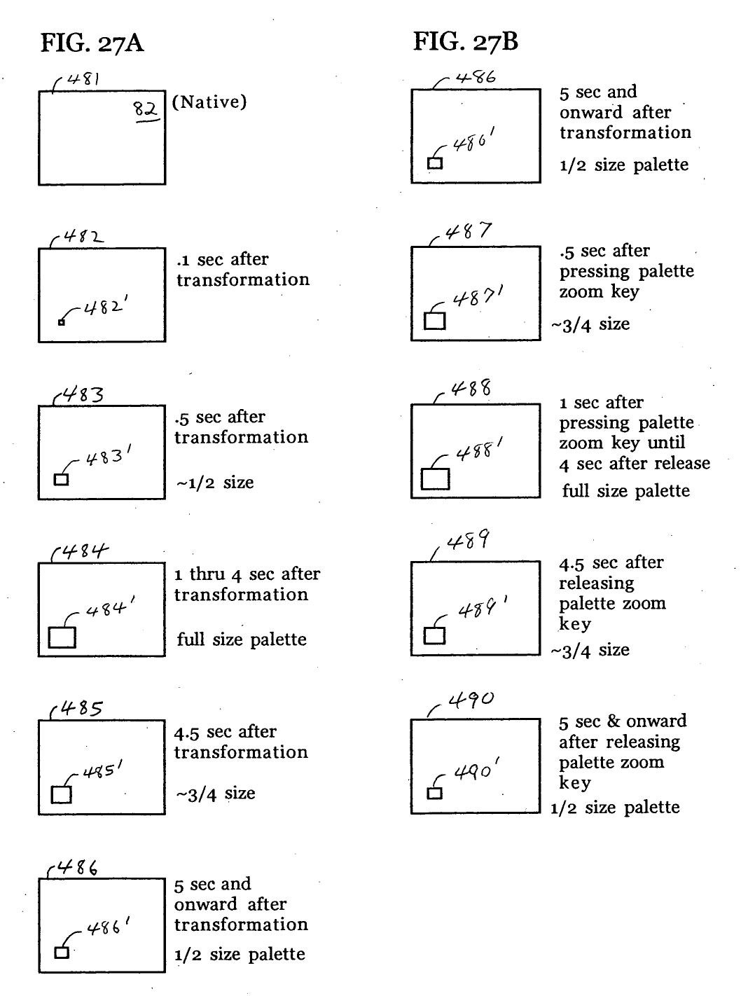

FIGS. 27A and 27B demonstrate the sequence of operation of two different on-screen palette timed zoom features. These features are alternatives to the on-screen palettes suddenly appearing full-size upon transformation, remaining full-size for the duration of the transformation, and vanishing all at once upon return to native keys. The sudden appearance could be uncomfortable for some people, and it may not be desirable for the palette to take up significant screen area for the whole time that transformation is in effect. Reference numbers 481 through 486 represent sequential snapshots in time. 481 shows computer monitor screen 82, with keyboard in native mode. 482 is the same screen about 0.1 second after transformation, with palette rectangle 482′ in the process of smoothly zooming up in size from a point or tiny rectangle 483 shows the palette 483′ at 0.5 seconds after transformation zooming past ½ size, and 484 shows it having reached full size 484′ one second after transformation. If “auto-shrink mode” has been selected during setup, then after about another 3 seconds, palette 484′ begins to smoothly shrink back, past ¾ size 485′ at 4.5 seconds after transformation, to half size 486′ 0.5 seconds later, where it remains for the duration of transformation.

If sometimes during transformation a full-size palette will be temporarily desired, a “palette zoom key” can be designated in preferences at setup. (This key could be, for example, the same key that is functioning as an ST key.) Its operation is demonstrated in FIG. 27B. 486 through 490 are sequential snapshots. About ½ second after pressing the palette zoom key, 487 shows the palette 487′ smoothly zooming up past ¾ full size, to reach full size 488′ another ½ second later. The palette then remains full size for about 3 seconds (duration adjustable at setup) and then, a total of 4 seconds after the palette zoom key had been released, automatically begins to shrink back down, past ¾ size 489′ 4.5 seconds after releasing palette zoom key, to reach ½ size 490′ (identical to 486′) 5 seconds after releasing palette zoom key. When transformation becomes disabled and the keys return to native, The palette 490′ can disappear either instantly, or by shrinking smoothly away to nothing in about ½ second (depending on preference settings), back to empty screen 481. To keep the full-size palette 488′ on screen for a longer time, one could hold down the palette zoom key. The palette would not begin to shrink until after the key's release.

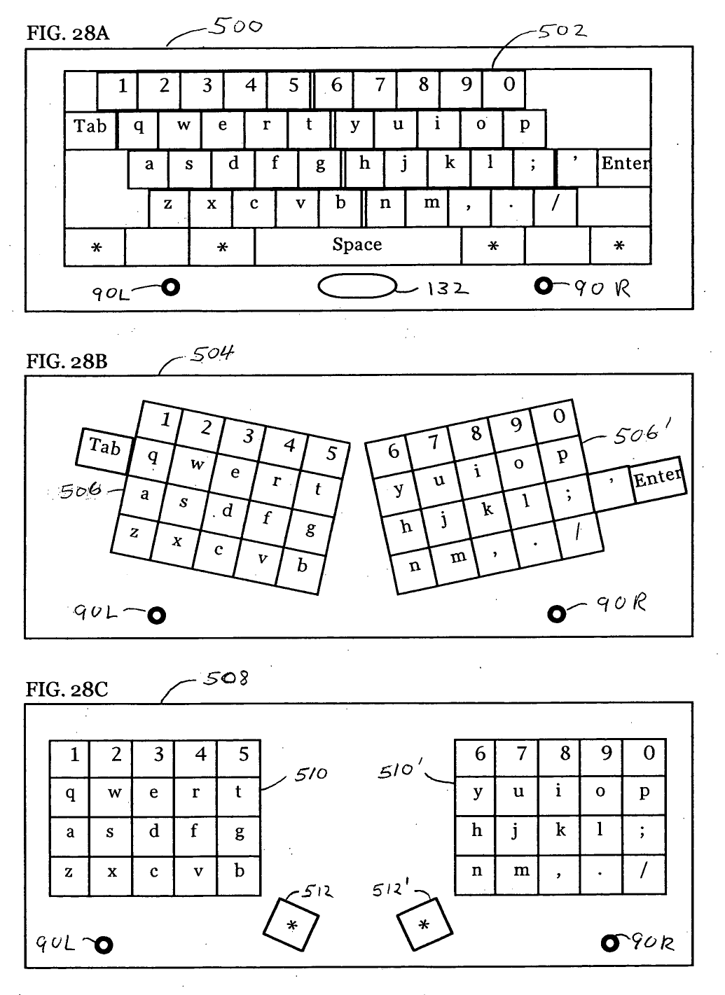

FIGS. 28A, B and C depict Qwerty keyboards 500, 504, and 508 for the purpose of showing the derivation of the rectilinear matrix used for the on-screen floating palette/transformation indicator of the present invention. The overall shape of these palettes and their matrix of rows and columns represents and reflects the geometric pattern of a set of key (switches) on the keyboard. The palette displays icons or labels in its compartments/boxes which represent the functions of the set of keys. The layout/position/arrangement of the assignment of each of the functions to each of the keys on the keyboard and the layout within the palette of the specific labels and icons that represent each of the functions are generally the same. These figures illustrate the core alphanumeric keys only, leaving off function keys and some modifier and punctuation keys for the sake of clarity. They include possible positions for keyboard hand position sensors 90L and 90 R. FIG. 28A (keyboard 500) has the traditional commonly used layout 502, whose asymmetrically offset row/crooked column design is based on the constraints of the original mechanical typewriter (constraints which are no longer desirable). Shown added here is a central extra thumb key 132 which could be used as an ST or ORT key. The rectilinear keyswitch matrix layouts 506 and 506′ depicted in FIG. 28B (keyboard 504) and the rectilinear keyswitch matrix layouts 510 and 510′ of FIG. 28C (keyboard 508) are far more ergonomic than keyboard 500, but as yet are commercially available in only a few keyboard models. In FIG. 28C, 512 and 512′ represent modifier keys such as Control or Command. Note that wherever in this patent application the term “rectilinear” is used in reference to keyboards, what is meant is generally rectilinear, or at least keyboards with straight columns as opposed to angled crooked columns.

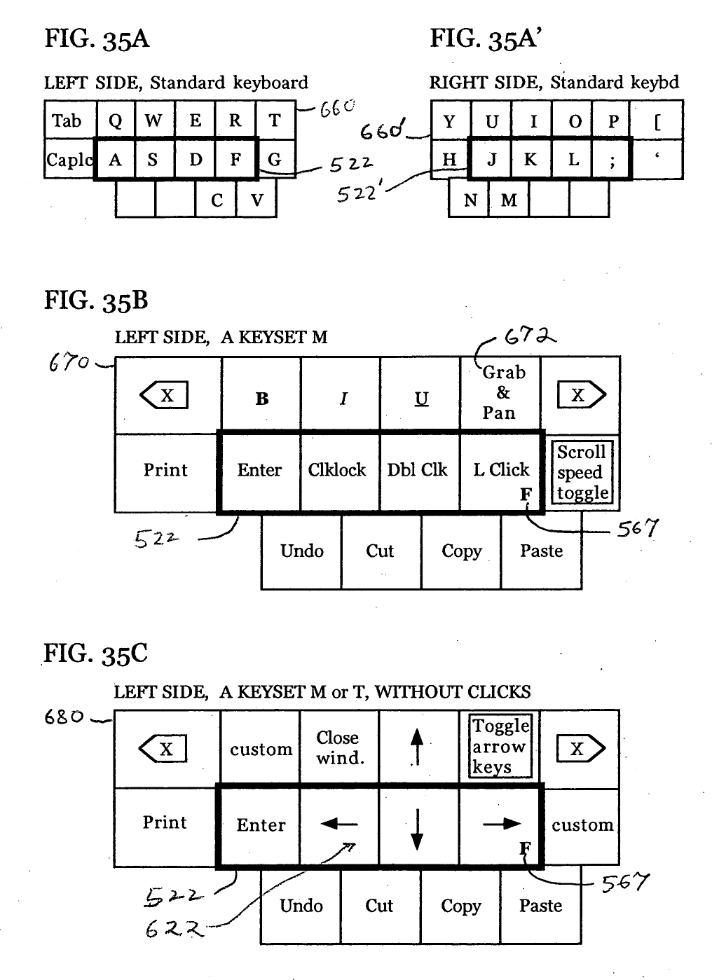

The rectilinear on-screen palettes used here to illustrate the present invention are derived from the most ergonomic keyboard layout, FIG. 28C; nonetheless they can be used to represent traditional keyboards also, as shown by the progression of FIG. 28A to 28B to 28C. The rectilinear palettes can represent any keyboard layout, those that are split and separated into parallel left and right sections as in FIG. 28C, those that are split and angled with respect to each other as in FIG. 28B, or those that are in one section as in traditional keyboards (FIG. 28A). For users of traditional offset row keyboards, an option could be provided to allow changing from the rectilinear palettes shown in FIGS. 29 through 34B and 38 through 40, to the offset row palettes of FIGS. 35 through 37. Templates for a variety of palette matrix shapes that correspond to a variety of keyboard shapes could be supplied to the user.

The matrix diagrams/palettes of FIGS. 29 through 40 basically serve three purposes: 1) to present examples of some of the many possible transformed keysets; 2) to illustrate their corresponding optional floating palettes that can automatically appear on the computer screen when transformation of each of these keysets is enabled; and 3) to demonstrate some examples of the variety of ways in which they can be used. Palettes can serve as transformation indicators and as reminders of new functions and their locations. The palettes can be used together with the keyboard to program the transformed sets, or to import multiple keystroke macros from preexisting software products and convert them into hand-position responsive single-stroke macro triggers. In addition to the particular transformed keysets shown in the palettes of FIGS. 29 through 40, any additional macros, variations in palette shape or in number of rows or columns may be used.

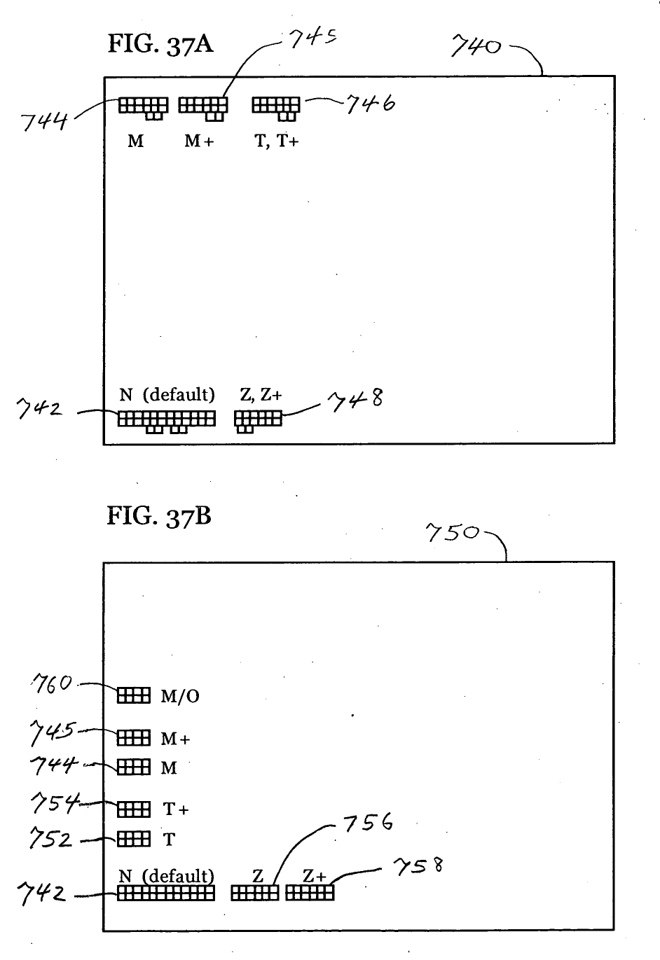

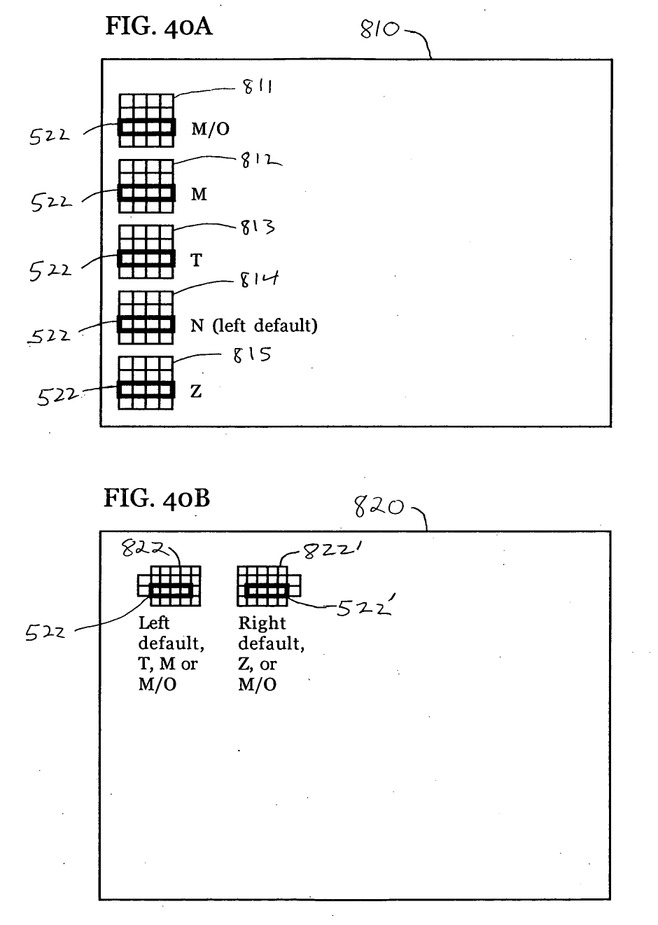

The on-screen palettes can either be fixed or floating, i.e., movable. They can each be a separate screen window, with resizing ability. They represent sets of keys transformed by either hand position detection, or by tool selection (see CAD FIGS. 37 and 40 and their discussion). They can consist of as few as four icons or labels (for the four home keys), or they can represent the entire keyboard. When active, that is, when the functions they display are currently the active functions of the keyset, the palettes can use any method of highlighting to distinguish them, including a thicker outline, a color change, or an increase in size.

The examples of transformed keys and keysets include illustrations of embedded transformed key actions/functions (shown above the first set of transformed functions, analogous to upper case) and the ST (Shift Transform) key which chooses the embedded functions when depressed, and of the ORT (OverRide Transform) key and its action. Also shown are keys/palette icons that indicate the present type of transformed keyset enabled (M, T, or Z), indicate the particular subset of that keyset that is enabled, and can be used to toggle between subsets. Although only the traditional “Qwerty” assignments for the native mode are shown in the diagrams of this patent application, “Dvorak” or any other keyboard layout could be used instead. In most of the transformed keyset/palette diagrams, on the left side of the page is depicted the left side of the keyboard for the left hand of right hand mouse users, and on the right side of the page is depicted the right side of the keyboard for the right hand of left hand mouse users. For orientation purposes, the left and right home keys: “a s d f” and “j k l ;” are shown outlined by heavy rectangles. Unless mentioned otherwise, the keysets shown are all “M” type transformed keysets.

FIG. 29 shows palettes 520 for the left hand and 520′ for the right hand, and demonstrates the transformation (while for example the mouse hand is at the mouse, state M and keyset M) of all four home keys, surrounded by the heavy rectangles 522 and 522′. All functions shown in the matrix boxes/compartments of 520 and 520′ are active except for the presently inactive original/native functions of the home keys shown in small bold italics in the lower part of each home key box. This transformation example provides three click functions (e.g., left click 524 and 524′, double-click 526 and 526′, and right click 528 and 528′) at the keyboard for the non-mouse hand and also, for the left hand a usually inaccessible “Enter” key 530, and for the right hand a usually inaccessible “Tab” key 530′. Thus, for right hand mouse users, while the right hand is at the mouse, the forefinger of the left hand could actuate click 524 by pressing the “f” key, the middle finger could actuate double-click 526 by pressing the “d” key, the ring finger could actuate right click by pressing the “s” key, and the pinkie could actuate Enter 530 by pressing the “a” key. These four fingers normally sit at rest on these same home keys. For all keysets, one could choose to have activation of transformation activate transformation of 1) only the non-mouse hand side of the keyboard, or 2) both sides simultaneously. With some sensor embodiments, the absence of either hand from its keyboard typing position or presence at the pointing device could be used to activate simultaneous transformation of both right and left keyboard sides (for ambidextrous use, eliminating the need to change any left/right setup settings for people of different handedness). Otherwise it does not really matter, since in order to transform, at least one hand must be absent from the keyboard. To satisfy anyone who might be in the habit of crossover hunt-and-peck typing, one could transform only the relevant side.

FIG. 30 illustrates the effect on the keyset shown in FIG. 29 of pressing the ORT (OverRide Transformation) key 532 during transformation (thicker outline around key 532 indicating depression). As shown in palettes 530 and 530′, all keys have reverted back to their native letter functions, for example now the home keys inside the heavy rectangle 522 actuate a, s, d, and f. Thus pressing the ORT key 532 enables the non-mouse hand to type native functions even though the mouse hand may be absent from the keyboard or present at the mouse.

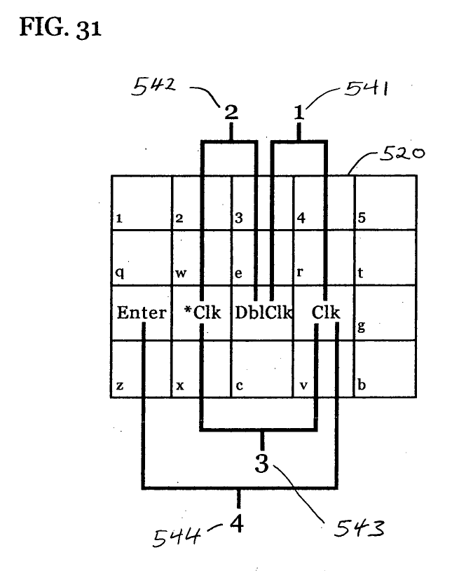

FIG. 31 illustrates optional chording of the transformed home keys of palette 520 of FIG. 29A: chord 1 (541) is actuated by “simultaneously” (within a dwell time) pressing keys with the transformed function labels “Clk” and “DblClk”, chord 2 (542) “DblClk” and “*Clk”, chord 3 (543) “Clk”, and “*Clk”, and chord 4 (544) “Clk” and “Enter”. The chording option can be added to setup and programming features, along with an adjustable chording dwell time setting. Any functions or macros could be assigned to the chords, particularly such as additional special clicks (e.g. shift-click, option-click, command-click or control-click), pop-up menus, or some of the 12 “Function” keys. (FIG. 31 shows only the left side of the keyboard, for use by the left hand of right hand mouse users.)

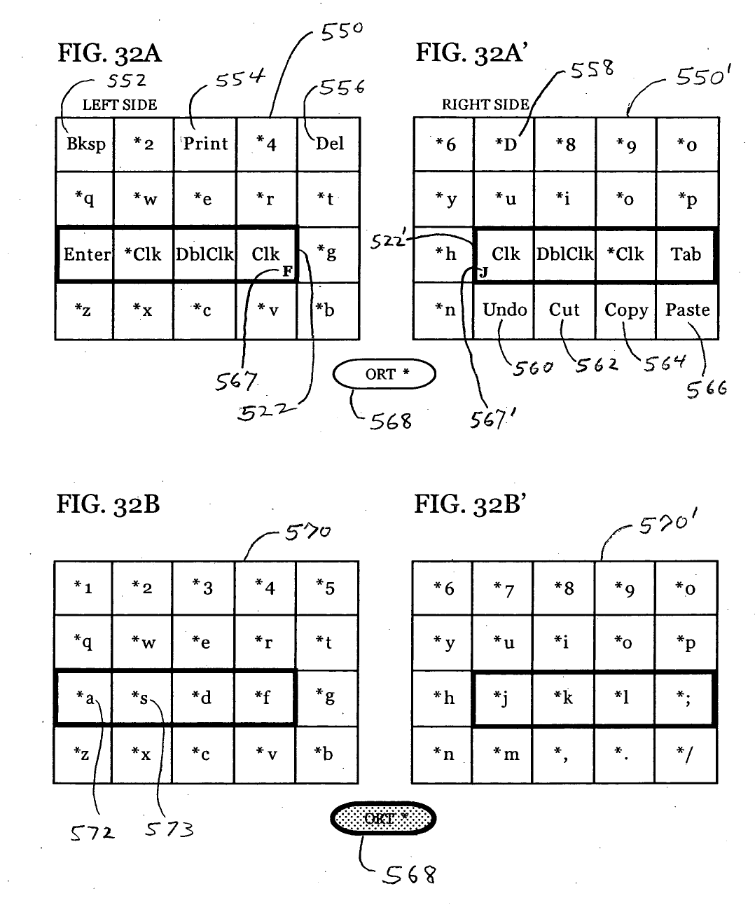

Palettes 550 and 550′ of FIGS. 32A and 32A′ are similar to FIGS. 29 and 29′, with the addition that here transformation also automatically converts “1” to Backspace (“Bksp” 552), “3” to “Print” 554, “5” to Delete (“Del” 556), “7” to Duplicate (“*D” 558), and letter m, comma, period and forward slash are transformed into “undo, cut, copy and paste” 560, 562, 564, 566 respectively; and in addition these transformed palettes add the modifier “*” (=“Control” in the PC world, and “Command” in the Macintosh world) to all other letter keys, thus making it possible to trigger their keyboard shortcuts with one keystroke. (For example, to trigger “Close Window” one now only has to press “w”, and not also the modifier key.

Note the small bold capital letters “F” 567 and “J” 567′ that are shown within the home key rectangles 522 and 522′; their purpose is as a palette orientation reference to the keyboard home keys “F” and “J”, and will be used as such in all of the palette figures to follow.

The palettes of FIGS. 32A and 32A′ make available Clicks, Enter, Backspace, Print and Delete to the left hand, and Clicks, Tab, Duplicate, Undo, Cut, Copy and Paste available to the right hand. For situations where, while one hand is at the mouse, it is desired to be able to activate keyboard shortcuts that are transformed in FIGS. 32A and 32′, instead of pressing an ORT key 532 as in FIGS. 30, one could use an ORT* key 568 which, when pressed as shown in palettes 570 and 570′ of FIG. 32B, overrides transformation and simultaneously adds a modifier, thus directly making available Select All “*a” 572 or Save “*s” 573, for example.

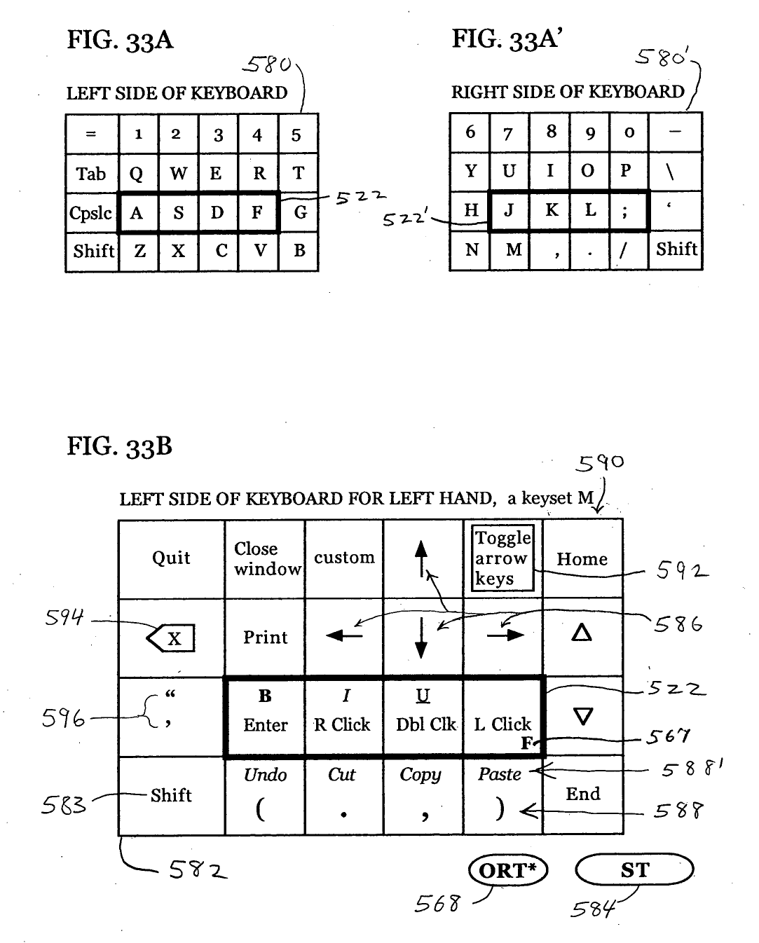

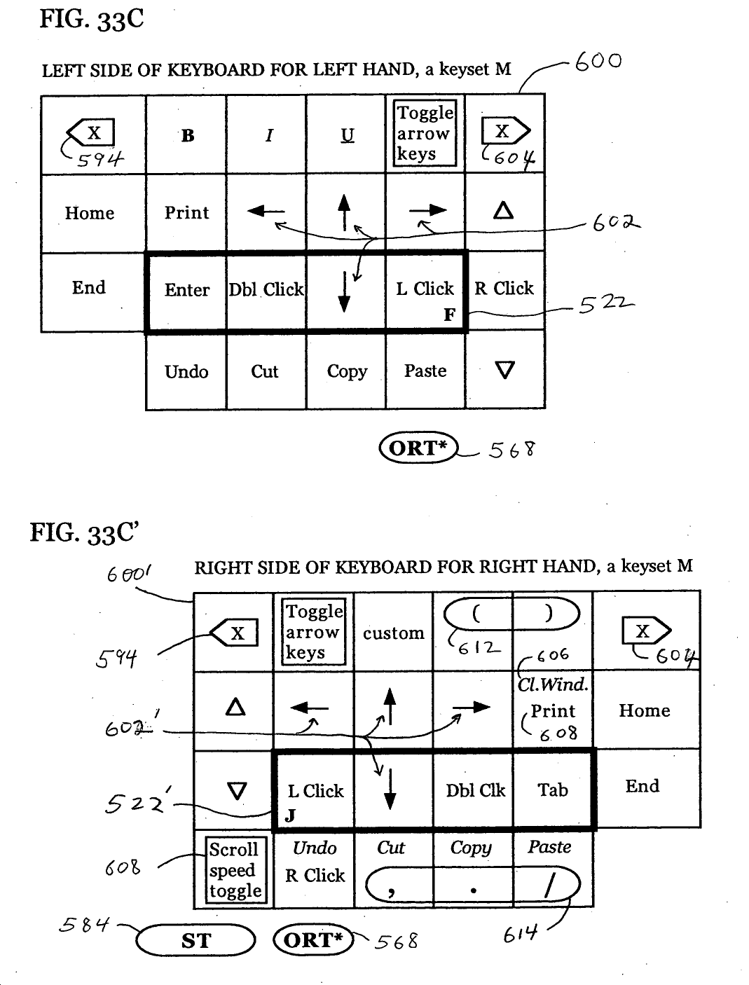

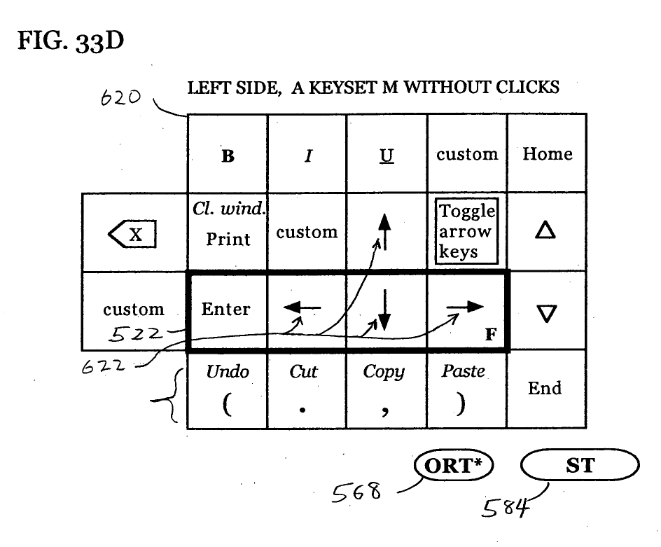

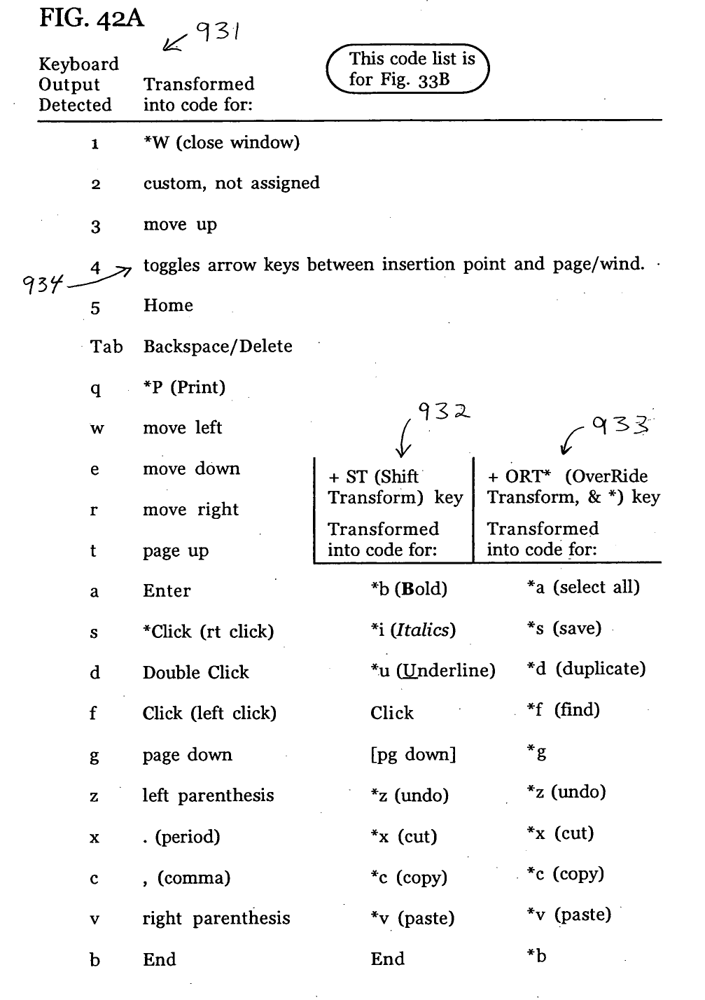

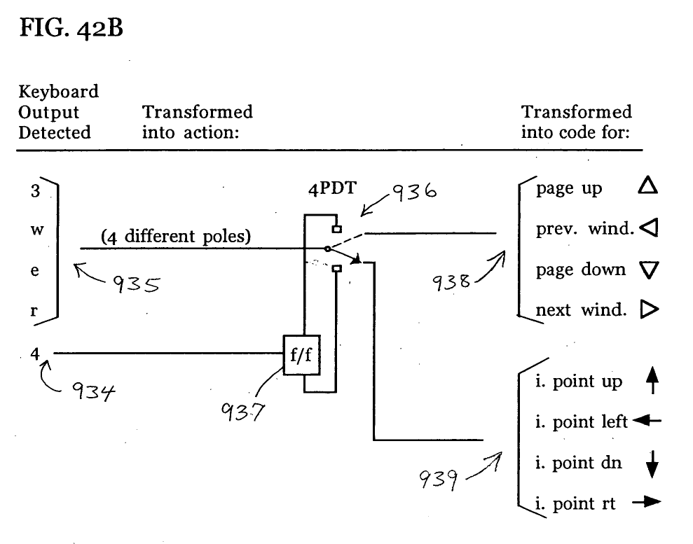

FIGS. 33A and 33A′ show, for reference purposes, palettes 580 and 580′ containing the native key assignments for the left and right side of the keyboard respectively. FIG. 33B introduces the use of the ST (Shift Transform) key and an arrow toggle key. Palette 582 of FIG. 33B displays a multipurpose transformed keyset M embodiment of the present invention for the left side of the keyboard for use by the left hand. Use FIG. 33A to find the native key assignments for each palette box, using the home key heavy rectangle 522 and the small bold capital letter F (567) as orienting references. All functions shown are the transformed functions except for Shift 583. This keyset combines mouse clicks, navigation keys and single stroke shortcuts for general use; for example, for use in the Finder and for word processing, editing and for surfing the web. This palette provides a great deal of power for the left hand without the right hand having to leave the mouse. The home row, outlined by heavy rectangle 522, is used for left click, double click, right click and for right hand mouse users, a now accessible Enter/Return. The home row also has embedded, to be activated by the Shift Transform key (“ST” 584): B (Bold), I (Italics) and U (Underline), labeled above Enter, R Click and Dbl Click respectively in the same palette boxes. Above home row is a group 586 of up, down, right and left arrow move keys. The row below home row, in the positions of native z, x, c, and v, consists of parenthesis, period, comma, and close parenthesis respectively (group 588), which, upon pressing of the ST key 584, further transform to provide Undo, Cut, Copy and Paste (group 588′) as labeled above the group 588 labels in the same boxes. Another group is the vertical column consisting of Home, page up, page down, and End (group 590). These four basic groups, the home keys 522, arrows 586, editing functions 588 and 588′, and page navigation functions 590 could be visually organized and distinguished by each having its own color, both in the palette 582, and in the form of colored key caps (or stick-on thin colored key cap labels) on the keyboard. Small arrows could be applied to the top or front side of the four navigation keys without interfering with the native letters. The “toggle arrow keys” toggle key 592 could be used to toggle the action of the arrow move keys back and forth between moving a selected object or insertion point, or previous window, next window, page up and page down. (This toggle and its implementation will be detailed in FIGS. 42A and 42B. In general in the palette figures in this document, text surrounded by a rectangle within a palette box signifies a toggle key. The page up and page down triangles in the native “t” and “g” locations, group 590, always provide page navigation abilities no matter how the toggle is set.) The icon 594 is for Backspace. The apostrophe 596, which plus ST key 588 results in quotation marks, together with group 586, 586′ and Backspace 594 place some of the most commonly needed functions for editing under the left hand for use while the right hand is at the pointing device. This greatly reduces the number of trips back and forth between pointing device and keyboard, with a great increase in speed and efficiency.

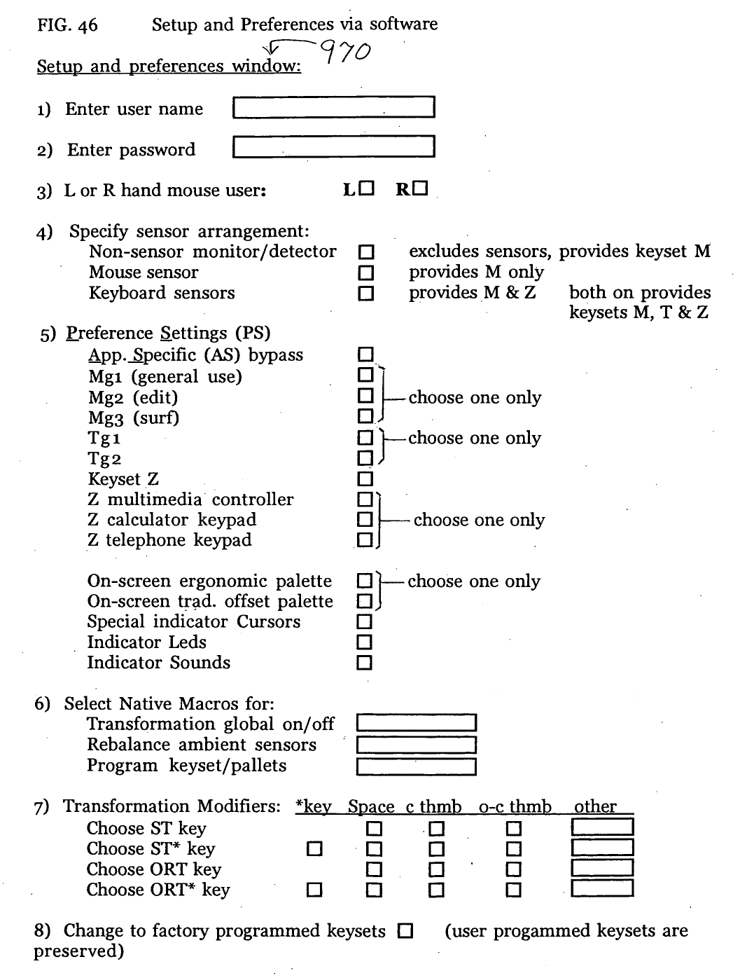

FIG. 33B shows both ORT* 568 and ST 588 keys (the ST key could instead be an ST* key, with the * removed from the embedded macros). The ORT and ST functions could be combined together in the same key, simultaneously overriding transformation for some keys, and making embedded transformed functions active for others. While the ST key is depressed, the embedded functions made active by it could optionally become highlighted in the on-screen palette. On some keyboards the * modifier key is convenient to use as an ST* key. This can be enabled by including the *modifier key in the set of keys transformed, and transforming it into ST*. It could retain its * function for native and single level transformed keys, and also activate embedded functions while simultaneously adding * to them. The normal Shift key 583 could also be assigned to be the ST key. Setup of ORT and ST will be shown in FIG. 46 and in the list “Preferences Setup via Hardware” below. A right side of keyboard version of FIG. 33B for left hand mouse users (not shown) would leave the comma and period untransformed (unless ST is pressed) in order to enhance the editing ability of the right hand alone at the keyboard. The keyboard “Space” bar or key, not shown in these palettes so far, could be included at the bottom of the palettes in T keysets, and in any M keysets and applications where the “Space” function itself will not be needed. “Space” could then be transformed into ST or “Click” or any other function. Extra thumb keys such as 132 and 134L and 134R from FIGS. 3 through 7 (and in many of the figures to follow below) could either be ST or ORT, or could have any other functions assigned to them where ORT or ST functions are not needed.

FIGS. 33C and 33C′ are pair of palettes 600 and 600′ which display additional possible arrangements for M keysets, with 600 representing the left side of the keyboard for operation by the left hand of right hand mouse users while the right hand is at the mouse, and 600′ representing the right side of the keyboard for operation by the right hand of left hand mouse users while the left hand is at the mouse. Palettes 600 and 600′ have an arrangement of their arrow key group 602 that is different from the arrow key group 586 of FIG. 33B, have both a backspace 594 and a forward delete key 604. Palette 600′ of FIG. 33C′ adds an embedded Close Window 604 in the same box as a Print 606 function and a “Scroll speed toggle” 608 in the position of native letter n. It leaves the parenthesis, comma, period and forward slash untransformed, as indicated by their being surrounded by rounded rectangles 612 and 614 respectively, so that they can be used for editing by the right hand while the left hand is at the mouse.

The “Scroll speed toggle” 608 can be used to change the scrolling speed or step size. Some examples of its use are if the default scroll step size were ½ page, this key could be set up to reduce it to two lines, for either as long as the key was held down (momentary), or until it was pressed again (latched). Alternatively this key could be used to increase the step size from the default, or to toggle through a sequence of step sizes. Instead, two or three transformed keys could be used to select different step sizes, either to toggle up and down, or each dedicated to a step size. An additional aid to scrolling can be a key in a transformed keyset assigned to convert from the default vertical scrolling to horizontal scrolling (as either a momentary or a latching control).

FIG. 33D contains palette 620, which can represent a M keyset without clicks for the left side of the keyboard. This is an example of a keyset for persons who may want to continue using only the traditional buttons on a pointing device for clicks, and wish to have the convenience of three of the four arrow keys (group 622) in the home key positions.

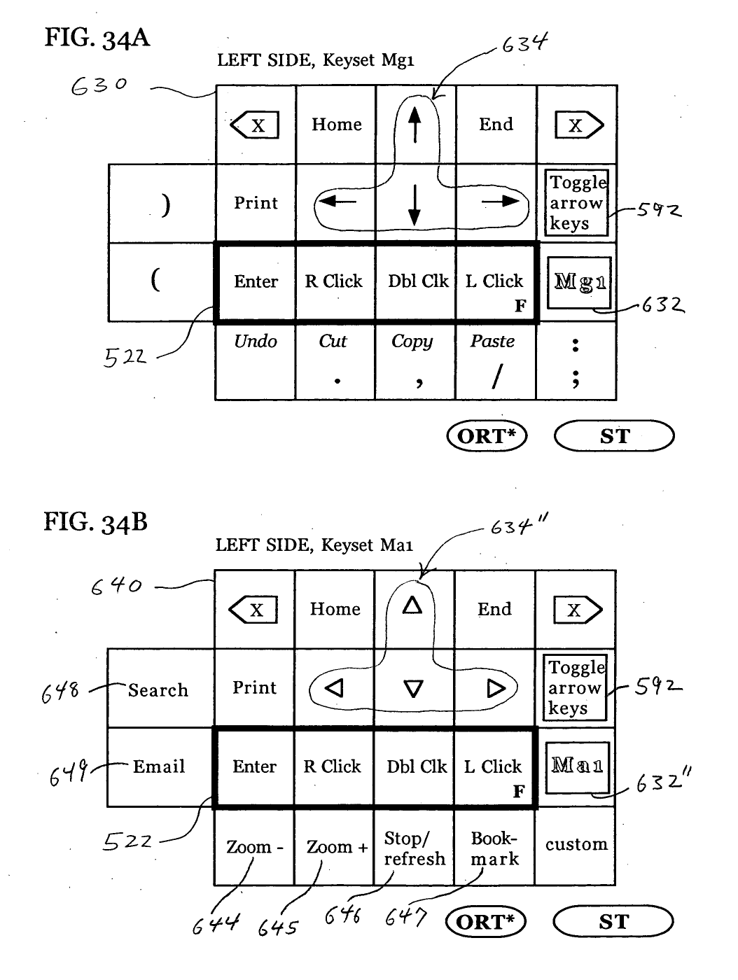

FIGS. 34A and 34B show palettes 630 and 640 for the left side of the keyboard, and demonstrate another method of providing more than one keyset within the same transformation state (in addition to the use of the ST or ORT keys). Palette 630 represents a “Mg1” keyset (M general keyset optimized for editing) with a “Mg1” toggle icon 632 in the location of the native letter g (or h for right side). When pressed, the Mg1 turns into a “Ma1” (642, M application specific keyset optimized for surfing), and the keyset changes to the arrangement depicted in FIG. 34B. FIG. 34B adds transformed functions for Zoom (644, 645), Stop/refresh 646, Bookmark 647, Search 648 and Email 649. Furthermore, the move-insertion-point state of “toggle arrow keys” toggle 592 is the default state for keyset Mg1, as shown by group 634, and the page control state is the default state for keyset Ma1, as shown by group of triangles 634′. This demonstrates one method of indicating which state toggle 592 is in, and these triangle icons/indicators can be used with any keyset. Toggle 592 can be used in any state to switch the function/state of the arrow keys from the default.

If desired, the Mg1 and Ma1 keysets could be used in conjunction with a T keyset or a special contextual menu containing *B, *I, *U and *T. In general, for any transformed keyset, any “overflow functions” (secondary functions that will not fit into the keyset but for which easy access while mouse hand is at mouse is desired) could be relegated to either a T keyset or to a special contextual menu to be opened with a “right click”.

T keysets can be paired with a M keyset for activating the embedded functions of that M keyset, that is, as a substitute for pressing the ST key. For example, when in the M keyset of FIG. 33B, activating T keyset could result in a keyset (not illustrated) identical except that all the previously embedded functions become active. This can be a very useful alternative to using a key to activate ST.

To summarize, if not all of the functions desired to be accessible to the non-mouse hand in a transformed M keyset will fit into the keyset, the remedies are: 1) Embed the function for activation by either the ST key or by a paired T keyset such as described in the previous paragraph; 2) include it in any other T, or a Z keyset, or 3) relegate it to a special dedicated contextual menu linked to appear if called up while the M keyset is active.

Three uses for transformed keyset Z (mouse hand at keyboard, other hand absent) are an application specific multimedia control keypad, a numeric keypad/calculator and a telephone dialer keypad. T and Z keysets may also be used in any other way not illustrated here, including for example to provide macros to open different applications or macros of function keys F1 through F12.

FIGS. 35A to 35C illustrate examples of palettes designed particularly for standard staggered row keyboards. FIGS. 35A and 35A′ show palettes 660 and 660′ with native assignments and as orienting references for the left and right hand side of the standard keyboard respectively. (When looking at FIGS. 35B and 35C, use FIG. 35A to find the native key assignments for each palette box, using the home key heavy rectangle 522 and the small bold capital letter F (567) as orienting references.) FIGS. 35B and 35C are for the left hand side of the standard staggered row keyboard. Palette 670 of FIG. 35B contains general use and click functions for transformation state M. It also contains a “Grab & Pan” tool 672 for grabbing and dragging documents with the mouse in applications that support it. Palette 680 of FIG. 35C has no click functions, with group of arrow keys 622 in the place of clicks. This palette can be used for state M or T. As a T keyset, palette 680 could be used in conjunction with the M keyset of palette 670.

A choice can be offered for the type/shape of palette displayed on-screen: either the rectilinear palette of, for example, FIG. 33B, or the offset palette of FIG. 35, or any other such as a curvilinear or fan-shaped palette or any shape in the future to match new keyboards. “Setup and Preferences” shown in FIG. 46 provides this choice. Any alternative form of transformed keyset palette, labeling and icons could be used to replace the palettes shown above. Any keys not included in an active keyset will retain their native function, and can still be used even while other keys are transformed.

Hand Position Responsive Transformation For Cad Application

The method of hand location responsive transformation can be used to great advantage for tool selection in CAD and in other similar programs that employ palettes containing many tools. A CAD program could be designed around on-screen palettes where the overall shape of the palette and its row/column matrix approximately reflects the geometric pattern of a set of keyboard keys, and where the palettes displays icons which represent the key functions (either current or potential) inside of compartments which represent the keys. The layout of the assignment of functions to keys on the keyboard and the layout within the active palette of the icons that represent those functions is always the same. If only one on-screen palette matrix outline is used for all hand position responsive states, then the icons of that palette and active keyboard key functions stay linked and matched, both changing together when hand location changes. Where each transformation state has its own dedicated on-screen palette, the current key functions are reflected by the labels within the active transformation state's palette. The keysets and the palettes that represent them could ergonomically use, for standard keyboards with staggered rows/crooked columns, either four, eight, ten, twelve or fourteen keys (for one side of keyboard). Rectilinear keyboards could ergonomically use eighteen or up to a maximum of twenty-four keys per side. Any keyset may additionally include an embedded level of functions accessible by pressing a modifier or shift transform (ST) key, analogous to the effect of a standard shift key, effectively doubling the number of tools in each. The labels of both the first and the embedded (shifted) level functions can be simultaneously displayed in each palette compartment/box, usually with the shifted level icons shown above the first, with the currently active set highlighted. Alternatively, only the level that is active could be displayed.

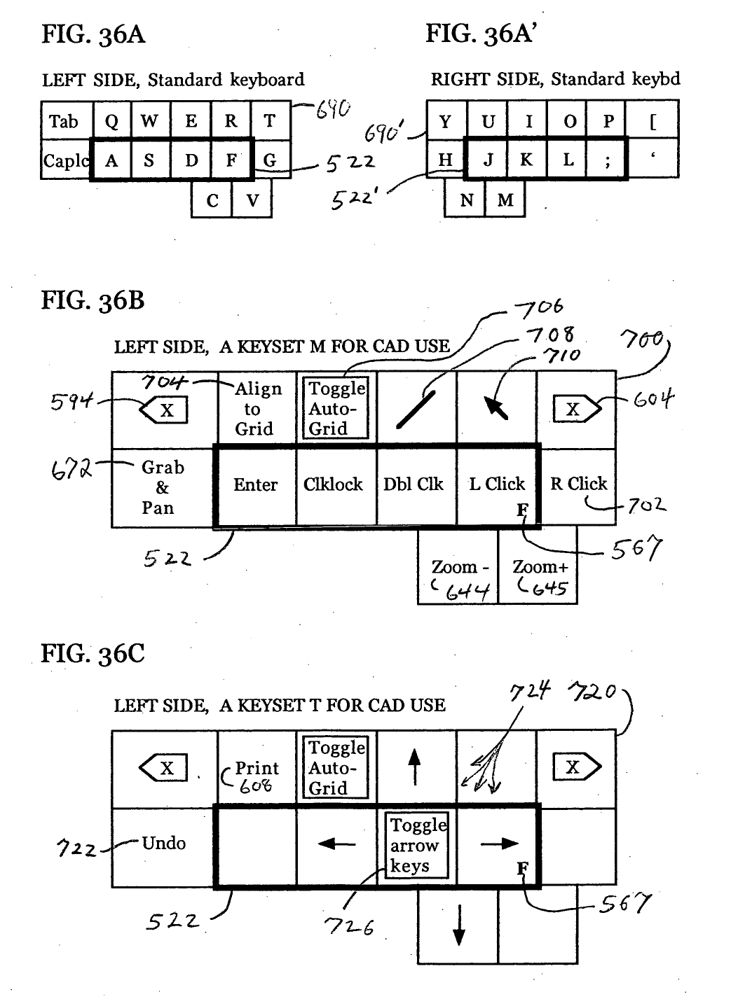

FIG. 36A, B and C illustrate possible palette outlines/matrices to be used for implementing the CAD interface method of the present invention. They show basic palettes for use with standard staggered row keyboards in CAD applications; the palettes are shown first with alphanumeric character assignments for text tool, then with M keyset and then T keyset. These two-row palettes are usable with any keyboard, and are particularly designed for easy eye-to-hand pattern transfer for the standard keyboard. In applications such as CAD where more than two different transformed keysets are used, fast and easy eye-to-hand pattern transfer is more important than when using only one or two general use transformed keysets. In the case of only one or two transformed keysets, eye-to-hand pattern transfer is relied on at first as a learning aid, but soon intuitive finger memory becomes the basis of operation.

Although the QWERTY layout native alphanumeric assignments are shown here, any other native assignments could be substituted instead. The palette outline 690 of FIG. 36A represents the left side of the keyboard in alphanumeric text mode (a text tool selected), showing the four home row keys A S D F (outlined by heavy rectangle 522) for use by the four fingers of the left hand, and the palette outline 690′ of FIG. 36A′ represents the right side of the keyboard, showing the four home row keys J K L ; within heavy rectangle 522′ for use by the four fingers of the right hand. Although on the standard keyboard the row above home row is shifted over (staggered) to the left by about one-quarter of a key width with respect to home row, for visual clarity and simplicity these palette outlines are drawn here with the uppermost row directly above the home row. These palette outlines/matrices can each contain a basic visual base of two rows of four (home row plus the row of four keys above home row) for a total of eight compartments/boxes, and the optional additional boxes shown can provide a total of up to ten, twelve, or fourteen boxes, thus representing up to fourteen keyboard keys.

FIG. 36B contains palette 700, which represents a fourteen key M keyset for CAD use for the left side of the keyboard. Use FIG. 36A to find the native key assignments for each palette box, using the home key heavy rectangle 522 and the small bold capital letter F (567) as orienting references. This provides for the left hand at the keyboard a grabber-hand scroll tool 672 in the position of native Caps Lock for the manipulation of documents by the mouse in applications that support it. It also provides Enter, three clicks within heavy home key rectangle 522, a Right Click 702 in the position of native letter g, Backspace 594 in the position of native Tab, Align to Grid key 704 in the position of native letter q, a Toggle Auto-Grid toggle key 706 in the position of native letter key w, line tool 708, selection arrow tool 710, forward delete 604, and zoom keys 644, 645 in the position of native letters c and v. The line tool and selection arrow tool are included here because they are the most commonly used CAD tools. Other CAD tools could be available in a M+ (i.e., M plus ST key) keyset.

FIG. 36C contains palette 720, which represents a fourteen key T keyset for CAD use for the left side of the keyboard. It is designed to be used together with the M keyset of FIG. 36B, and adds Print 608 and Undo 722, and up, down, left and right arrow move tools (group 724) together with their toggle key, 726. This particular layout of the arrow key group is especially useful because it allows the use of separate fingers for up and down as well as for left and right, making it possible to alternately move an object up and down without shifting a finger back and forth. This is an example of the kind of individualized ergonomic customization of the home and surrounding keys that can be done by the individual user of the present invention.

Alternatively, if a T keyset is not to be used, the palette of FIG. 36C could be used as a M keyset, and some of the functions of FIG. 36B could be programmed into its blank boxes.

FIGS. 37A and 37B show windows on a computer screen containing two possible configurations of multiple on-screen palettes for use in selecting tools in CAD applications, using the standard keyboard with the left hand at the keyboard (for right hand mouse users). Each palette has an adjacent caption or information box indicating the transformation state that activates it and/or the label of its keyset. The default mode in many CAD applications is a special CAD functions mode with pre-assigned functions active in lieu of the standard alphanumeric keyboard. The palette that is active at the moment (i.e. the one whose icons/labels correspond to the current transformation state and the active functions of the keyboard keys under the non-mouse hand) would be indicated by some type of highlighting such as a thicker border, an increase in size, or a change of color. Tool icons and therefore the palettes that contain them can be smaller than those used when selecting tools by moving the mouse and clicking directly on the icons as in prior art.

Computer screen window 740 of FIG. 37A is shown containing five different palettes, representing keysets of the same name: N (default special functions) 742; M 744; M+ 745; T, T+ 746; and Z, Z+ 748. As shown, 744, 745 and 746 represent the left side of the keyboard, 748 represents the right side, and 742 (default functions) represents keys on both sides of the keyboard. These palettes match the shape of the palettes of FIGS. 36, with the top row being the row above home row, the second row from the top being the home row (plus one key on either side of the four home row keys), and the two boxes hanging below are the native letter c and v keys on the left side, and n and m keys on the right. M could be similar to palette 700 of FIG. 36B, and M+(M transformation state plus the ST key pressed) could be a palette containing fourteen drawing tools. T, T+ (746) could be similar to palette 720 of FIG. 36C, in T state, and change its contents to fourteen drawing tools, or methods and operations when the ST key is pressed while in T state. Z, Z+ 748 could be used for more tools or other functions.

Window 750 of FIG. 37B is similar to 740, but containing eight different palettes and in a different arrangement. Here each palette represents a keyset of eight keys, the four home keys (the bottom row of each palette) and the four keys above home row (except N default 742 which contains 24 keys, including the whole row that contains the home keys, plus the row above, and represents both sides of the keyboard). T, T+ (746) of window 740 has been divided into separate T (752) and T+(754) palettes, and Z, Z+(748) has been divided into separate Z (756) and Z+ (758) palettes, taking up slightly more room on the screen, but always providing a display of the full choice of tools and functions available. (One can choose to have either all palettes displayed on the screen simultaneously, or only one palette matrix on the screen at a time, with its name label and contents labels/icons changing automatically with key transformation.)

Hand position detection activates either N (native or default state and functions) or transformation state T, M or Z. A tool is selected by pressing the keyboard key that corresponds to the desired icon in the active palette, at which time that icon becomes highlighted. The selection is usually latched until a different tool is selected. A function or tool may be selected via the keyboard from the palette containing sets of functions/tools available while the keyboard is in its native/default state N, or from other palettes/sets of functions available while in transformed states T, M or Z.

Once a tool is selected, then automatically, and independently of any change in location of hand detected after selection, a methods/operations palette (M/O 760, FIG. 37B) could optionally become activated, i.e., the keyboard functions now change to reflect this methods and/or operations palette, showing only methods and/or operations available specifically for that tool, with the method that was last used with that tool is automatically selected and highlighted (or alternatively, the default method for that tool, pre-chosen in preferences). When it is desired to select a different tool, pressing on an already selected method or on an exit key can revert back to tool selection mode: hand position responsive T, M, or Z palettes keysets containing tools. Thus there can be two basic modes, 1) a hand position responsive tool selection mode, and 2) methods and operations mode (M/O mode) which can either override all hand position activated keysets, or be relegated to only the T transformed state. The methods palette could include an exit toggle key for toggling back into tool selection mode. It could also include, for convenience, the most commonly used tools such as the selection arrow tool and the line tool. From a tool palette, selecting a new tool or pressing on an already selected tool or pressing the exit toggle key (which would preferably be present and in the same location in all tool and m/o palettes) would automatically toggle the mode (and active palette and keyset) back into M/O mode.

M transformed state could always be available for clicks, etc., and there could be different T keysets, one containing tools, and the other containing methods/operations, with the same toggle key in the same location in both for manually toggling back and forth, analogous to the Mg1 and Ma1 keysets of FIGS. 34A and 34B, with their toggle key 632.

Therefore in the method of this invention, the act of tool selection can be made to simultaneously cause the keyboard keyset to automatically transform, this time to match the layout of the method icons in the methods palette for that tool, so that if desired a different method for that tool can be selected from the keyboard via eye-to-hand pattern transfer. In prior art CAD applications, tools are selected either from a palette by mousing and clicking in the palette, or by pressing a keyboard key whose default function is selection of that tool, but not by having the palette pattern match a key function layout pattern and using eye-to-hand pattern transfer, and not having any transformation of keys to match palette layouts, and without any hand position responsive transformation of key functions. In prior art, tool selection sometimes automatically causes methods and/or operations palettes to change to display icons appropriate for the selected tool, but again, no transformation of key assignment layout occurs to match the palettes, and there is no hand position responsive transformation of key functions.

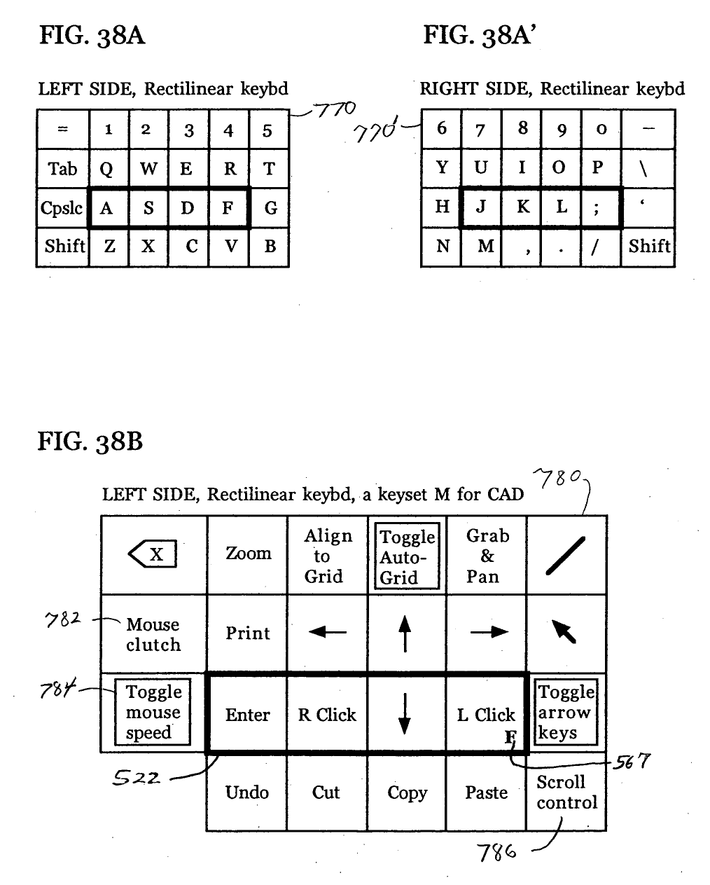

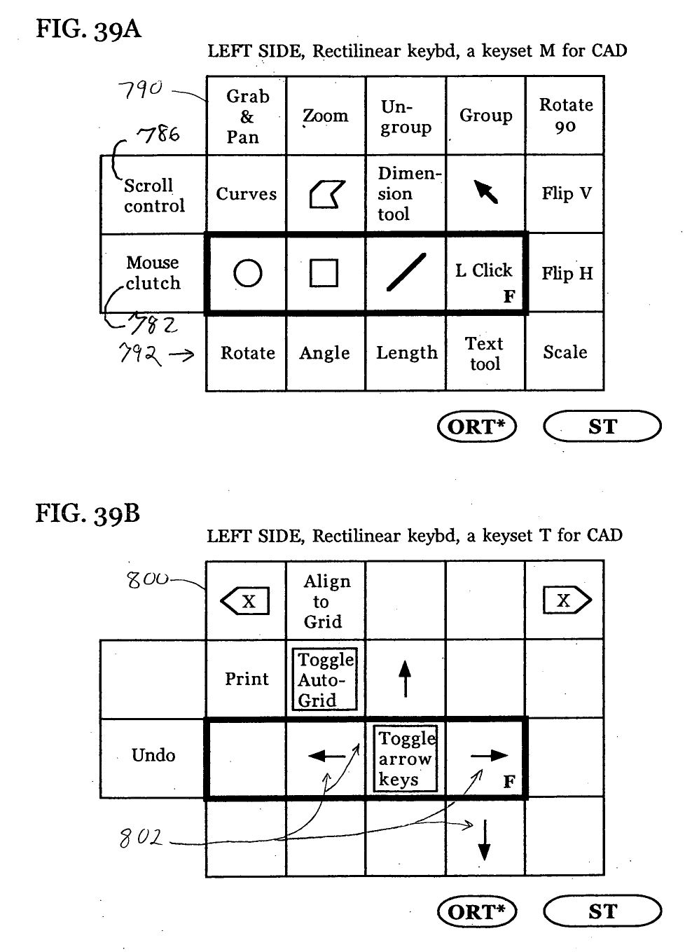

FIGS. 38A and 38B show basic palettes for use with rectilinear keyboards in CAD applications. FIG. 38A and 38A′ show palettes 770 and 770′ representing keysets containing twenty-four keys each for CAD use, for the left and the right side of the keyboard respectively, shown with the native alphanumeric character assignments that are active while a text tool is selected. Palette 770 of FIG. 38A also serves as a reference for the correlation of the key assignments in FIGS. 38B and 39A and 39B to keyboard native key positions. (Use FIG. 38A to find the native key assignments for each palette box using the home key heavy rectangle 522 and the small bold capital letter F (567) as orienting references.) FIG. 38B displays left side palette 780, a keyset M for use in CAD applications, that includes the Mouse clutch 782 and Toggle mouse speed toggle 784 to be detailed in the discussion of FIG. 43 and FIG. 44B, and Scroll control 786 which can be used to momentarily (or toggle) change the function of a scroll wheel or other scrolling device (for example, from vertical to horizontal scrolling, or to link to another function such as zoom or rotate.

FIGS. 39A and 39B show a pair of palettes (790 and 800) displaying CAD keysets for M and T that work together synergistically. These are designed for the left side of rectilinear keyboards. Palette 790 includes a left click, the arrow selection tool, line, rectangle, and circle tools, and the bottom row (group 792) consists of tools which automatically convert the keyboard to native alphanumeric text characters for entry of numbers or text. Palette 800, for T (Transition) transformation state, when the mouse hand is not present at either keyboard or mouse contains group 802 of four arrow keys in an arrangement that is very convenient, especially for CAD, because it allows nudging/adjusting a selected object up and down using two fingers, the middle finger on the up arrow key and the index finger on the down arrow key simultaneously, without having to shift a finger from one key to another.

FIGS. 40A and 40B show computer screen windows with two different configurations of multiple on-screen palettes for use in selecting tools in CAD applications, using a rectilinear keyboard. FIG. 40A is window 810, containing five palettes optimized for eye-to-hand pattern transfer for rectilinear keyboards. They each represent the same sixteen keys on the left side of the keyboard (except Z, 818 represents the right side) and contain four columns, one for each finger, making for easy eye-to-hand pattern transfer. They have four rows, the row of home keys (outlined by heavy rectangle 522), one row below, and two rows above home row. The palettes show the keyboard key functions for keysets: M/O (Methods and/or Operations 811), M (812), T (813), N (left default special functions) 814, and Z (815). M, T and Z are transformed by hand position as detailed earlier in this document, N is not transformed but is the default (although it is selected automatically by hand position by both hands being present at their keyboard typing positions), and M/O is transformed by tool selection. Only one of these palettes is active at a time, and thus to return to tool selection mode from M/O, an exit key should be provided within the M/O keyset, preferably one of the home keys. The ST key can be added in any state to provide an additional keyset for that state, and could be used to provide the right side of the default keyboard when ST is pressed during N state. An ORT or ORT* key could also be used in conjunction with any state.

FIG. 40B is window 820, showing the use of only two palettes, 822 for the left side of the keyboard, and 822′ for the right side. These palettes are similar, in both shape and in keyboard keys used, to the palettes of FIGS. 39A and 39B, and the home keys are outlined by heavy rectangles 522 and 522′. Palette 822 on the left represents either: Left default, T, M, or M/O (Methods and/or Operations) keysets. Palette 822′ on the right represents either Right default, Z, or M/O. The palettes are either in tool selection mode or in M/O mode. In tool selection mode the keyset they represent and tools they display depends on the transformation state resulting from sensing hand position. Selecting a tool (which can only be done from within tool selection mode and is done by finding the desired tool in the palette and pressing the corresponding key via eye-to-hand pattern transfer) toggles the mode into M/O mode. The tool can then either be used for drawing with the preselected method, or a new method can be found in the palette and its corresponding keyboard key pressed. Pressing an exit key within the M/O mode keyset toggles the system back into tool selection mode. This is only one example of numerous ways that the method of the present invention can be used in CAD applications.

An alternative example is as follows, with other variations possible:
A) With rectilinear keyboards, using transformation state T to automatically provide a rectilinear numeric keypad keyset for the left hand can be extremely useful, especially when having to type numbers into a drawing. The selection of a text tool, which converts N state keyboard functions from default to native alphanumeric (such as any of the tools in the bottom row group 792 of FIG. 39A), could be used to automatically convert the T keyset to a numeric keypad. M state transformation could be unaffected by text tool selection. Thus when a tool that requires the typing in of letters or numbers is selected, the target location can be selected by moving the pointing device and then clicking from M keyset, and then backing the hand away from the pointing device slightly to activate T keyset, making available a numeric keypad to the non-mouse hand for entering numbers at the selected location. A keyset transformed to a numeric keypad works best with rectilinear keyboards, where z x c v can be 0 1 2 3, a s d f can be Enter 4 5 6, and q w e r can be . 7 8 9. (Prior art creation of a numeric keypad from keyboard letter keys is via a function key trigger rather than a hand position activation, and is of the right side only.)
B) Selecting the selection arrow or any other type of tool not requiring alphanumeric entry does not affect M keyset, but could automatically convert either M+, T or T+ keyset (transforming both the keyset and its corresponding palette simultaneously) into methods and or operations appropriate for use with that tool. One could then select a desired method or operation for that tool via eye-to-hand pattern transfer, and in this method the selection of a tool would not override hand position responsive transformation (as it did in the method introduced above during the discussion of FIGS. 37 and 40), nor does it have to affect M keyset, but in both of the above cases A) and B) it controls which functions becomes available during one of the transformation states: T state can normally provide a T keyset consisting of either 1) arrow move tools (e.g. FIG. 36C or 39B), 2) a set of drawing tools, 3) methods and operations (which change appropriately with selected tool), or 4) a fixed numeric keypad. One addition could be a transformed key within a T keyset to serve as a toggle key to toggle between any two of 1), 2), 3) and 4) above and another possibility would be to use a ST key (a keyboard modifier key or mouse button) to serve a similar purpose.

A tool selected in one transformation state stays selected and can be used until a different tool is selected, even if the transformation state/keyset changes. While the Text tool is active the default palette could either be empty, absent, or show the native alphanumeric characters (for the keyboard left side, for consistency).

Cad Method Summary

The essential components of using the method of the present invention for CAD tool selection are: hand position responsive function transformation, together with palettes that are based on the home keys and the four vertical columns that contain the home keys, one column for each finger of the non-mouse hand, and in exactly the same spacial pattern as their assigned keys in the transformed keysets. The usual prior art means of moving the mouse and clicking on icons in the palette could still be used to select tools, methods or operations at any time. A CAD program could use the methods of the present invention for selecting functions from some of the on-screen palettes, together with prior art mousing and clicking and/or non-palette referenced keystroke selection of functions and tools, in any combination. One combination would be, for example, the selection of a tool via a prior art method, and the act of selection automatically transforming a keyset to match a methods/operations palette for selecting a method via a transformed key. Another combination would be the inverse, i.e., the selection of a tool via a transformed keyset, and then the selection of a method by using the mouse and clicking.

Using most prior art CAD tool selection methods is analogous to a surgeon having to reach away from his patient and over to the instrument tray himself, and then bring the instrument back into the operating area. Using the method of the present invention to select tools in CAD and similar applications is like being a surgeon who has an assistant by his/her side placing tools: scalpel, clamp, rectangle, circle etc. into his hands when needed, without the surgeon having to remove his hands from the area of operation.

A list summarizing the method of the present invention for CAD use:
1. Sensor means detects position of hands with respect to keyboard and/or pointing device.
2. Processed output of sensor means activates either:
   a) native state N (alphanumeric) or default functions, or
   b) transformed state T, M or Z which transforms the functions of a set of keyboard keys to T, M or Z set of alternative functions.
   c) state −K which can be used to transform mouse motion, buttons and scroll wheel functions.
3. While in transformed state T, M or Z, a ST (Shift Transform) key can be pressed to substitute an embedded/shifted/uppercase set of transformed functions, thereby transforming keyset T to T+, M to M+, or Z to Z+.
4. While in any transformed state, an ORT (OverRide Transformation) key can be pressed to temporarily revert to the non-transformed state (N or D, with native or default functions), irrespective of the current hand positions.
5. Optional on-screen palette(s) whose layout is generally the same as the layout of the transformed keyset with icons for key functions displayed in the same pattern as the pattern of functions assigned to the keys, can be used to guide the fingers to select desired functions or tools via eye-to-hand pattern transfer, without needing to look at the keyboard or to use the mouse.
6. In using the method of the present invention in CAD applications, the selection of a tool can automatically activate a different type of keyset function transformation, one that is not dependent on hand position: Methods and Operations Mode, which activates a Methods/Operations palette and transforms keyset functions into methods and/or operations available for use with the selected tool, with either the default or the last method used with that tool automatically selected. The methods/operations palette(s) includes means for toggling back to to hand position responsive states to make the tool palette(s) active again, which can be either the pressing of the key for the presently selected method, or pressing an exit toggle key dedicated to activating a palette for tool selection (Tool Selection Mode). Toggling into Methods/Operations Mode from Tool Selection Mode without changing the selected tool could be done simply by selecting the currently selected tool again.

A list summarizing the purposes that on-screen palettes can serve:
1. As a general indicator that transformation is presently in effect.
2. As a specific indicator of which type of keyset (M, T, Z) is active.
3. As an even more specific indicator of which subkeyset (Mg1, Ma1, Ma2, etc.) is active.
4. As a visual reference to the location of each transformed function, enabling eye-to-hand m pattern transfer.
5. While the ST key is depressed, to highlight embedded functions made active.
6. While the ORT key is depressed, to show which keys are reverted to native.
7. To display function labels for keys transformed into toggle keys which can be set to toggle between different subkeysets (e.g., Mg1 and Mg2) and different functions (e.g., move insertion point marker or page up/dn, previous window/next window), where the labels can automatically change to reflect current status of the toggle.
8. For programming keysets (see FIG. 47).
9. As confirmation of a keyboard key pressed and its function, by highlighting its palette label.
10. To select tools and/or methods and/or operations from a tool bar/palette without moving the mouse.

Embodiments could include the ability to print out hard copy of the palettes. In embodiments where only a single keyset is available, on-screen palettes are completely unnecessary, although still helpful for programming. For transformation indication, a Led could light and/or a cursor could become modified. A small palette reference card could be printed and situated near the monitor screen for visual reminder of the action and location of the transformed functions.

Keypress Code Routing and Code Transformation

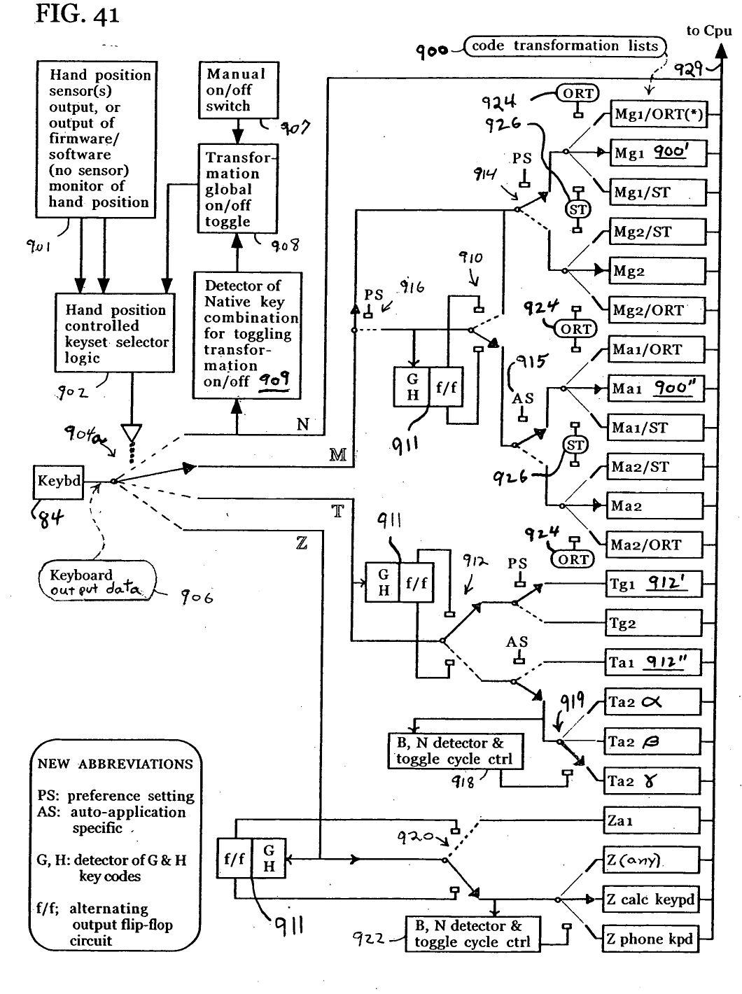

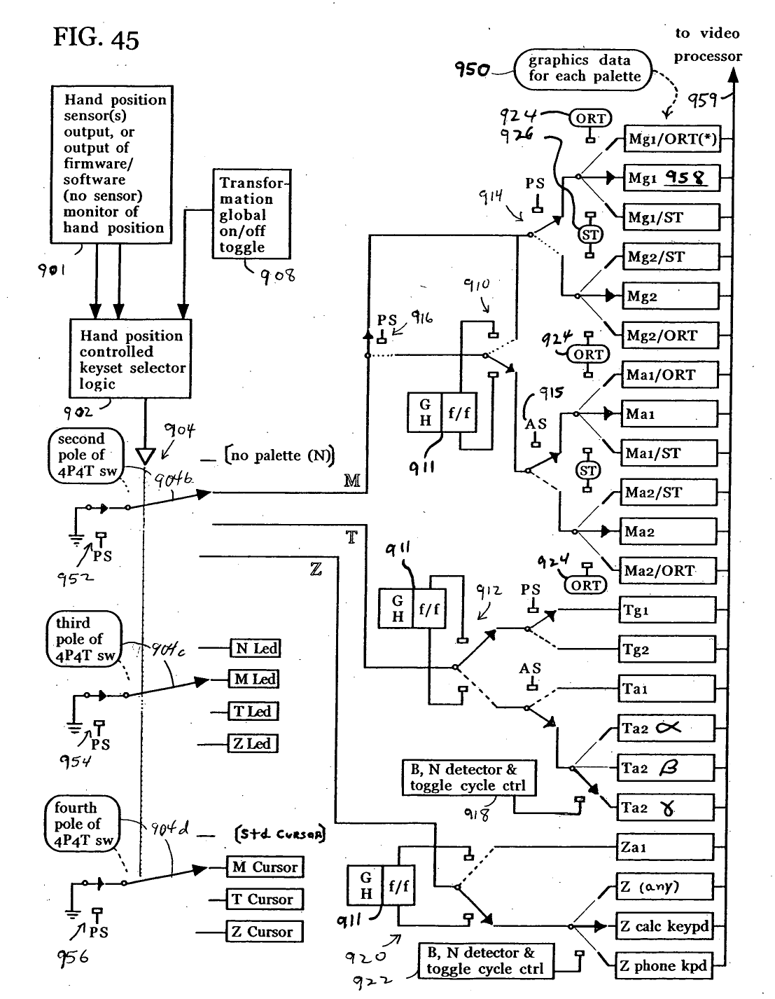

FIG. 41 is a detailed keyboard output code signal routing diagram. It illustrates an example of one method by which transformed keysets can be chosen and implemented. The labeled names of “code transformation lists” 900 on the far right-hand side of this diagram correspond to the labels of transformed keysets in on-screen palettes, for example, the code transformation lists for Mg1, 900′, and Ma1, 900″, correspond to palette names and toggle key labels Mg1 (632) Ma1 (632′) of palettes 630 and 640 of FIGS. 34A and 34B. The hand position controlled keyset selector logic 902 receives the outputs from hand position sensors 901, and controls four position switch 904. Switch 904 is a four pole four position switch, and only its first pole 904a shown here; its other three poles are shown in FIG. 45. (Note that whenever the word or symbol for “switch” is used in FIGS. 41 and 45 and in their description, it is being used figuratively, not literally, since it generally depicts logic and signal flow that will be implemented by firmware or software, rather than a discrete hardware switch). All of the other switches shown in FIG. 41 (i.e. except for 904, 907 and 908) are two-pole switches, with only the first pole of each shown in FIG. 41 and the second pole shown in FIG. 45. Switch 904a selects which type of code transformation list 900: N (none/Native), M, T or Z that the “keyboard output data” 906 is routed to, and thereby the function that particular keypress is transformed into. Input to logic 902 from “Transformation global on/off toggle” 908 either enables transformation, or disables all transformation by causing switch 904 to remain in the N (Native) position. Detector 909 which detects the native key macro for toggling transformation on/off, together with 908 corresponds to “Native keyboard macro” in section 6 of FIG. 46 and section 1 of the list “Setup and Preferences via Hardware”. Referring back to FIG. 41, manual on/off switch 907 can also be used to override all transformation via 908 and 902. The descriptive label “keyboard output data” (906) is used in the general sense; it can mean an output from the keyboard key matrix, an output from a point somewhere within the keyboard or keyboard processor, or the output from the overall keyboard unit. The code transformation lists 900 are essentially look-up/translation tables that implement the actual transformation of each key. Usually not all of the keys of the keyboard are included in transformed keysets, and therefore the signal processing is done in such a manner that the code transformation lists allow these other keys to retain their normal functions. The G,H flip-flop toggle switches 910 and 912 are transformed keys at the location of native g and h, (with 911 being a keypress code detector for g and h for actuating the alternating output flip-flop “f/f” circuit) and can be used to toggle or cycle between different subsets of the same type of transformed keyset; for example using 910 to toggle between Mg1 code list 900′ and Ma1 code list 900′. Toggle switch 912 can be used to toggle between Tg1 912′ and Ta1 912′ (See labels on code transformation lists 900: g=general use, Mg1 or Mg2 as preset by a preference setting via Preference Switch “PS” 914; a=application specific, Ma1 or Ma2, etc. chosen automatically via Application specific Switch “AS” 915 linked to application currently in use.) PS 916 is a bypass switch, shown here in the bypass position. Its purpose is to bypass the use of the G,H flip-flop for M keysets 910 when only one M keyset is needed and it is desired to use G and H for other functions (as, for example, in all other palette figures of this document besides FIGS. 34A and 34B). The B,N detector and toggle cycle control 918 detects the keypress codes for b and n can use them via switch 919 to toggle/cycle through three different subsets of, for example keyset Ta2 for a drawing application, Ta2 alpha, beta, or gamma. In FIG. 41, the “ORT” 924 and “ST” 926 switches activate the ORT and ST versions, respectively, of the code transformation lists 900, as is further detailed in FIG. 42A. ORT effectively momentarily overrides transformation for all or for only specific keys of the transformed keyset, and ST momentarily enables the functions of an embedded level of the transformed keyset. The switch settings/configurations shown in FIG. 41 demonstrate keyboard code data being routed to code transformation list Mg1 (900′), resulting in transformed code data being sent (929) to the computer, thus effectively providing transformed keyset Mg1 (e.g. palette 632 of FIG. 34A).

FIG. 42A is an example of a keyboard code transformation list for the keyset represented by the palette 582 of FIG. 33B. It details the function and use of these lists, including one possible means for producing the actions of the ST and ORT keys. The first column 931 shows a code transformation list for the transformed keyset/palette of FIG. 33B (left out of this list are Quit, and apostrophe/quotes). The second column 932 shows the list that a portion of the first list changes into in response to the ST key being held down, thereby enabling the embedded transformed functions of FIG. 33B (shown as the upper function labels in FIG. 33B). The third column 933 depicts the list that a portion of the first list changes into as a result of the ORT* key being held down (selectively reverting particular keys back to native functions plus automatically adding a * modifier command to each). (Left out of this list is the reversion of Backspace back to Tab, which could also be included in the action of the ORT* key.) Overriding transformation for all keys, even when also adding a modifier, could be accomplished by simply bypassing the code transformation list, but where transformation is to be overridden for only some transformed keys, leaving the others transformed, a new list such as in the third column (or an analogous equivalent, since there are a multitude of ways to intercept and reroute codes) may be necessary.

FIG. 42B is a schematic diagram which is an example of means of implementation of transformation list toggle detection 934 of FIG. 42A. This toggle is the “Toggle arrow keys” (insertion point to page-up/down window-previous/next) toggle key 592, first depicted in the keyset of FIG. 33B in the keyboard position of the native number “4”. FIG. 42B illustrates a means by which this toggle can choose one of two basic functions for the arrow keys. Here the arrow keys are located in the positions of native 3, w, e and r, and the output of four different keypress detectors 935 for detecting the code of these keys each goes to its own pole of four pole double throw switch 936 (only one pole actually illustrated here), which routes the codes to be transformed into the codes for either page movements 938 (page up, page down, previous window or Home, next window or End) or insertion point (or selected object) movements 939. Insertion point marker movements 939 are shown chosen here. The position of switch 936 is determined by a control input from flip-flop circuit 937, driven in turn by reception of keypress code for the native character 4 by detector 934. The action of this toggle is demonstrated by comparing FIGS. 34A and 34B.

FIGS. 43, 44A and 44B illustrate examples of a method using a transformation list to implement the mouse/pointing device clutch 782 of FIG. 38B (in the position of the native Tab key), and sensitivity control “Toggle mouse speed” 784 of FIG. 38B (in the position of native Caps Lock). FIG. 43 illustrates a pointing device clutch (shown here in the normally engaged position) where during keyset transformation a detection 940 of the key code for Tab by a microprocessor causes a momentary (for as long as the Tab is key is held down) disabling (942) of the pointing device, or interruption 942′ (by opening of normally closed single throw switch 942″) of the flow of xy position/motion or of all data 941 from the pointing device to the computer 943. The action of “momentarily disables pointing device” 942 can occur by sending a signal to the computer instructing it to temporarily ignore inputs from the pointing device. This pointing device clutch permits repositioning certain types of pointing devices without moving the screen cursor in order to establish a new relationship between the position of the pointing device and the position of the cursor on the screen. The clutch eliminates ever having to lift a mouse off of the desk, and is particularly valuable for certain kinds of high resolution drawing work when using a slowed-down pointing device (see FIGS. 44A and B), especially when in absolute mode. It can also be helpful to use the clutch to reposition a pointing device when returning the pointing device to normal operation after having linked pointing device motion to scrolling (as when after using a prior art “scroll with mouse” mode). For general use of the mouse clutch feature, the clutch could also (or instead of using a keyboard key or macro) be momentarily disengaged by holding down a mouse button.

FIG. 44A is a transformed keyset speed/sensitivity control for pointing devices, showing an example of how when a microprocessor detects 944, the key code for the Caps Lock, it causes the xy position/motion data 941′ from the pointing device to be momentarily (for as long as Caps Lock is held) rerouted by means of double throw (figurative) switch 945 through pulse divider or code converter or attenuator 946, which slows the pointing device, i.e. reduces the distance traveled by the cursor on the screen per unit distance traveled by the pointing device, for detailed high-resolution or pixel-by-pixel work. FIG. 44B illustrates the same pointing device speed control, but instead of being momentary, it consists of toggle switch 948, shown here in slow position/mode, controlled by an alternate action flip-flop circuit 947 which is triggered by detection 944 of the key code for Caps Lock. FIGS. 43, 44A and 44B are conceptual flow diagrams rather than literal schematics, i.e. the clutch and/or speed control, though triggered in the manner shown, could be actually be implemented by (driver) software installed on the computer.

FIG. 45 shows a possible means of implementing the automatic selection of transformation indicators which determines which palette is displayed on the computer screen at any one time. An additional optional feature could be that when a key shown within the displayed palette is depressed, its square within the palette can become highlighted. This figure parallels the logic flow of FIG. 41. FIG. 45 shows the other three poles of switch 904 of FIG. 41: 904b, 904c, and 904d, as well as the second pole of all of the other switches introduced in FIG. 41. Programming of the palettes (via “graphics data for each palette” 950) would automatically occur in parallel to any programming of keysets. New switches added in FIG. 45 are preference settings “PS” 952 to enable or disable display of on-screen palettes, PS 954 to enable or disable Led lamps for indicating keyboard transformation status (N, M, T or Z), and PS 956 to enable or disable special on-screen cursors (see FIG. 26A) for indicating transformation and transformation keyset type. Although FIG. 45 illustrates enabling the above three indicator features by pulling logic high conductors to ground (this is by way of example only, as there are a myriad of ways in which this could be accomplished). In FIG. 45 the palette for keyset Mg1, the M Led and the M cursor are all shown as enabled, paralleling the key code routing shown in FIG. 41, with the appropriate data for the selected palette being sent from 958 out (959) to the computer.

FIG. 46 shows the contents of a computer screen window 970, which includes a list and sequence for setup and preferences via software. The choice of “L or R hand mouse user” (FIG. 46, section 3, also via the “Mouse hand L/R” toggle switch listed in section 1. of the list “Setup and Preferences via Hardware” of this specification and shown in many of the figures which depict embodiments of this invention) reverses “L” and “R” in the truth tables of FIGS. 1C, 9A-E, 13A-E, 18E and 19K, and also designates which is the mouse side of the keyboard for the non-sensor software/firmware monitoring/detection of hand location of FIGS. 25A and 25B. The “Z multimedia, calculator, and telephone keypad” could either be selected here, or via a B,N toggle such as switch 922 described in FIGS. 41 and 45. Some of the preference choices could be also or instead be incorporated into a pull-down menu for fast and convenient access. In section 7. of FIG. 46, “Transformation Modifiers”, the same key could be specified to activate more than one function, e.g., both ST and ORT* simultaneously, and the “other” box is meant to include the option of assigning ST, ORT, and/or ORT* to any of the mouse buttons on the pointing device. The “factory programmed keysets” mentioned in the last line #8) of FIG. 46 could also include factory programmed on-screen palettes. These factory programmed keysets and palettes would be a locked set of “code transformation lists” (FIG. 41, 900) and of “graphics data for each palette” (FIG. 45, 950), always available for reverting to or copying from as a foundation for reprogramming to create new keysets (see FIG. 46 section 8 “change to factory programmed keysets”; “Preferences Setup Via Hardware” of this specification section 1 “Factory keysets on/off”; FIG. 47 “copy factory keyset” and sections 2 and 3 of description “Programming using software and on-screen palettes” of FIG. 47) in this specification. In FIG. 46 section 7 “Transformation Modifiers”, “Space” means the Space key, “c thumb” means central extra thumb key (e.g. 132 in FIG. 3A) and “o-c thumb” means off-center extra thumb key (such as 134L and 134R in FIG. 3A).

Setup and Preferences via Hardware

The following is a list of manual switches that can be used for setting up preferences via hardware. The keyset labels Mg1, Tg1, etc. refer to the labels of the same names in FIGS. 41 and 45.

1. Toggle switches with tactile, visual or led indication of status:
Transformation global on/off
Mouse hand L/R,
On-screen palettes on/off
Factory keysets on/off

2. Momentary pushbuttons:
Rebalance ambient sensors
Program keyset/palette

3. Dip switches (on or off)

| | |
|---|---|
| Non-sensor monitor/detector | excludes sensors, provides M |
| Mouse sensor | provides M only |
| Keyboard sensors | provides M & Z both on |
| | provides keysets M, T & Z |
| App. Specific (AS) bypass | |
| Mg1 (general use) | choose one Mg only |
| Mg2 (edit) | |
| Mg3 (surf) | |
| Tg1 | choose one Tg only |
| Tg2 | |
| Keyset Z | |
| Z multimedia controller | choose one Z only |
| Z calculator keypad | |
| Z telephone keypad | |
| Special indicator Cursors | |
| Indicator Leds | |
| Indicator Sounds | |
| Yes or No: | |
| Transform *key | |
| Transform Space key | |
| assign ST or ORT to: | |
| Left mouse button | |
| Center mouse button | |
| Right mouse button | |
| Transformed *key | |
| Transformed Space key | |
| Central extra thumb key | |
| Off-center extra thumb key | |
| Yes or No: | |
| Add* to c. extra thumb key | |
| Add * to o-c. extra thumb key | |

Programming Using Software and On-Screen Palettes

FIG. 47 displays a programming window 980 for programming transformed keysets by using a keyboard to enter the desired functions into the window's left and right palettes 982 and 982′. The programming sequence using FIG. 47 could be:

1. Transformation global on/off switch on; all hand location sensors off.

2. Press program key/macro/switch 3× in a row; this causes blank (except for small native key labels in lower left corner of each square) L and R 4 row×5 column palettes and a list of keyset names to be displayed in a screen window:

3. Click box (from group 981) in window 980 that is labeled with the name of the desired keyset; this links it with sensor logic, routing flow, code transformation list (FIG. 41) and palette information list (FIG. 45) for that type of set. If this palette had been programmed previously, the palette(s) 982 now fills up with the previous programming. If it is desired to begin programming with the (locked) factory programmed keyset of the same name as the checked box, then click “Copy factory keyset” button 983; this fills palette with the factory program. If keyset name checked is an “a” type, a dialog box 984 opens to allow selection of desired application for automatic linking. If a selective rather than the default global overriding of transformation is wanted when ORT or ORT* key is pressed during usage, one can program a special code list and palette for “with ORT or ORT* pressed” for that keyset by clicking in the “prog. for selective ORT” (or ORT*) box 986.

4. Press program key.

5. Press key on keyboard to be programmed or reprogrammed (or click in palette square representing key to be programmed). To program at the embedded level, i.e. requiring the ST key to activate later, press and hold the shift key while depressing key to be programmed (or shift-click if clicking in palette square). The square becomes empty of any previous programming, and becomes highlighted (if shift-click was used, only the upper one-half of the square empties and highlights).

6. Type desired transformed action for that key (can be a sequence of keys, or macro).

7. Press program key again. Highlight disappears, and typed action appears in the square.

8. Repeat steps 4-7 for another square. When keyset is completely programmed as desired, click “Programming completed” box 988.

9. At a later time, if it is desired to change programming of this keyset, press program key 3×, click name of keyset to be reprogrammed (palette reappears as previously programmed), unclick the “Programming complete” box, and go to step 4, etc. (One can always shift-click in a box already programmed at the surface level to add an embedded action, or click in a box previously programmed at the embedded level to add a surface action to that same key, without one interfering with the other, irrespective of sequence.)

Programming Without On-Screen Palettes

An example of a sequence for programming transformed keysets without using on-screen software is:

1. Transformation on, all sensors off.

2. Set dip switch to keyset desired to program or reprogram.

3. If it is desired to begin programming with the locked factory keyset of the same name as the dip switch setting, press program button, then toggle the “Factory keysets” switch on, and then press program button again. This puts a copy of the factory keyset into the palette to be user programmed. Toggle the “Factory keysets” switch off.

4. Press program button; all leds light.

5. Press key (or shift+key, as above) to be programmed; leds flash slowly.

6. Press desired action (can be a sequence of keys, or macro).

7. Press program button; leds go off.

8. Repeat cycle (4-7) for each key it is desired to program.

9. To reprogram, go back to step 4.

The present invention may employ any combination of the features and procedures, hardware, firmware and software settings and programming as described above. An option that could be added to “Setup and preferences via hardware” section 3. is a choice of palette type: rectilinear to match the most highly ergonomic keyboards), or asymmetrically offset/staggered as in FIGS. 28A, 35 and 36 (to match the traditional keyboard). Other means of programming include dragging icons from an icon file into the boxes/compartments of a palette template for a particular keyset or transformation state, and typing labels and commands right into the boxes, with the function assigned to each box being automatically simultaneously assigned to the corresponding keyboard key. Alternatively, any conventional macro programming method may be used, such as programming on the keyboard itself, without involving the computer's operating system.

### COMPLETE EMBODIMENTS

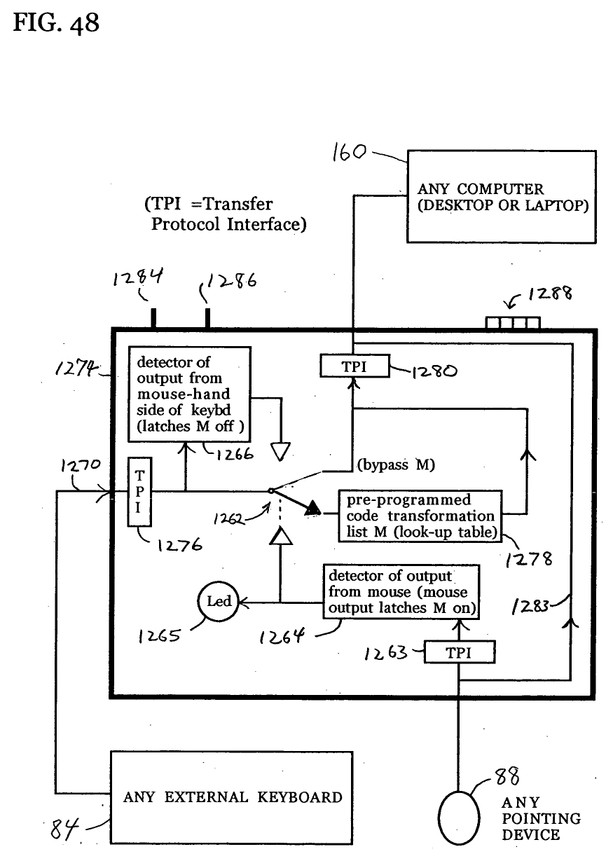

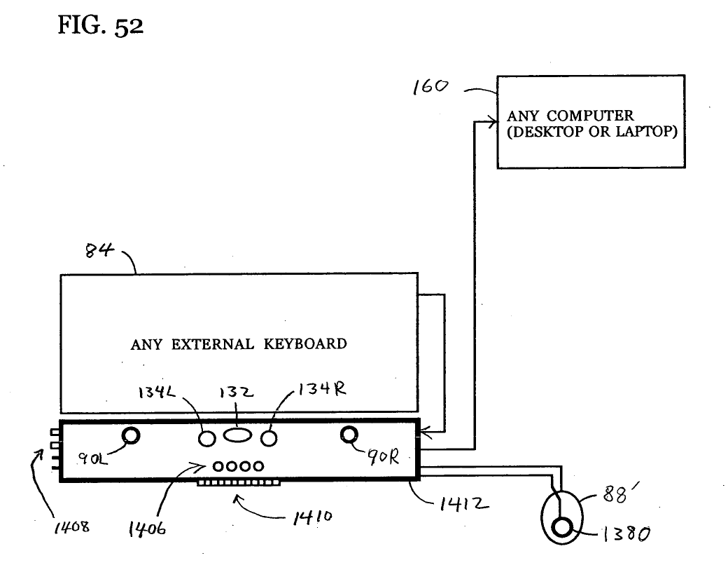

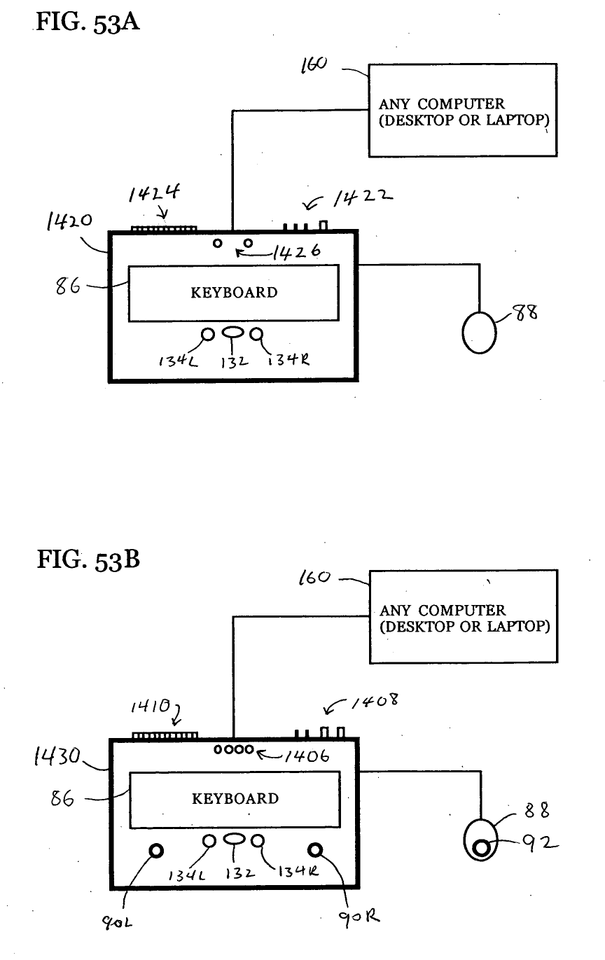

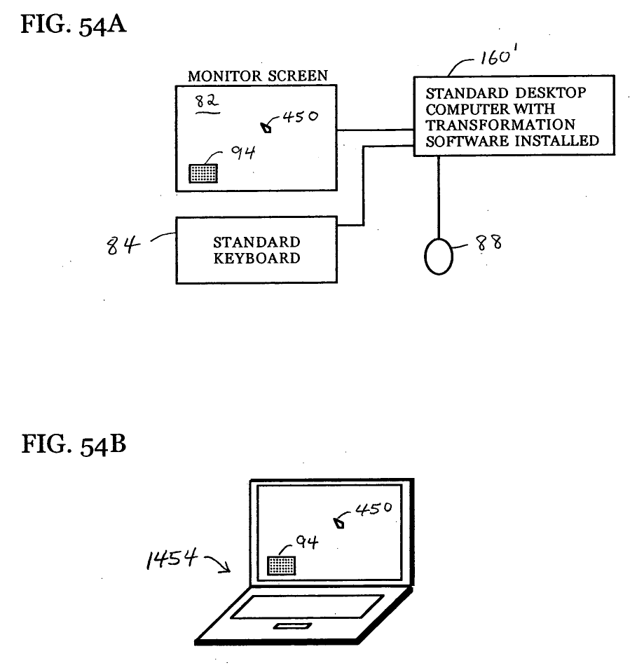

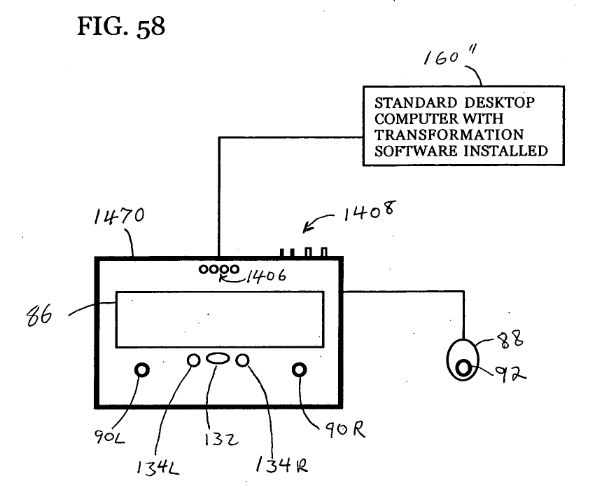

FIGS. 48 through 60. External switches and controls in these figures correspond to the “Manual Switches” of the list given above. All embodiments can include factory preprogrammed keysets, chosen via either “Factory keysets on/off” under “1. Toggle switches” of “Setup and Preferences via Hardware”, or incorporated into “dip switches” 288, 352, 424 shown in FIGS. 48, 49, 50A, 51 and 53, or via software as in FIGS. 46 and 47. The embodiment in FIG. 48 uses firmware detection of hand location, the embodiments in FIG. 54 use software detection of hand location, the embodiment of FIG. 24 uses a video camera plus firmware and/or software detection, and the other embodiments employ discrete sensor detection of hand location. With the possible exception of some sensor signal conditioning circuitry and logic, and microprocessors used to convert hand position sensor signals to code, the functions of the embodiments shown in FIGS. 48 through 53 can be implemented by firmware in a microprocessor located as either (1) a dedicated microprocessor in an external junction box 274, 304, 330 (embodiments in FIGS. 48, 49, 50 and 51), (2) a dedicated microprocessor in a wrist-rest box 412 (embodiment in FIG. 52), or (3) a dedicated microprocessor or the keyboard microprocessor in an special external keyboard 420, 430 (embodiment in FIG. 53). Most of the functions of the embodiments shown in FIGS. 54 through 60 are to be carried out by software installed onto a standard computer (desktop or laptop). All features of all embodiments can be combined in any way. Firmware inside an embodiment could transmit a signal to the computer to indicate which keyset is active, so that the appropriate on-screen palette or indicator cursor, the graphics data for which is stored in software in the computer, becomes displayed on the computer screen. While programming new keysets in firmware, data could be sent to the computer to program palettes in simultaneously. Conversely, palettes could be programmed in the computer, and then the new data sent to the firmware portion of the embodiment to program the keysets (code transformation lists) residing there. Any programmer skilled in the art can write software and firmware for implementing this invention by following the diagrams of this patent application, particularly in FIGS. 1, 8, 13, 14, 1, 1, 25, 41 through 47, and 51. The first preferred embodiment is shown in FIG. 53B, and the second preferred embodiment is shown in FIG. 58.

### EMBODIMENT 1

FIG. 48: is a junction box embodiment with firmware detection of hand location (no external sensor), and with a choice of preprogrammed transformed keysets. Refer to FIGS. 25A, B and C and their description for an introduction to the non-sensor hand location detection of this invention. “TPI” (1280) stands for any standard Transfer Protocol Interface, such as USB. Mouse detector 1264 latches M on when it detects an output from the mouse. Switch 1262 enables transformed keyset M when hand first moves or clicks pointing device 88 (via TPI 1263, and detector 1264 which also illuminates transformation indicator Led 1265), and becomes disabled upon detection of the next output from the mouse hand side of the keyboard via TPI 1276 and keyboard detector 1266. Detector 1266 detects the output from the mouse hand side of the keyboard, which causes it to latch M off. Key code output 1270 of “any external keyboard” 84 is fed into junction box 274 and then through input TPI 1276, and when keyset M is active, into preprogrammed code transformation list M (1278, which could be similar to, for example, 900′ of FIG. 41) where it is transformed, and then out via output TPI 1280 to “any computer” 160. When M is disabled, the key code bypasses list M, exits junction box 1274 via TPI 280 and arrives at the computer as if the keyboard had been connected directly to the computer. Conductor 1283 is a bypass that carries standard data output of the pointing device through to the output to computer, bypassing the electronics of junction box 1274. A dedicated microprocessor in junction box 1274 would generally be used carry out most of these operations. Toggle switch 1284 is used to tell the microprocessor whether the user is operating the pointing device with the left or right hand, i.e. which side of the keyboard is the mouse-hand side. External toggle switch 1286 corresponds to the “Manual on/off switch” 907 of FIG. 41. Dip switches 1288 correspond to the dip switches listed in “Setup and Preferences via Hardware” above.

Any of the input or output TPI's can include wireless transmission ability, such as IR, RF, “Bluetooth”, “Y-Fi”, etc. for use instead of hardwired connections. Possible locations for the junction box 1274 are: 1) as a very thin box underneath the keyboard; 2) as a box underneath or incorporated into a wrist wrest; or 3) as a separate box positioned anywhere between the keyboard and the computer.

### EMBODIMENT 2

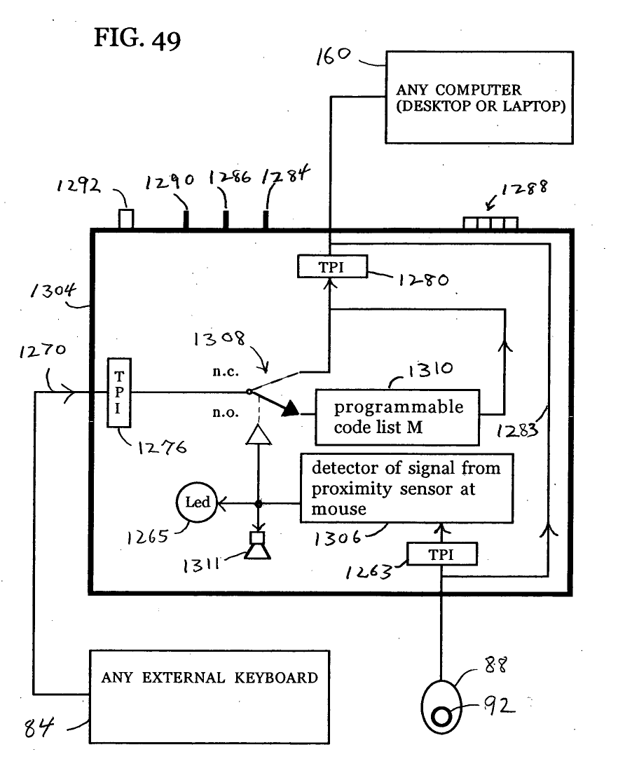

FIG. 49 is a junction box embodiment with discrete proximity sensor at mouse and programmable firmware. Switch 1308 enables transformed keyset M whenever a hand is at the pointing device (as in truth table of FIG. 9A). Hand presence at pointing device 88 is detected by discrete hand proximity sensor 92 which outputs a presence signal to microprocessor inside pointing device 88 which encodes presence signal and sends it as a code into junction box 1304 and then via input TPI 1263 to sensor presence signal code detector 1306. When detector 1306 detects hand presence signal coming from pointing device sensor it causes switch 1308 to route all signals from keyboard into “programmable code transformation list M (look-up table)” 1310. It simultaneously activates transformation indicator(s) Led 1265 and/or optional sound generator 1311. Key code output 1270 of “any external keyboard” 82 is fed into junction box 1304 and then through input TPI 1276 and, with switch 1308 in the transformation position, into list M 1310 where it is transformed, and then out via output TPI 1280 to “any computer” 160. When no hand presence signal is detected by detector 1306, 1306 causes switch 1308 to be in the bypass (n.c.), or disable transformation position, and this causes the key code to bypass list M (1310) and to go directly to output TPI 1280. Thus when switch 1308 is in bypass position, the key code arrives at the computer as if the keyboard had been connected directly to the computer. External toggle switches 1284 and 1286, and dip switches 1288 have the same functions as they did in Embodiment 1 of FIG. 48. External toggle switch 1290 is a “Factory keysets on/off” switch, and 1292 is a momentary “Program” button. A dedicated microprocessor inside junction box 1304 would generally be used to carry out most of these operations.

### EMBODIMENT 3

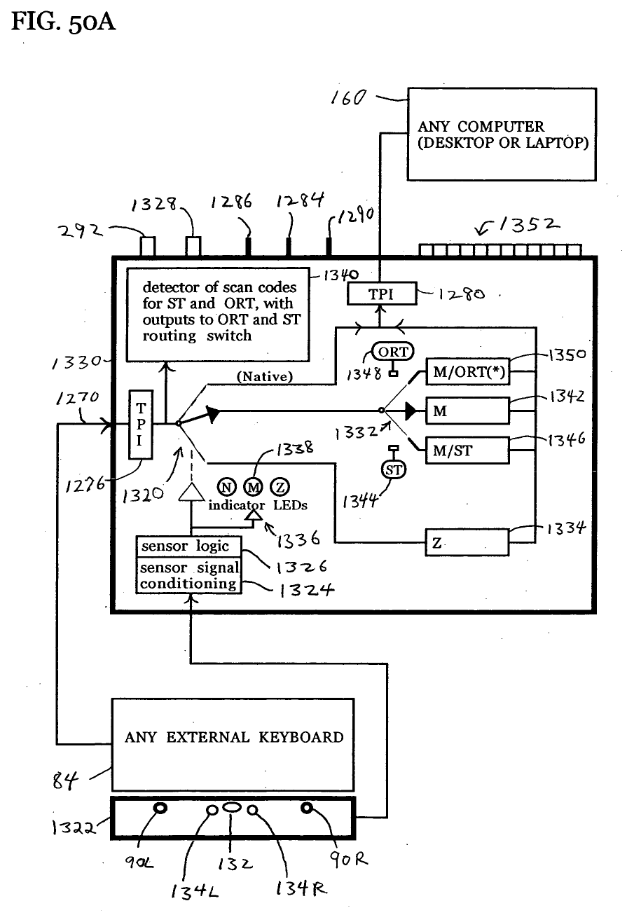

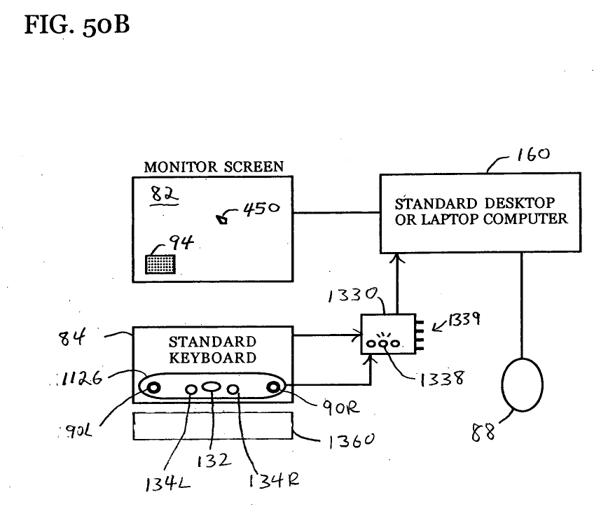

FIG. 50A is a junction box embodiment with L and R sensors added below a standard keyboard, with preprogrammed transformed keysets, and reprogrammable firmware. Transformed keyset M (1342) is enabled by switch 1320 when mouse hand departs keyboard typing position, and becomes disabled upon its return to typing position. Optional transformed keyset Z is enabled by switch 1320 when non-mouse hand departs typing position. Photosensors 90L and 90R for detecting presence of hands at left and right sides of keyboard 84 are mounted, together with extra thumb keys 132, 134L and 134R for ST, ORT, etc., in retrofit carrier strip 1322 (similar to 130 of FIGS. 3 and 5, or to wrist rest 140 or 144 of FIG. 4) or box below or attached to the keyboard. Photosensor signals are conditioned 1324 and processed by sensor logic 1326 as shown in FIGS. 9D (logic truth table), 10B and 13D and in their discussion, and are balanced by means shown in FIG. 11A or FIG. 11B, with external “rebalance sensors” control 1328 representing either potentiometer 264 of FIG. 14A or momentary switch 274 of FIG. 14B. (Control 1328 could either be mounted on the outside of junction box 1330 as shown in FIG. 50A, or, together with all or a portion of 1324 and 1326, it could be on/in carrier strip 1322).

Key code 1270 encoding key pressed on keyboard 84 enters junction box 1330 through input TPI 1276 and goes to switch 1320. Output of sensor logic 1326, which is determined by sensor status truth table of FIG. 9D, controls position of three-position switch 1320. Switch 1320 routes the key code to either the three-position M transformation switch 1332, to code transformation list Z 1334, or unchanged (“Native”) directly out to computer 160 via output TPI 1280. Output of sensor logic 1326 also controls three-position switch 1336 (1336 could be a second pole of switch 1320) which causes the indicator led 1338 corresponding to the active keyset to become illuminated. Where code 1270 outputs TPI 1276 to feed into switch 1320, it branches to also feed into detector 1340, which detects scan codes for ST and ORT. (ST and ORT can be assigned to the shift key, a modifier key, or to extra thumb keys.) If detector 1340 does not detect a code for either ORT or ST it does nothing, leaving M transformation switch 1332 in its central position, as shown in FIG. 50A, which routes the key code into code transformation list M 1342 for transformation into a function of set M. When a ST transformation modifier key (for example “*” the Macintosh Command key) is pressed, 1340 detects the code for ST and sends a signal (signal path not shown in FIG. 50A to avoid clutter) to the ST control 1344 of switch 1332, which causes 1332 to route the key code to code transformation list M/ST 1346. When an ORT transformation modifier key is pressed, 1340 detects the code for ORT and signals the ORT control 1348 of switch 1332 to route key codes to code transformation list M/ORT 1350. (When the ST and ORT keys used are the extra/added-on thumb keys 134L, 134R, and 132, their output can be routed around 1324/1326 and directly (not illustrated) to 1344 and 1348). External controls 1284, 1286, 1290 and 1292 are the same as in FIG. 49, and dip switches 1352 include many of the functions listed in “Setup and Preferences via Hardware”, section 3.

Instead of the individual left and right sensors 90L and 90R, a different version of embodiment 3 of FIG. 50A could use the single sensor pair configuration of FIG. 18, (component embodiments shown in FIGS. 20 and 21) resulting in keysets M and T instead of M and Z.

### EMBODIMENT 4

FIG. 50B is equivalent to the junction box embodiment of FIG. 50A except with sensors and optional extra thumb keys added to an external keyboard via an overlay strip. Junction box 1330 of FIG. 50A is shown connected to standard keyboard 84 with standard wrist rest 1360, and to standard computer 160 with mouse 88 and standard monitor with screen 82. On top of the keyboard and also connected to junction box 1330 is thin overlay strip 1126 containing sensors 90L and 90R, and extra thumb keys 132, 134L and 134R, as introduced in FIG. 3A. (Overlay strip 1126 could resemble strip 166 or 172 introduced in FIGS. 6 and 7.) FIG. 50B is configured to show transformed keyset M active (right hand absent from keyboard, left optionally present), with M indicator Led 1338 on junction box illuminated, and M indicator cursor arrow 450 (from FIG. 26A) and M keyset palette 94 displayed on screen 82. External switches 1339 on junction box 1330 are 1284, 1286, 290, 292 and 1328.

### EMBODIMENT 5

FIG. 51 is a junction box embodiment with L and R sensors added below a standard keyboard, with hand sensor at mouse, preprogrammed transformed keysets, and reprogrammable firmware. The junction box 1370 of FIG. 51 is similar to junction box 1330 of FIG. 50A except with the addition of a hand proximity sensor at the mouse, which makes possible activation of a transformed keyset T (via code transformation list 1372) in addition to M and Z. Operation is similar, except that the main key code routing switch is now the four position switch 1374, with (optionally as its second pole) led indicator switch 1374′ also being four position, and selecting one of the four indicator leds 1378.

The pointing device connected to junction box 1370 can either have a retrofit sensor 1380 (pointing device 88′) or a built-in sensor 92 (pointing device 88) with sensor signal encoded by the pointing device's microprocessor. The signal conductor from the retrofit sensor 1380 would input directly into sensor signal conditioning 1386, and the data line 1283 carrying standard motion and click information from pointing device 88 would connect directly into the output from the junction box to the computer, after output TPI 1280 (assuming the same data protocol for both keyboard and mouse, as with USB for example). When using built-in sensor 92, the sensor signal input is via TPI 1263 and an extra component (not shown) inside 1386 which detects and decodes the encoded proximity sensor signal.

The sensor logic 1388 truth table would resemble that of FIG. 1C and FIG. 9E, and the three-sensor logic implementation could be generally similar to that of 13E. Alternatively, if the pointing device's proximity sensor was of a type not needing an ambient light reference, the logic implementation would be slightly modified. Overall operation and use of the embodiment portrayed in FIG. 51 would be similar to that described in FIG. 1C and FIGS. 2A, B, C and D.

Instead of the individual left and right sensors 90L and 90R and a sensor at the mouse, a different version of embodiment 5 of FIG. 51 could use the dual sensor pair configuration of FIG. 19, (component embodiments shown in FIGS. 20 and 21) resulting in an additional Z keyset plus the extra functions XL, XR and XLR.

### EMBODIMENT 7

FIG. 52 is a top view of a wrist rest box embodiment incorporating any or all features of junction box embodiments of FIGS. 48, 49, 50 and 51, including transforming firmware and preprogrammed keysets. This embodiment has keyboard hand position sensors 90L and 90R, extra thumb keys 132, 134L and 134R, Led keyset transformation indicators 1406, external controls 1408, dip switches 1410, inputs from standard keyboard 84 and pointing device 88′, input for optional retrofitted pointing device hand proximity sensor 1380, output to computer 160, and the internal electronics to implement the features of junction box embodiments of FIGS. 48, 49 50 and 51, all incorporated into a wrist rest box 1412. This wrist rest box could have a soft and/or cushioned upper surface, and would resemble the simpler retrofit wrist rest portrayed in FIGS. 4A, B, C and D. Instead of pointing device 88 with retrofitted hand proximity sensor 1380, box 1412 could include electronics (as in description of 1386 in FIG. 51) that enables it to use the pointing device with built-in proximity sensor 92 of FIG. 51.

### EMBODIMENT 8

FIG. 53A is an external keyboard embodiment incorporating any or all features of junction box embodiment of FIG. 48, including firmware detection of hand location (no discrete hand position sensors), a choice of preprogrammed keysets, and adding optional reprogrammable firmware and extra thumb switches. External keyboard 1420 has no discrete sensors, has keyswitch matrix 86, extra thumb keys 132, 134L and 134R, external controls 1422 (L/R switch, transformation on/off switch, and program button), dip switches 1424, led status indicators 1426, and is connected to any standard pointing device 88 and any computer 160.

### THE FIRST PREFERRED EMBODIMENT

### EMBODIMENT 9

FIG. 53B shows the first preferred embodiment. It consists of an external keyboard that incorporates any or all features of junction box embodiments of FIGS. 48, 49, 50 and 51, including hand position sensors, choice of preprogrammed keysets, reprogrammability, extra thumb switches, and optionally with the addition of colored groups of keys (colored keycaps or backlit). External keyboard 1430 with built-in keyboard hand position sensors 90L and 90R, keyswitch matrix 86, optional extra thumb keys 132, 134L and 134R, led transformation indicators 1406, external controls 1408 (L/R switch, transformation on/off switch, program button, factory programmed keyset switch, and sensor adjust knob or rebalance command button), dip switches 1410, and connected to pointing device 88 with optional hand proximity sensor 92 (or 1380) and to any computer 160, and including internally all of the electronics necessary to carry out any or all of the functions of the embodiments described in FIGS. 48, 49, 50 and 51. This embodiment could be configured to use for non-sensor transformation using firmware hand position detection as in FIG. 53A, or as a three-sensor embodiment (providing keysets M, T and Z), a two-sensor embodiment (providing keysets M and Z), or using only a proximity sensor in the pointing device (M keyset only).

Transformation in the embodiments of FIG. 53A and 53B can be implemented by the keyboard processor itself, either via alternative matrix address to key code lists or via key code conversion lists. Implementation could also be via an extra microprocessor inside the keyboard and positioned after the usual/main keyboard processor, with this extra processor functioning similarly to the method illustrated in FIGS. 41, 43, 44, 50 and 51, routing key codes coming from the main keyboard processor through key code conversion lists. Another transformation implementation method could be via an array of solid state switches and logic interposed between the keyboard keyswitches and the keyboard microprocessor.

### EMBODIMENT 10

FIG. 54A is a software-only embodiment, without any discrete hand position sensor, with all features provided by software installed on any desktop computer. Software incorporating all software (non-discrete) sensor features of this invention installed on desktop computer 160′ as any combination of driver software, application software and operating system software. Software detects hand location by monitoring data output from pointing device and from mouse-hand side of keyboard (see FIGS. 25A, B and C). Monitor screen 82 shows the system in a transformed state, with palette 94 depicting transformed keyset for non-mouse hand, and transformation indicated by modified cursor 450. Specific guidelines for software design are found in FIGS. 25A and B, 41, 42A, 42B, 43, 45, 46 and 47.

### EMBODIMENT 11

FIG. 54B is a software-only embodiment, without any discrete hand position sensor, with all features provided by software installed on any laptop computer. Software incorporating all non-discrete sensor features of this invention is installed on any standard laptop computer 1454, as any combination of driver software, application software and operating system software. Specific guidelines for software design are found in FIGS. 25A and B, FIGS. 41, 42A, 42B, 43, FIGS. 45, 46, 47, and 48.

List of basic elements of software embodiment installed on standard computers of FIGS. 54A and 54B:

1. Hand position sensing based on monitoring of pointing device and keyboard activity, which activates transformation (FIG. 25).

2. Keypress code signal routing and code transformation lists (FIGS. 41 and 42).

3. Selection and programming of code transformation lists, with mirrored (simultaneous) programming of on-screen indicator palettes (FIGS. 46, 47 and 45).

4. Selection and display of on-screen indicators (FIGS. 46 and 45).

5. Menus, dialog boxes and/or windows for setup, preference selection and programming (FIGS. 46 and 47).

The software that embodies the present invention in FIGS. 54A and 54B can be any combination of driver software, application software and operating system software. The laptop of 54B can optionally be connected to an external keyboard and/or external pointing device.

### EMBODIMENT 12

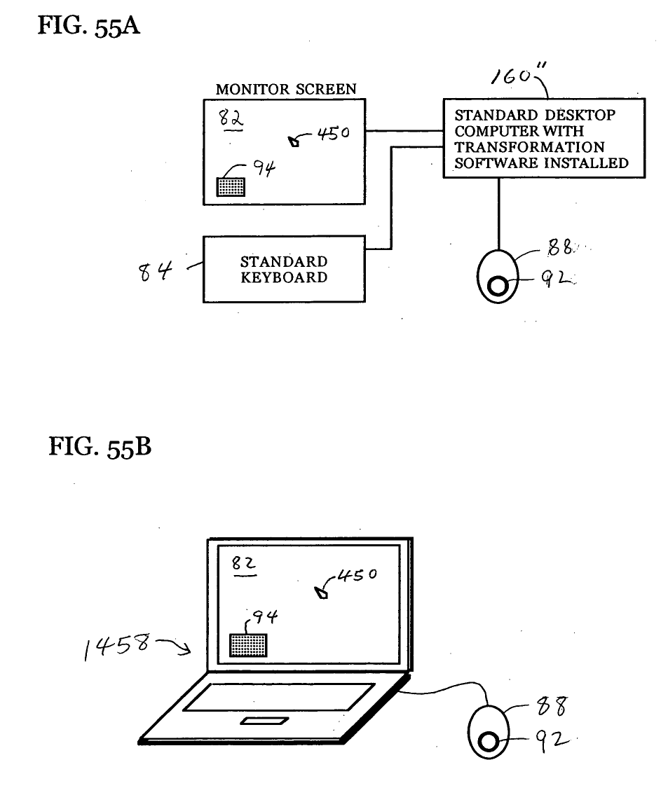

FIG. 55A is a desktop computer embodiment consisting of software, plus discrete sensor 92 at pointing device 88, software installed on any desktop computer 160″, and with the signal from sensor 92 incorporated into code sent from the pointing device's microprocessor to the computer.

### EMBODIMENT 13

FIG. 55B is a laptop computer embodiment consisting of software, plus discrete sensor 92 at pointing device 88, software installed on any laptop computer 1458, and with the signal from sensor 92 incorporated into code sent from the pointing device's microprocessor to the computer.

The embodiments of FIGS. 55A and B are capable of transforming into M keyset only, since they have a sensor only at the pointing device.

List of basic elements of software installed on standard computers of FIGS. 55A and 55B (the software being any combination of driver software, application software and operating system software):

1. Hand position sensing based on discrete sensor at pointing device (FIG. 9A), which activates transformation

2. Keypress code signal routing and code transformation lists (FIGS. 41 and 42).

3. Selection and programming of code transformation lists, with mirrored (simultaneous) programming of on-screen indicator palettes (FIGS. 46, 47 and 45).

4. Selection and display of on-screen indicators (FIGS. 46 and 45).

5. Menus, dialog boxes and/or windows for setup, preference selection and programming (FIGS. 46 and 47).

### EMBODIMENT 14

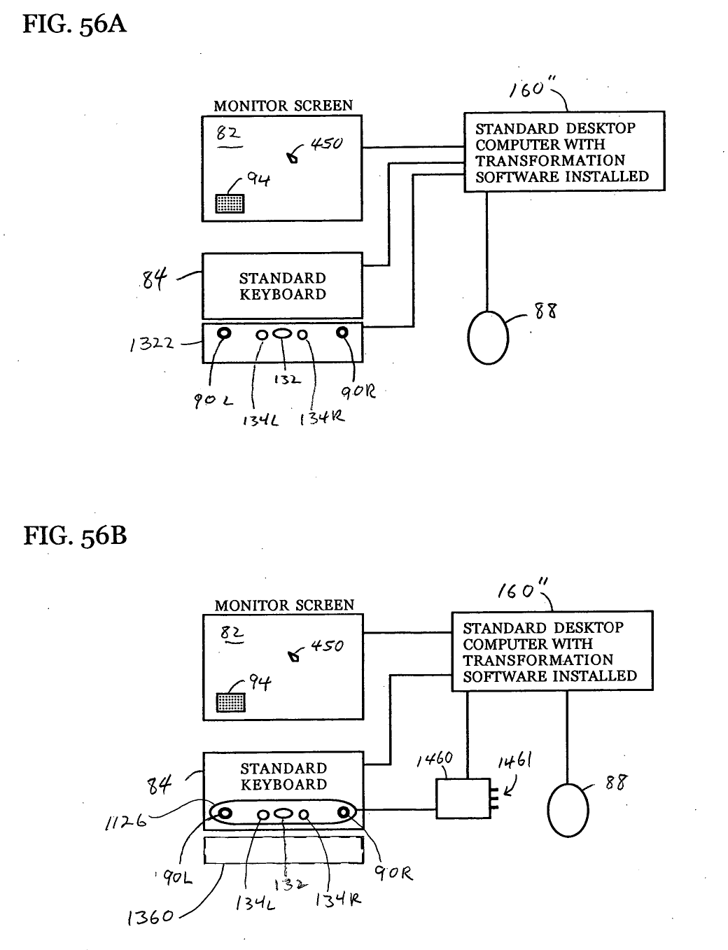

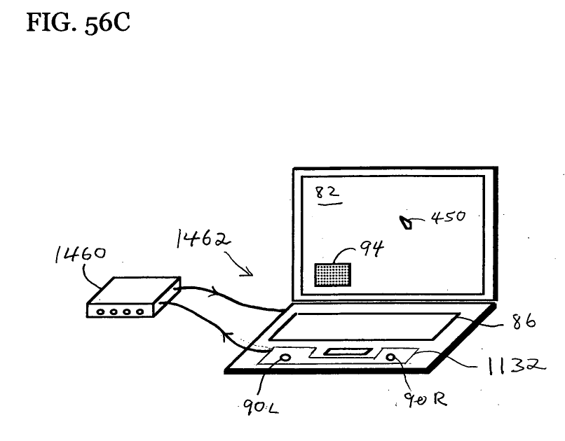

FIG. 56A is an embodiment consisting of software, plus discrete position sensors 90L and 90R in wrist-rest 1322 below standard external keyboard 84; software installed on any desktop computer 160″. Wrist-rest 1322 also contains sensor circuitry, sensor logic, optional extra thumb keys 134L, 134R and 132 (for ST, ORT or other functions), sensor signal and extra thumb key code generators, and TPI.

### EMBODIMENT 15

FIG. 56B is an embodiment consisting of software, plus discrete position sensors 90L and 90R retrofitted to standard external keyboard 84 by means of thin strip 1126 attached to top surface of the keyboard; software installed on any desktop computer 160″. Thin strip 1126 can also contain optional extra thumb switches 134L, 132, and 134R. Electrical output of thin strip 1126 is connected to separate junction box 1460, which is in turn connected to computer 160″. Junction box 1460 contains any necessary sensor circuitry, sensor logic and sensor signal and extra thumb key code generators with TPI, plus any necessary external controls 1461 for the sensors.

### EMBODIMENT 16

FIG. 56C is an embodiment consisting of software, plus discrete hand position sensors 90L and 90R retrofitted below keyboard key matrix 86 of standard laptop 1462 by means of thin strip 1132, and including junction box 1460 containing sensor circuitry, sensor logic, and sensor code generator with TPI; software installed on any laptop computer 1462. Sensor output is connected to junction box 1460 which processes and encodes the sensor signals and feeds them into the laptop through a standard TPI (such as USB for example).

The embodiments of FIGS. 56A, B and C are capable of transforming into M and Z keysets since they have sensors only at the keyboard.

List of basic elements of software installed on standard computers of FIGS. 56A, 56B and 56C (the software being any combination of driver software, application software and operating system software):

1. Hand position sensing based on discrete sensors at keyboard (FIG. 9D), which activates transformation.

2. Keypress code signal routing and code transformation lists (FIGS. 41 and 42).

3. Selection and programming of code transformation lists, with mirrored (simultaneous) programming of on-screen indicator palettes (FIGS. 46, 47 and 45).

4. Selection and display of on-screen indicators (FIGS. 46 and 45).

5. Menus, dialog boxes and/or windows for setup, preference selection and programming (FIGS. 46 and 47).

### EMBODIMENT 17

FIG. 57A is similar to FIG. 56A, except with the addition of a sensor at the mouse. This embodiment consists of software, sensor at mouse, plus discrete position sensors 90L and 90R and optional extra thumb keys 134L, 134R and 132 in wrist-rest 322 below standard external keyboard 84; software installed on any desktop computer 160″. Wrist-rest 1322 also contains sensor circuitry, sensor logic, sensor signal and extra thumb key code generators and TPI. The external pointing device consists of either (1) sensor 1380 retrofitted onto/into standard pointing device 88′, with extra conductor 1380′ carrying uncoded sensor signal into wrist-rest 1322, or (2) sensor 92 built into pointing device 88, with pointing device's microprocessor sending coded sensor signal directly into computer 456.

### EMBODIMENT 18

FIG. 57B is similar to FIG. 56B, except with the addition of sensor at mouse; embodiment consisting of software, sensor at mouse, plus discrete position sensors 90L and 90R retrofitted to standard external keyboard 84 by means of thin strip 1126 attached to top surface of the keyboard; software installed on any desktop computer 160″. Thin strip 1126 can also contain optional extra thumb switches 134L, 132, and 134R. Electrical output of thin strip 1126 is connected to separate junction box 1464, which is in turn connected to computer 160″. Junction box 1464 contains any necessary sensor circuitry, sensor logic and sensor signal code generator with TPI, plus any necessary external controls 1465 for the sensors. The external pointing device consists of either (1) sensor 1380 retrofitted onto/into standard pointing device 88′, with extra conductor 1380′ carrying uncoded sensor signal into junction box 1464, or (2) sensor 92 built into pointing device 88, with pointing device's microprocessor sending coded sensor signal directly into computer 160″.

### EMBODIMENT 19

FIG. 57C is similar to FIG. 56C, except with the addition of sensor at pointing device; embodiment consisting of software, sensors 1469L and 1469R at pointing device 1468 and/or sensor 92 at pointing device 88 or sensor 1380 at pointing device 88′, plus discrete hand position sensors 90L and 90R retrofitted below keyboard keyswitch matrix 86 of standard laptop 1462 by means of removable thin strip 166′, and including junction box 1466 containing sensor conditioning circuitry, sensor logic, and sensor signal and extra thumb key code generators with TPI, plus external controls 1467 for sensors (manual sensor sensitivity adjustments and/or rebalance command), optionally including Led sensor balance and transformation indicator(s), and sensor on/off switch(es); software installed on any laptop computer 1462. Thin strip 166′, which is held onto laptop by elastic strap 170, can also contain optional extra thumb switches 134L, 132, and 134R. Output of thin strip 166′ is connected to junction box 1466 which processes and encodes the sensor and extra thumb key signals and feeds them into the laptop through a standard TPI. Sensors 1469L and 1469R serve to detect presence or absence of hand at the built-in pointing device or trackpad 1468, with 1469L being employed when the left hand is used for the track pad, and 1469R when the right hand is used at the trackpad. An external pointing device with sensor can also be used, as either sensor 92 built into pointing device 88 with pointing device's microprocessor sending coded sensor signal directly into laptop, or sensor 1380 retrofitted onto/into standard pointing device 88′ with extra conductor 1380′ carrying uncoded sensor signal into junction box 1466.

The embodiments of FIGS. 57A, B and C are capable of transforming into M, T and Z keysets, since they have sensors at both keyboard and pointing device.

List of basic elements of software installed on standard computers of FIGS. 57A, 57B and 57C (the software being any combination of driver software, application software and operating system software):

1. Hand position sensing based on discrete sensors at keyboard and at pointing device (FIG. 9E), which activates transformation.

2. Keypress code signal routing and code transformation lists (FIGS. 41 and 42).

3. Selection and programming of code transformation lists, with mirrored (simultaneous) programming of on-screen indicator palettes (FIGS. 46, 47 and 45).

4. Selection and display of on-screen indicators (FIGS. 46 and 45).

5. Menus, dialog boxes and/or windows for setup, preference selection and programming (FIGS. 46 and 47).

### THE SECOND PREFERRED EMBODIMENT

### EMBODIMENT 20

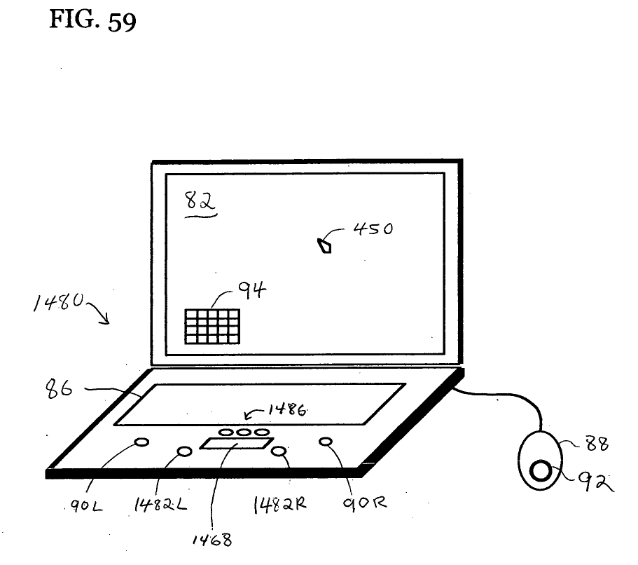

FIG. 58 shows the second preferred embodiment. It consists of software installed on standard desktop computer 160″, plus external keyboard 1470 with built-in sensors 90L and 90R, sensor circuitry, sensor logic, and firmware which sends sensor signal and extra thumb key signals to computer 160″as code (optionally via keyboard's microprocessor). Software in computer 160″carries out transformation. External pointing device 88 optionally includes sensor 92 (or retrofit sensor 1380 with conductor 1380′ as in FIGS. 57A, B and C). This keyboard could also have a built-in pointing device plus additional hand position sensor(s) for detecting the presence of a hand at the built-in pointing device (not illustrated here, see FIG. 59).

List of basic elements of software installed on standard computer of FIG. 58 (the software being any combination of driver software, application software and operating system software):

1. Hand position sensing based on discrete sensors at keyboard and/or pointing device (FIG. 9E), which activates transformation.

2. Keypress code signal routing and code transformation lists (FIGS. 41 and 42).

3. Selection and programming of code transformation lists, with mirrored (simultaneous) programming of on-screen indicator palettes (FIGS. 46, 47 and 45).

4. Selection and display of on-screen indicators (FIGS. 46 and 45).

5. Menus, dialog boxes and/or windows for setup, preference selection and programming (FIGS. 46 and 47).

### EMBODIMENT 21

FIG. 59 is a laptop embodiment as a specially constructed laptop 1480 with built-in sensors and extra thumb keys, sensor conditioning circuitry if necessary, and any combination of hardware, firmware and software to implement transformation, on-screen display of transformed keyset palette and transformation-indicating cursors, and simultaneous programming of keysets and palettes. Built-in sensors 90L and 90R detect hand presence or absence from typing position at keyboard, 1482L and 1482R detect hand presence or absence from built-in pointing device 1468, and 1486 are built-in extra thumb keys. External pointing device 88 is optional, and is shown carrying optional proximity sensor 92 with sensor signal incorporated into scan code sent from pointing device's microprocessor to the laptop computer.

List of basic elements of software installed on laptop computer of FIG. 59 (the software being any combination of driver software, application software and operating system software):

1. Hand position sensing based on discrete sensors at keyboard and/or at laptop's built-in pointing device or external pointing device (FIGS. 9A, 9D, 9E), which activates transformation.

2. Keypress code signal routing and code transformation lists (FIGS. 41 and 42).

3. Selection and programming of code transformation lists, with mirrored (simultaneous) programming of on-screen indicator palettes (FIGS. 46, 47 and 45).

4. Selection and display of on-screen indicators (FIGS. 46 and 45).

5. Menus, dialog boxes and/or windows for setup, preference selection and programming (FIGS. 46 and 47).

The single or dual sensor pair embodiments of FIGS. 18 through 21 can be used to substitute for the individual/single left and right sensors for any embodiments described as using the latter, including in FIGS. 50, 51, 52, 53, 56, 57, 58 and 59.

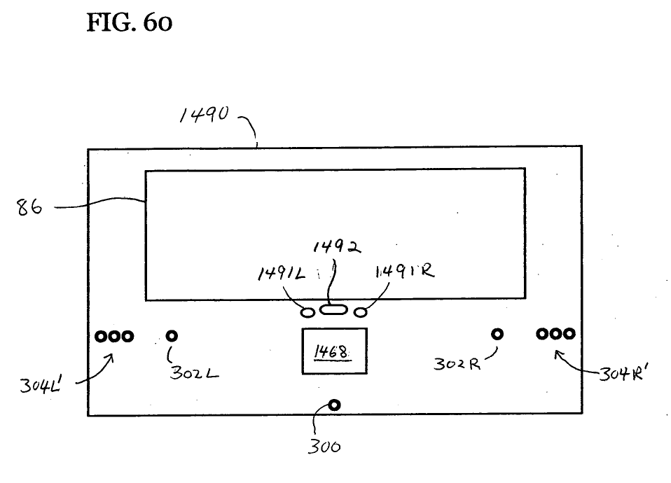

FIG. 60 illustrates the dual sensor pair built into a keyboard 1490, which represents both an external keyboard and the keyboard of a laptop computer. (Dual sensor pairs were previously introduced and discussed, see FIGS. 19A through 19K and 20C, with FIGS. 21B and C illustrating retrofit dual pairs with adjustable spacing). The outer sensors 304L′ and 304R′ can either be individual sensors, or can each consist of two or more phototransistors (three are depicted here, with their reference numbers taken from FIG. 21C), only one of which would be chosen to be active at any one time, to provide an adjustability of the spacing between inner 302L and 302R and outer sensors of each pair (similar to FIG. 21C). A central reference sensor 300, (from FIGS. 19 and 21) is optional, depending on sensor type and transformed keyset types desired. In the present invention in general, any sensor could be replaced by multiple sensors or an array of sensors, or any other means could be used to provide adjustability of sensor position.

Hand position detection can also be used to selectively enable (enable as used here does not mean trigger) particular keyboard keyswitch(es) designed for use at the keyboard when the mouse hand is absent from the keyboard or is present at the mouse, and disable the same keyswitch(es) when the mouse hand returns to the keyboard. Automatic hand and position responsive disabling of special keyboard switches while the mouse hand is in typing position at the keyboard might be useful in certain cases to prevent normal two-handed typing from inadvertently triggering them. Such automatic disabling could be used, for example, in the case of special light touch click buttons 1491L, 1491R and 1492 shown in FIG. 60 on keyboard 1490 which are designed for operation while the mouse hand is using the keyboard trackpad 1468 or is at the mouse, and might otherwise be accidentally actuated during two-handed typing.

### CONCLUSION, RAMIFICATIONS AND SCOPE

New Integration of Use of Keyboard and Pointing Device

The present invention integrates the operation of keyboard and mouse in new ways to provide additional functions for more efficient and ergonomic operation. It expands left and right hand coordination from integrated use at the keyboard alone (prior art), to provide more integrated use of left and right hands when one hand is at the pointing device and the other is at the keyboard. It accomplishes this basically in four different ways, discussed briefly below.

1) Hand location responsive transformation provides the hand remaining at the keyboard with many useful new functions while the mouse hand is at the mouse. This is especially beneficial when these new functions are those that work together synergistically with the mouse. Examples of these are the mouse-speed toggle, mouse clutch, scroll control and toggle auto-grid (snap to grid) of FIG. 39B, and of course the clicks actuated by transformed home keys which are included in many of the palettes shown in the figures.

2) Clicking with both hands, one at the keyboard and the other at the mouse. Using clicks provided by home keys does not preclude choosing sometimes to also click with buttons on the mouse as in prior art. Clicking with a home key is usually less stress-producing over the long term because it is a loose stroke that has the benefit of momentum and follow-through. The mouse button requires a more tightly controlled spasm. One could use both methods, alternately at will, with the left and right hands sharing the task of clicking, thus dividing the workload and providing variety to reduce long-term strain. One can also actuate a click at the mouse and either simultaneously or quickly afterwards (within the dwell time) a click at the keyboard (or visa versa) to actuate a “double-click”. This is a very fast and relaxed method of double-clicking, which is a very frequently used function.

3) Actuating a ST, ORT or OR7*function by pressing a mouse button provides new single-stroke functions for the non-mouse hand without the thumb of the non-mouse hand having to simultaneously hold down an ST modifier key. This is a very convenient method of actuating these transformation modifiers. (If clicking is done mainly with home keys transformed into clicks, this frees up mouse buttons to be reassigned to ST, etc.)

4) Transforming any or all mouse functions to alternative functions when no hand is at the keyboard (transformation state −K).

The present invention also integrates the transformation of on-screen palettes with the transformation of keysets in response to hand location. With simultaneous transformation of both a keyset and its corresponding palette, the palette always displays the new functions in the same geometric pattern as the actual layout of the new functions on the keyboard. This enables eye-to-hand pattern transfer for intuitive function selection via the keyboard without using the mouse. In addition to its benefit for general use, this provides a new method of selecting tools in CAD applications.

Hand Location, Sensors and Transformation States

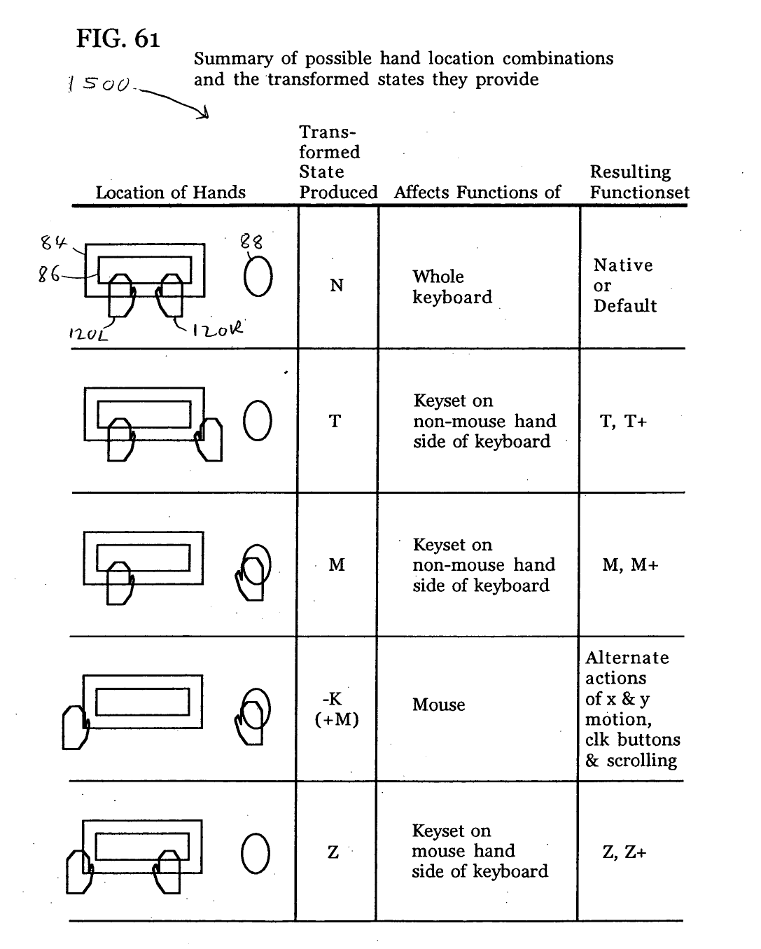

The hand location responsive transformation of the present invention provides up to three new powerful workhorse states for the keyboard, and one new state for the pointing device. Each of the new keyboard states can include either one or two or more keysets of alternative functions. FIG. 61 is a summary 1500 of possible hand location combinations and the transformed states they provide. Shown are keyboard 84, mouse 88, left hand 120L and right hand 120R. Discrete sensor means and combinations that detect the hand locations can be either:

1. imaging (see FIG. 24), which is capable of detecting all of the states shown;

2. proximity or contact sensor at mouse, plus left and right proximity sensors at keyboard, can detect all states;

3. proximity or contact sensor at mouse, plus three ambient photosensors (left and right and reference at keyboard) can detect all states;

4. proximity or contact sensor at mouse, plus two ambient photosensors (left and right) at keyboard, can detect all states except −K;

5. left and right proximity sensors at keyboard, can detect all states except T;

6. two ambient photosensors (left and right) at keyboard, can detect all states except T and −K;

7. one proximity or contact sensor at mouse, can only detect N and M (cannot detect T, Z or −K).

Any type of proximity sensor can be used for distinguishing/differentiating between presence and absence of a hand (or forearm) at/from a keyboard, and any type of proximity or touch or contact sensor can be used for distinguishing/differentiating between presence and absence of a hand (or forearm) at/from a pointing device. All of the embodiments that have sensor configurations capable of detecting −K (see also FIGS. 15) can include the ability to transform pointing device functions when no hands are at the keyboard.

Transformation Sequence

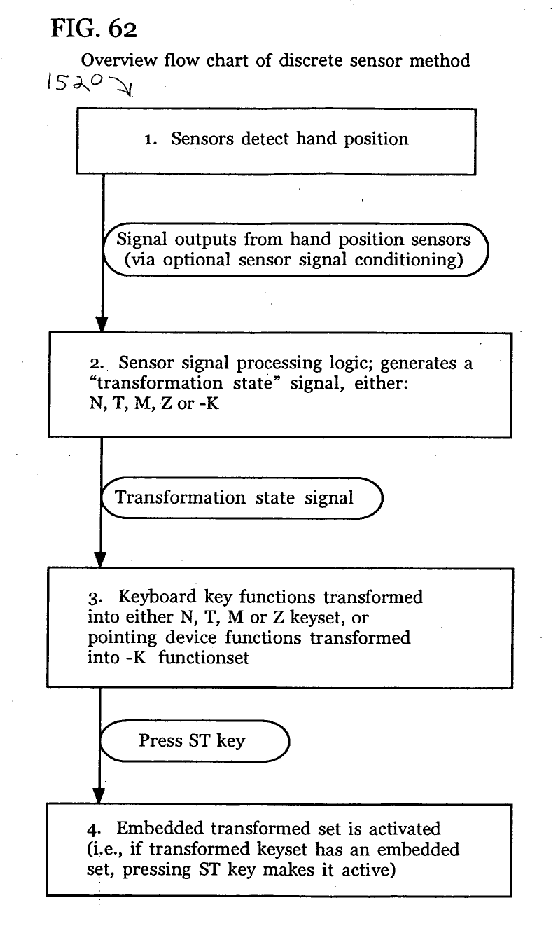

FIG. 62 is an overview flow chart 1520 of the discrete sensor method. A summary/overview of events when using the method of the present invention with discrete (i.e. hardware) sensors follows:

1. Sensors detect position of left and/or right hands with respect to keyboard typing position and/or with respect to pointing device.

2. Signals from sensors are processed by logic, which uses the particular combination of sensor outputs present at the time to generate a “transformation state” signal, e.g. either: N, T, M, Z or −K; or XL, XR or XLR.

3. The transformation state signal transforms keyboard into either N, T, M, Z or −K state, or function assigned to XL, XR or XLR is activated. (Transformation state −K can be used to replace default mouse functions with alternate functions.)

4. Each keyboard state (except N) has one or more transformed keysets (function sets) linked to it. Of the multiple keysets possible for transformed keyboard modes T, M, or Z, either pre-choose one of each type via preference settings, or on the fly from choices within the current transformed state via a ST (Shift Transform) key or by toggling a macro.

Hand position could also be detected without discrete sensor(s), by means of software only, with software sensing of hand position based on software monitoring of activity/outputs of keyboard and pointing device.

Scope of Application

The method of and apparatus for transformation in response to hand location of the present invention can be applied to/used with any type of computer data input device, including keyboards, pointing devices, and auxiliary keypads or other data input devices.

Embodiments for General Use

This invention could be marketed as:

1. A special external keyboard with all features of this invention built in, including hand position sensors, sensor logic, transformation firmware and transformation indicator Leds, and not requiring that any software to be installed on computer; optionally to be available with software driver to be installed on the computer to provide on-screen palettes and programming features, and optionally sold together with an external pointing device having a built in hand sensor (FIG. 53B).

2. A special external keyboard with hand position sensors and sensor logic, sold together with transformation/palette/programming software to be installed on computer, and optionally with an external pointing device having a built in hand sensor (FIG. 58).

3. A pointing device with hand sensor, sold together with transformation/palette/programming software to be installed on computer (FIG. 55A).

4. A laptop computer with all features of this invention built in, and optionally with an external pointing device having a built in hand sensor (FIG. 59).

5. A junction box to be used with a keyboard and/or pointing device with built in or retrofit sensors, and providing the features of either keyboard 1. or 2. above (FIGS. 51, 57B and 57C).

6. A wrist rest embodiment (FIGS. 52, 57A).

Palettes and Keyboards

Palettes can be in any shape, even though not shown here, to match the matrix layout of any new keyboard created in the future. The present invention can be used with any keyboard, and with any keyboard layout: QWERTY as shown in the Figures, DVORAK or any other, including for any language with its own characters. Key functions can be transformed to any function or macro, and in any arrangement beyond those shown in the Figures. The visual pattern transfer of the present invention works well for any keyboard, including the traditional keyboard with its asymmetrically staggered horizontal rows and therefore angled crooked columns, but larger transformed keysets can more easily be used on keyboards with straight columns (non-staggered rows), exactly as in numeric keypads. Rectilinear key matrices are far more ergonomic than staggered rows and angled crooked columns. One would not like to use a calculator or numeric keypad with staggered rows and crooked columns. Staggered rows and crooked columns are even worse on keyboards, because although the left and right hands are mirror images of each other, the positional patterns of the keys under the left and right hands are not mirror images, they are not symmetrical as the hands are: the columns are tilted at a different angle for the left hand than they are for the right hand. It is easy to do a test by feel: type some numbers on a numeric keypad with straight vertical columns, and then compare that with pretending to type numbers using the home key row and the row above and the row below the home key row on the standard angled crooked column computer keyboard. What is best for calculators is best for keyboards, and the reason that most keyboards are extremely poor ergonomically is not mainly QWERTY, it is the staggered rows. When one moves the fingers up and down from the home keys, they naturally want to go straight up and down, or with a little fan-out on the up. The reason that most keyboards are the way they are is because of grandfathering. The original mechanical typewriters had staggered rows and angled crooked columns because of the constraints of its mechanical mechanism, and these constraints were carried over to computer keyboards. Learning DVORAK layout after being trained on QWERTY is difficult, but getting used to typing on a QWERTY keyboard with straight vertical columns is quite easy. It only takes a few hours to adjust to because letters are shifted over only by about one-half a key width. The ease and pleasure of typing with straight columns after years of having to bend the fingers under each other results in a very noticeable reduction of strain, a feeling of ease, greater productivity. Straight columns correspond to the way the fingers naturally move when they curl and extend, and open up more possibilities for humane computer interfaces. It is without doubt the keyboard of the future, and will release much potential that is now blocked by staggered rows. Ergonomic keyboards currently available that have straight columns include the Kinesis Contour available from www.kinesis-ergo.com, Malbron Ergonomic Keyboards from www.Malbron.com, and the SmartBoard from www.data-desktech.com.

1. A method for automatically transforming the function of a computer input device of a computer having a keyboard and a pointing device, said method comprising the steps of:
providing at least one hand-position sensor capable of sensing either hand presence at or hand absence from the pointing device, or hand presence at or absence from a typing position at the keyboard; and
providing a signal output from the at least one hand-position sensor causing transformation of the function of at least some portion of the computer input device from a default action to an alternative action during the time that a hand is either present at the pointing device or is absent from a keyboard typing position.

2. The method of claim 1 where the input device is a keyboard.

3. The method of claim 1 where the input device is a pointing device.

4. The method of claim 1 where the input device is a scrolling device.

5. The method of claim 1 where the input device is an auxiliary keypad.

6. The method of claim 1 wherein the input device is a keyboard having a plurality of keys, and said step of providing a signal output from the at least one hand-position sensor comprises transforming the function of at least one of the keyboard keys from a default action to an alternative action during the time that a hand is either present at the pointing device or is absent from the keyboard typing position.

7. The method of claim 6 further including the step of returning the function of the at least one keyboard key to the default action during the time that the pointing-device-hand is either absent from the pointing device or is present at the keyboard typing position.

8. The method of claim 6 further including the step of providing an indicator of function transformation.

9. The method of claim 6 further including the steps of providing a screen monitor, and providing a palette on the screen monitor representing the alternative action.

10. The method of claim 6 wherein said step of providing at least one hand-position sensor comprises providing software capable of detecting pointing device activity and capable of detecting activity on the pointing-device-hand side of the keyboard.

11. The method of claim 6 wherein said step of transforming the function of at least one of the keyboard keys comprises simultaneously transforming a plurality of keyboard keys from a default action to an alternative action.

12. An apparatus for automatically transforming the function of a computer input device of a computer having a keyboard and a pointing device, said apparatus comprising:
at least one hand-position sensor capable of sensing either hand presence at or hand absence from said pointing device, or hand presence at or absence from a keyboard typing position; and
means to transform the function of at least some portion of said computer input device from a default action to an alternative action during the time that a hand is either present at said pointing device or is absent from said keyboard typing position.

13. The apparatus of claim 12 wherein said input device comprises a keyboard having a plurality of keys, and said means to transform of the function of at least some portion of the computer input device comprises means to transform the function of at least one of the keyboard keys from a default action to an alternative action during the time a hand is sensed as either present at said pointing device or absent from said keyboard typing position.

14. The apparatus of claim 13 wherein said at least one hand-position sensor provides a signal output to activate transformation of said at least one keyboard key during the time a hand is sensed as either present at said pointing device or absent from said keyboard typing position.

15. The apparatus of claim 13 wherein said at least one keyboard key is returned to the default action during the time the pointing-device-hand is sensed as either absent from said pointing device or present at said keyboard typing position.

16. The apparatus of claim 13 including an indicator of function transformation.

17. The apparatus of claim 13 including a monitor screen, and a palette on the monitor screen representing the alternative action.

18. The apparatus of claim 13 wherein said at least one hand-position sensor comprises hardware to detect hand presence at or absence from said pointing device.

19. The apparatus of claim 13 wherein said at least one hand-position sensor comprises hardware to detect hand presence at or absence from at least one said keyboard typing position.

20. An apparatus for automatically transforming a function of a computer pointing device of a computer having a keyboard and a pointing device, said apparatus comprising:
hand-position sensing means capable of detecting that the non-pointing-device-hand is present at or absent from its keyboard typing position; and
means to transform the action of at least one of the functions of said pointing device from a default action to an alternative action during the time that said non-pointing-device-hand is absent from said its keyboard typing position;
whereas a signal output from said hand-position sensing means causes the transformation of at least one of the functions of said pointing device; and
whereas the function of the said at least one of the functions of said pointing device is reverted to said default action during the time that said non-pointing-device-hand is present at said its keyboard typing position.
